(19) United States
(12) Patent Application Publication
(10) Pub. No.: US 2011/0313957 A1
(43) Pub. Date: Dec. 22, 2011

(54) DATA PROCESSING APPARATUS, DATA PROCESSING METHOD AND PROGRAM

(76) Inventors: Naoki IDE, Tokyo (JP); Masato Ito, Tokyo (JP)

(21) Appl. No.: 13/160,435

(22) Filed: Jun. 14, 2011

(30) Foreign Application Priority Data
Jun. 22, 2010 (JP) P2010-141946

(51) Int. Cl. G06F 15/18

(52) U.S. Cl. 706/12

(57) ABSTRACT

A data processing apparatus includes: a learning section which obtains parameters of a probability model; a destination and stopover estimating section which estimates a destination node corresponding to a movement destination and a stopover node corresponding to a movement stopover; a current location estimating section which inputs the movement history data of the user within a predetermined time from a current time to the probability model using the parameters obtained by learning, and estimates a current location node corresponding to a current location of the user; a searching section which searches for a route to the destination from the current location of the user; and a calculating section which calculates an arrival probability and a time to reach the searched destination. The learning section includes a known or unknown determining section, a parameter updating section, a new model generating section, and a new model combining section.

### BACKGROUND

The present disclosure relates to a data processing apparatus, a data processing method and a program thereof, and in particular, to a data processing apparatus, a data processing method and a program thereof in which difference learning when movement history data on an unknown route is obtained can be simply performed.

Recently, a technology has been studied in which states of a user are modeled and learned using time series data obtained from a wearable sensor which is a sensor worn by the user and a current state of the user is recognized using the model obtained by learning (for example, Japanese Unexamined Patent Application Publication No. 2006-134080, Japanese Unexamined Patent Application Publication No. 2008-204040, and “Life Patterns: structure from wearable sensors”, Brian Patrick Clarkson, Doctoral Thesis, MIT, 2002).

The present applicant has proposed a method of probabilistically predicting a plurality of possibilities for activity states of a user at a desired time in the future in Japanese Patent Application No. 2009-180780 (hereinafter, referred to “prior application 1”). In the method proposed in the prior application 1, the activity states of the user are learned as a probabilistic state transition model from time series data, the current activity state is recognized using the learned probabilistic state transition model, and thus, the activity states of the user “after a predetermined time” can be probabilistically predicted. In the prior application 1, with respect to the prediction of the activity states of the user “after the predetermined time”, an example is proposed in which a current position of the user is recognized using the probabilistic state transition model in which the time series data (movement history data) on the movement history of the user is learned and a destination (location) of the user is predicted after the predetermined time.

Further, the present applicant has proposed a method of predicting arrival probabilities, routes and times to a plurality of destinations even in a case where there is no designation of an elapse time from a current time called “after a predetermined time” in Japanese Patent Application No. 2009-208064 (hereinafter, referred to as “prior application 2”) which is further developed from the prior application 1. In the method proposed in the prior application 2, an attribute of a “movement state” or a “stationary state” is assigned to state nodes which form a probabilistic state transition model. Further, as the state node of the “stationary state” which is the state node of the destination is found from the state nodes which form the probabilistic state transition model, it is possible to automatically detect candidates for the destination.

### SUMMARY

However, in a case where additional learning is performed using movement history data which is newly obtained as learning data, difference learning in which only the newly obtained movement history data is learned is generally performed to reduce a learning time.

However, the difference learning typically changes parameters of the same model. If the newly obtained movement history data is data obtained when a user moves along a known route once again, it is desirable that the parameters of the existing probabilistic state transition model is updated. However, if the obtained movement history data is data obtained when the user moves along an unknown route that has not appeared so far, it is preferable that a new state node is added thereto and learning is performed for the added state node. However, in the related difference learning, it is difficult to extend topology in a behavior range of the user.

Accordingly, it is desirable to simply perform the difference learning when movement history data on an unknown route is obtained.

According to an embodiment of the present disclosure, there is provided a data processing apparatus including: a learning section which obtains parameters of a probability model when movement history data of a user which is obtained as learning data is expressed as the probability model indicating an activity of the user; a destination and stopover estimating section which estimates a destination node corresponding to a movement destination and a stopover node corresponding to a movement stopover, among state nodes of the probability model using the parameters obtained by the learning section; a current location estimating section which inputs the movement history data of the user within a predetermined time from a current time, which is different from the learning data, to the probability model using the parameters obtained by learning, and estimates a current location node corresponding to a current location of the user; a searching section which searches for a route to the destination from the current location of the user, using information about the estimated destination node, stopover node and the current location node and the probability model obtained by learning; and a calculating section which calculates an arrival probability and a time to reach the searched destination. Here, the learning section includes: a known or unknown determining section which determines, in a case where movement history data which is new learning data is supplied after the parameters of the probability model are once obtained, whether the new learning data is movement history data on a known route or movement history data on an unknown route; a parameter updating section which updates, in a case where it is determined that the new learning data is the movement history data on the known route in the known or unknown determining section, the parameters of the existing model which is the already obtained probability model; a new model generating section which obtains, in a case where it is determined that the new learning data is the movement history data on the unknown route in the known or unknown determining section, parameters of a probability model which is a new model corresponding to the movement history data on the unknown route; and a new model combining section which generates an updated model in which the existing model and the new model are combined with each other, by combining the parameters of the existing model with the parameters of the new model. Further, in a case where the probability model is updated by the new learning data, a process using the probability model after being updated is performed in the destination and stopover estimating section, the current location estimating section, the searching section and the calculating section.

According to an embodiment of the present disclosure, there is provided a data processing method including: obtaining parameters of a probability model when movement history data of a user which is obtained as learning data is expressed as the probability model indicating an activity of the user, by a learning section of a data processing apparatus which processes the movement history data of the user; estimating a destination node corresponding to a movement destination and a stopover node corresponding to a movement stopover, among state nodes of the probability model using the parameters obtained, by a destination and stopover estimating section of the data processing apparatus; inputting the movement history data of the user within a predetermined time from a current time, which is different from the learning data, to the probability model using the parameters obtained by learning, and estimating a current location node corresponding to a current location of the user, by a current location estimating section of the data processing apparatus; searching for a route to the destination from the current location of the user, using information about the estimated destination node, stopover node and the current location node and the probability model obtained by learning, by a searching section of the data processing apparatus; and calculating an arrival probability and a time to reach the searched destination, by a calculating section of the data processing apparatus. Here, the process in the learning section includes: determining, in a case where movement history data which is new learning data is supplied after the parameters of the probability model are once obtained, whether the new learning data is movement history data on a known route or movement history data on an unknown route, by a known or unknown determining section of the learning section; updating, in a case where it is determined that the new learning data is the movement history data on the known route in the known or unknown determining section, the parameters of the existing model which is the already obtained probability model, by a parameter updating section thereof; obtaining, in a case where it is determined that the new learning data is the movement history data on the unknown route in the known or unknown determining section, parameters of a probability model which is a new model corresponding to the movement history data on the unknown route, by a new model generating section thereof; and generating an updated model in which the existing model and the new model are combined with each other, by combining the parameters of the existing model with the parameters of the new model, by a new model combining section thereof. Further, in a case where the probability model is updated by the new learning data, a process using the probability model after being updated is performed in the destination and stopover estimating section, the current location estimating section, the searching section and the calculating section.

According to an embodiment of the present disclosure, there is provided a program which allows a computer to function as the following sections, the sections including: a learning section which obtains parameters of a probability model when movement history data of a user which is obtained as learning data is expressed as the probability model indicating an activity of the user; a destination and stopover estimating section which estimates a destination node corresponding to a movement destination and a stopover node corresponding to a movement stopover, among state nodes of the probability model using the parameters obtained by the learning section; a current location estimating section which inputs the movement history data of the user within a predetermined time from a current time, which is different from the learning data, to the probability model using the parameters obtained by learning, and estimates a current location node corresponding to a current location of the user; a searching section which searches for a route to the destination from the current location of the user, using information about the estimated destination node, stopover node and the current location node and the probability model obtained by learning; and a calculating section which calculates an arrival probability and a time to reach the searched destination. Here, the learning section includes functions of: a known or unknown determining section which determines, in a case where movement history data which is new learning data is supplied after the parameters of the probability model are once obtained, whether the new learning data is movement history data on a known route or movement history data on an unknown route; a parameter updating section which updates, in a case where it is determined that the new learning data is the movement history data on the known route in the known or unknown determining section, the parameters of the existing model which is the already obtained probability model; a new model generating section which obtains, in a case where it is determined that the new learning data is the movement history data on the unknown route in the known or unknown determining section, parameters of a probability model which is a new model corresponding to the movement history data on the unknown route; and a new model combining section which generates an updated model in which the existing model and the new model are combined with each other, by combining the parameters of the existing model with the parameters of the new model. Further, in a case where the probability model is updated by the new learning data, a process using the probability model after being updated is performed in the destination and stopover estimating section, the current location estimating section, the searching section and the calculating section.

According to the embodiments of the present disclosure, the parameters of the probability model when the movement history data of the user which is obtained as the learning data is expressed as the probability model indicating the activity of the user, is obtained in the learning section; the destination node corresponding to the movement destination and the stopover node corresponding to the movement stopover are estimated from the state nodes of the probability model using the parameters obtained by the learning section, in the destination and stopover estimating section; the movement history data of the user within the predetermined time from the current time, which is different from the learning data, is input to the probability model using the parameters obtained by learning, and the current location node corresponding to the current location of the user is estimated, in the current location estimating section; the route to the destination from the current location of the user is searched for using information about the estimated destination node, stopover node and the current location node and the probability model obtained by learning, in the searching section; and the arrival probability and the time to reach the searched destination are calculated in the calculating section. Here, in the learning section, in a case where the movement history data which is the new learning data is supplied after the parameters of the probability model are once obtained, it is determined whether the new learning data is the movement history data on the known route or the movement history data on the unknown route, in the known or unknown determining section; in a case where it is determined that the new learning data is the movement history data on the known route in the known or unknown determining section, the parameters of the existing model which is the already obtained probability model are updated in the parameter updating section; in a case where it is determined that the new learning data is the movement history data on the unknown route in the known or unknown determining section, the parameters of the probability model which is the new model corresponding to the movement history data on the unknown route are obtained in the new model generating section; and the updated model in which the existing model and the new model are combined with each other is generated by combining the parameters of the existing model with the parameters of the new model in the new model combining section. Further, in a case where the probability model is updated by the new learning data, the process using the probability model after being updated is performed in the destination and stopover estimating section, the current location estimating section, the searching section and the calculating section.

According to the embodiments of the present disclosure, it is possible to simply perform the difference learning when the movement history data on the unknown route is obtained.

### BRIEF DESCRIPTION OF THE DRAWINGS

FIG. 1 is a block diagram illustrating an example of a configuration of a prediction system according to an embodiment of the present disclosure;

FIG. 2 is a block diagram illustrating an example of a configuration of hardware of a prediction system;

FIG. 3 is a diagram illustrating an example of movement history data;

FIG. 4 is a diagram illustrating an example of an HMM;

FIG. 5 is a diagram illustrating an example of a left-to-right HMM;

FIGS. 6A and 6B are diagrams illustrating an example of an HMM with a sparse restriction;

FIG. 7 is a block diagram illustrating an example of a detailed configuration of a learning pre-processing section;

FIG. 8 is a diagram illustrating a process of a learning pre-processing section;

FIG. 9 is a diagram illustrating a block diagram illustrating an example of a detailed configuration of a movement attribute recognizing and assigning section;

FIG. 10 is a diagram illustrating a block diagram illustrating an example of a configuration of a learning machine of a movement attribute recognizing section;

FIG. 11 is a diagram illustrating a classification example in a case where behavior states are classified according to categories;

FIG. 12 is a diagram illustrating an example of a process of a behavior state labeling section;

FIG. 13 is a diagram illustrating an example of a process of a behavior state labeling section;

FIG. 14 is a block diagram illustrating an example of a configuration of a behavioral state learning section in FIG. 10;

FIG. 15 is a block diagram illustrating an example of a detailed configuration of a movement attribute recognizing section;

FIG. 16 is a block diagram illustrating an example of another configuration of a learning machine of a movement attribute recognizing section;

FIG. 17 is a block diagram illustrating an example of another configuration of a movement attribute recognizing section;

FIG. 18 is a flowchart illustrating a process of the learning pre-processing section;

FIG. 19 is a block diagram illustrating an example of a detailed configuration of a learning main processing section in FIG. 1;

FIG. 20 is a block diagram illustrating an example of a detailed configuration of a known or unknown determining section;

FIG. 21 is a flowchart illustrating a building process of an unknown state adding model in an unknown state node adding section;

FIG. 22 is a diagram illustrating an initial probability table of an unknown state adding model;

FIG. 23 is a diagram illustrating a transition probability table of an unknown state adding model;

FIG. 24 is a diagram illustrating a center value table of an unknown state adding model;

FIG. 25 is a diagram illustrating a variance value table of an unknown state adding model;

FIG. 26 is a flowchart illustrating a known or unknown determining process of a known or unknown determining section;

FIG. 27 is a diagram illustrating an example of a result obtained by a known or unknown determining process;

FIG. 28 is a diagram illustrating an example of a result obtained by a known or unknown determining process;

FIG. 29 is a block diagram illustrating an example of a detailed configuration of a new model generating section;

FIG. 30 is a diagram illustrating a difference between a learning model through a normal HMM and a learning model performed by a new model learning section;

FIG. 31 is a diagram illustrating a difference between a learning model through a normal HMM and a learning model performed by a new model learning section;

FIGS. 32A and 32B are diagrams illustrating a learning model of a new model learning section using a graphic model;

FIG. 33 is a flowchart illustrating a new model learning process of a new model learning section;

FIG. 34 is a flowchart illustrating a parameter re-calculating process of a parameter re-calculating section;

FIG. 35 is a flowchart illustrating an overall new model generating process performed by a new model generating section;

FIG. 36 is a flowchart illustrating a topology updated model generating process in a new model combining section;

FIGS. 37A and 37B are diagrams illustrating an initial probability table of a topology updated model;

FIG. 38 is a diagram illustrating a transition probability table of a topology updated model;

FIG. 39 is a diagram illustrating a transition probability table of a topology updated model;

FIG. 40 is a diagram illustrating a transition probability table of a topology updated model;

FIG. 41 is a diagram illustrating a center value table of a topology updated model;

FIG. 42 is a diagram illustrating a variance value table of a topology updated model;

FIG. 43 is a flowchart illustrating an overall parameter update process performed by a parameter updating section;

FIGS. 44A and 44B are diagrams illustrating an initial probability table of a model in the related art;

FIG. 45 is a diagram illustrating a transition probability table of a model in the related art;

FIG. 46 is a diagram illustrating a transition probability table of a model in the related art;

FIG. 47 is a diagram illustrating a transition probability table of a model in the related art;

FIG. 48 is a diagram illustrating a center value table in a model in the related art;

FIG. 49 is a diagram illustrating a variance value table in a model in the related art;

FIG. 50 is a flowchart illustrating an overall learning main processing process of a learning main processing section;

FIGS. 51A to 51C are diagrams illustrating a process of a destination and stopover detecting section;

FIG. 52 is a flowchart illustrating an overall process of a learning block;

FIG. 53 is a flowchart illustrating a tree search process;

FIG. 54 is a diagram further illustrating a tree search process;

FIGS. 55A to 55D are diagrams further illustrating a tree search process;

FIG. 56 is a diagram illustrating an example of a search result list in a tree search process;

FIG. 57 is a flowchart illustrating a representative stopover selecting process;

FIG. 58 is a flowchart illustrating an overall process of a prediction block;

FIGS. 59A and 59B are diagrams illustrating an example of a learning process result of a learning main processing section in FIG. 1;

FIG. 60 is a diagram illustrating an example of a learning process result of a learning main processing section in FIG. 1;

FIG. 61 is a diagram illustrating an example of a learning process result of a learning main processing section in FIG. 1;

FIG. 62 is a diagram illustrating an example of a learning process result of a learning main processing section in FIG. 1;

FIG. 63 is a diagram illustrating an example of a learning process result of a learning main processing section in FIG. 1; and

FIG. 64 is a block diagram illustrating an example of a configuration of a computer according to an embodiment of the present disclosure.

### DETAILED DESCRIPTION OF EMBODIMENTS

### [Example of Configuration of Prediction System]

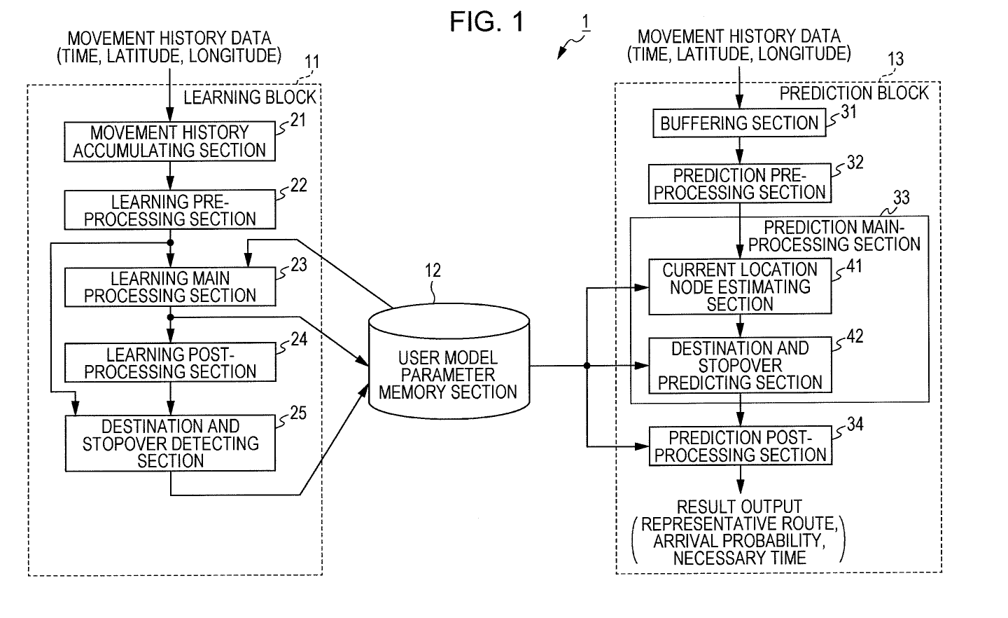

FIG. 1 is a diagram illustrating an example of a configuration of a prediction system according to an embodiment of the present disclosure.

A prediction system 1 in FIG. 1 includes a learning block 11, a user model parameter storing section 12, and a prediction block 13.

Time series data indicating a position (latitude and longitude) of a user at a predetermined time which is obtained in a predetermined period in a sensor device (not shown) such as a GPS (Global Positioning System) sensor is supplied to a learning block 11. That is, data on positions (latitude and longitude) which are sequentially obtained at a constant time interval (for example, 15 seconds) and time series data (hereinafter, referred to as movement history data) indicating three dimensional movement routes of the user at corresponding times are supplied to the learning block 11. One data set including latitude, longitude and time which forms the time series data is appropriately referred to as three dimensional data.

The learning block 11 performs a learning process of learning an activity model (state model indicating behavior and activity patterns of the user) of the user as a probabilistic state transition model using the movement history data of the user.

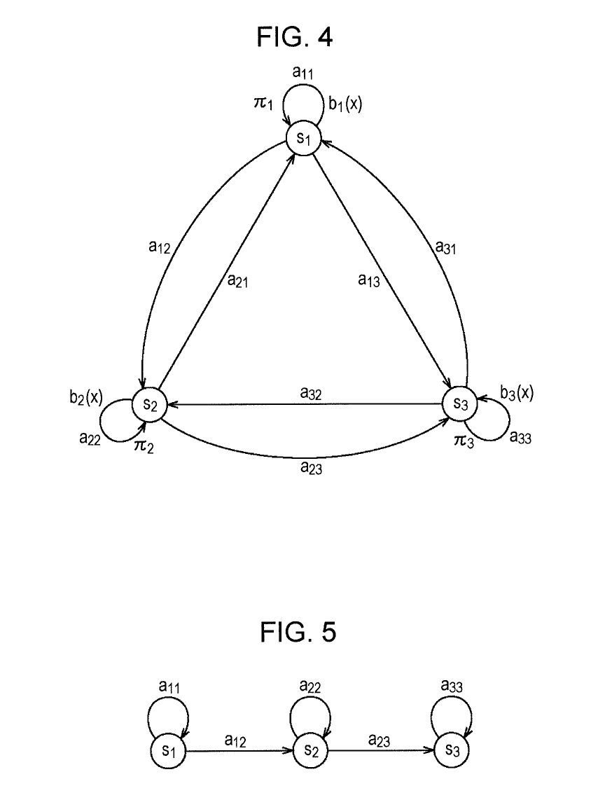

As the probabilistic state transition model used for learning, for example, a probability model including a hidden state such as an ergodic HMM (Hidden Markov Model) may be employed. The prediction system 1 employs a probabilistic state transition model in which a sparse restriction is given to the ergodic HMM. A calculation method of the ergodic HMM having the sparse restriction and parameters of the ergodic HMM, or the like will be described later with reference to FIGS. 4 to 6.

The user model parameter storing section 12 stores parameters indicating the activity model of the user obtained by learning in the learning block 11.

The prediction block 13 obtains the parameters of the user activity model obtained by the learning in the learning block 11 from the user model parameter storing section 12. Further, the prediction block 13 estimates a current location of the user using the user activity model according to the parameters obtained by the learning, with respect to the movement history data of the user which is newly obtained, and then predicts a destination of the movement from the current location. Further, the prediction block 13 calculates an arrival probability, a route and an arrival time (necessary time) for the predicted destination. Here, the destination is not limited to only one, but a plurality of destinations may be predicted.

The learning block 11 and the prediction block 13 will be described in detail.

The learning block 11 includes a history data accumulating section 21, a learning pre-processing section 22, a learning main processing section 23, a learning post-processing section 24 and a destination and stopover detecting section 25.

The history data accumulating section 21 accumulates (stores) the movement history data of the user which is supplied from the sensor device as learning data. The history data accumulating section 21 supplies the movement history data to the learning pre-processing section 22 as necessary.

The learning pre-processing section 22 solves problems occurring from the sensor device. Specifically, the learning pre-processing section 22 forms the movement history data and fills in a temporary data gap through an interpolation process or the like. Further, the learning pre-processing section 22 gives any one movement attribute of a “stationary state” indicating that the user stays (stops) at the same position and a “movement state” indicating that the user moves, with respect to each piece of three dimensional data which forms the movement history data. The movement history data after the movement attribute is given is supplied to the learning main processing section 23 and the destination and stopover detecting section 25.

The learning main processing section 23 models the movement history of the user as the user activity model. That is, the learning main processing section 23 obtains parameters when the movement history data of the user is modeled as the user activity model. The parameters of the user activity model obtained by the learning are supplied to the learning post-processing section 24 and the user model parameter storing section 12.

Further, after the movement history data of the user is learned as the user activity model, in a case where movement history data which is new learning data is supplied, the learning main processing section 23 obtains the parameters of the current user activity model from the user model parameter storing section 12 and updates the parameters.

Specifically, firstly, the learning main processing section 23 determines whether the movement history data which is the new learning data is movement history data on a known route or movement history data on an unknown route. Then, in a case where it is determined that the new learning data is the movement history data of the known route, the learning main processing section 23 updates the parameters of the existing user activity model (hereinafter, simply referred to as “existing model”). On the other hand, in a case where the new learning data is the movement history data on the unknown route, the learning main processing section 23 obtains parameters of the user activity model which is the new model corresponding to the movement history data on the unknown route. Then, the learning main processing section 23 synthesizes the parameters of the existing model with the parameters of the new model, to thereby generate an updated model obtained by combining the existing model with the new model.

Hereinafter, the user activity model in which the parameters are updated by the movement history data on the known route is referred to as a parameter updated model. On the other hand, since the user activity model in which the parameters are updated by the movement history data on the unknown route is referred to as a topology updated model since topology is also updated according to expansion of the unknown route. Further, hereinafter, the movement history data on the known route and the movement history data on the unknown route are also simply referred to as “known movement history data” and “unknown movement history data”.

The parameters of the parameter updated model or the topology updated model are supplied to the learning post-processing section 24 and the user model parameter storing section 12, and a process is performed using the user activity model after the updating in a subsequent stage.

The learning post-processing section 24 converts each piece of three dimensional data which forms the movement history data into a state node of the user activity model, using the user activity model obtained by the learning of the learning main processing section 23. That is, the learning post-processing section 24 generates time series data (node series data) on the state node of the user activity model corresponding to the movement history data. The learning post-processing section 24 supplies the node series data after conversion to the destination and stopover detecting section 25.

The destination and stopover detecting section 25 matches the movement history data after being given the movement attribute supplied from the learning pre-processing section 22 with the node series data supplied from the learning post-processing section 24. That is, the destination and stopover detecting section 25 allocates the state node of the user activity model to each piece of three dimensional data which forms the movement history data.

Further, the destination and stopover detecting section 25 gives the destination or stopover attribute to the state node corresponding to the three dimensional data, in which the movement attribute is the “stationary state” from among the respective state nodes of the node series data. Thus, a predetermined position in the movement history of the user (state node corresponding to the position) is allocated to the destination or stopover. Information about the attribute of the destination and stopover given to the state node by the destination and stopover detecting section 25 is supplied to the user model parameter storing section 12 and is stored therein.

The prediction block 13 includes a buffering section 31, a prediction pre-processing section 32, a prediction main processing section 33 and a prediction post-processing section 34.

The buffering section 31 buffers (stores) the movement history data obtained in real time for the prediction process. As the movement history data for the prediction process, data having a period shorter than that of the movement history data during the learning process, for example, movement history data of about 100 steps, is sufficient. The buffering section 31 constantly stores the latest movement history data for a predetermined period, and when new data is obtained, the buffering section 31 deletes the oldest data among the stored data.

The prediction pre-processing section 32 solves problems occurring from the sensor device, in a similar way to the learning pre-processing section 22. That is, the prediction pre-processing section 32 forms the movement history data and fills in a temporary data gap through an interpolation process or the like.

The prediction main processing section 33 includes a current location node estimating section 41 and a destination and stopover predicting section 42. Parameters indicting the user activity model obtained by the learning in the learning block 11 are supplied to the prediction main processing section 33 from the user model parameter storing section 12.

The current location node estimating section 41 estimates a state node (current location node) corresponding to the current location of the user, using the movement history data supplied from the prediction pre-processing section 32 and the user activity model obtained by the learning in the learning block 11. In order to estimate the state node, the Viterbi maximum likelihood estimation or soft decision Viterbi estimation may be employed.

The destination and stopover predicting section 42 calculates node series up to a state node of the destination (destination node) and their occurrence probabilities in a tree structure including a plurality of state nodes capable of being transited from the current location node estimated by the current location node estimating section 41. Since the node series (route) up to the state node of the destination may include the node of the stopover, the destination and stopover detecting section 42 predicts the destination and the stopover at the same time.

The prediction post-processing section 34 obtains the sum of selection probabilities (occurrence probabilities) of the plurality of routes up to the same destination as an arrival probability to the destination. Further, the prediction post-processing section 34 selects one or more routes (hereinafter, referred to as “representative route”) which is representative among the routes to the destination, and calculates a necessary time of the representative route. Further, the prediction post-processing section 34 outputs a representative route, an arrival probability and a time to reach the predicted destination as a prediction result. A frequency may be output as the prediction result instead of the occurrence probability of the route, and an arrival frequency may be output as the prediction result instead of the arrival probability to the destination.

### [Example of Hardware Configuration of Prediction System]

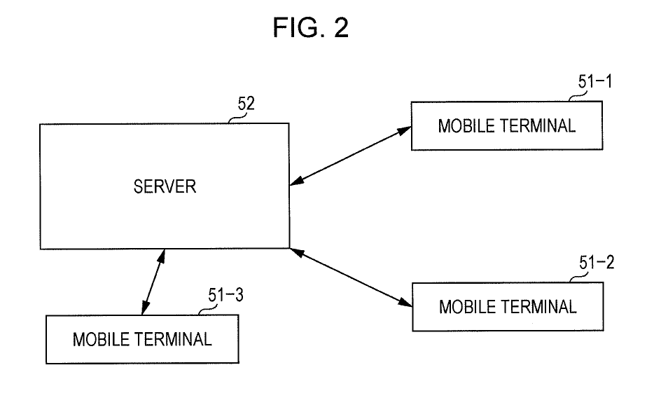

The prediction system 1 having the above-described configuration can employ a hardware configuration shown in FIG. 2, for example. That is, FIG. 2 is a block diagram illustrating an example of a hardware configuration of the prediction system 1.

In FIG. 2, the prediction system 1 includes three mobile terminals 51-1 to 51-3 and a server 52. The mobile terminals 51-1 to 51-3 are the same type mobile terminals 51 having the same function, but the mobile terminals 51-1 to 51-3 are possessed by different users. Thus, only three mobile terminals 51-1 to 51-3 are shown in FIG. 2, but in reality, the number of mobile terminals 51 corresponding to the number of users is present.

The mobile terminals 51 can perform transmission and reception of data to/from the server 52 by communication through a network such as a wireless communication network and the Internet. The server 52 receives the data transmitted from the mobile terminals 51 and performs a predetermined process for the received data. Further, the server 52 transmits the process result of the data processing to the mobile terminals 51 by wireless communication or the like.

Accordingly, the mobile terminals 51 and the server 52 at least have a communication section which performs communication in a wireless or wired manner.

Further, each mobile terminal 51 may include the prediction block 13 in FIG. 1, and the server 52 may include the learning block 11 and the user model parameter storing section 12 in FIG. 1.

In the case of such a configuration, for example, in the learning process, the movement history data obtained by the sensor device of the mobile terminal 51 is transmitted to the server 52. The server 52 learns and stores the user activity model, on the basis of the received movement history data for learning. Further, in the prediction process, the mobile terminal 51 obtains parameters of the user activity model obtained by learning, estimates the current location node of the user from the movement history data obtained in real time, and calculates a destination node, and an arrival probability, a representative route and a necessary time up to the destination. Further, the mobile terminal 51 displays the process result on a display section (not shown) such as a liquid crystal display.

Division of roles between the mobile terminal 51 and the server 52 as described above can be appropriately determined according to a process capability of each data processing apparatus or a communication environment.

In the learning process, the time necessary for one process is very long, but it is not necessary to frequently perform the process. Accordingly, since the server 52 generally has a higher process capability than the portable mobile terminal 51, it is possible to allow the server 52 to perform the learning process (parameter updating) on the basis of the movement history data accumulated about once a day.

On the other hand, it is preferable that the prediction process is rapidly performed and displayed in correspondence with the movement history data updated in real time every moment for display, and thus it is preferable that the process is performed in the mobile terminal 51. If the communication environment is rich, it is preferable that the prediction process is performed in the server 52 and only the prediction result is received from the server 52 to reduce the burden of the mobile terminal 51 which prefers a portable minimum size.

Further, in a case where the mobile terminal 51 can independently perform the learning process and the prediction process as the data processing apparatus at a high speed, the mobile terminal 51 can be provided with the entire configuration of the prediction system 1 in FIG. 1.

### [Example of Input Movement History Data]

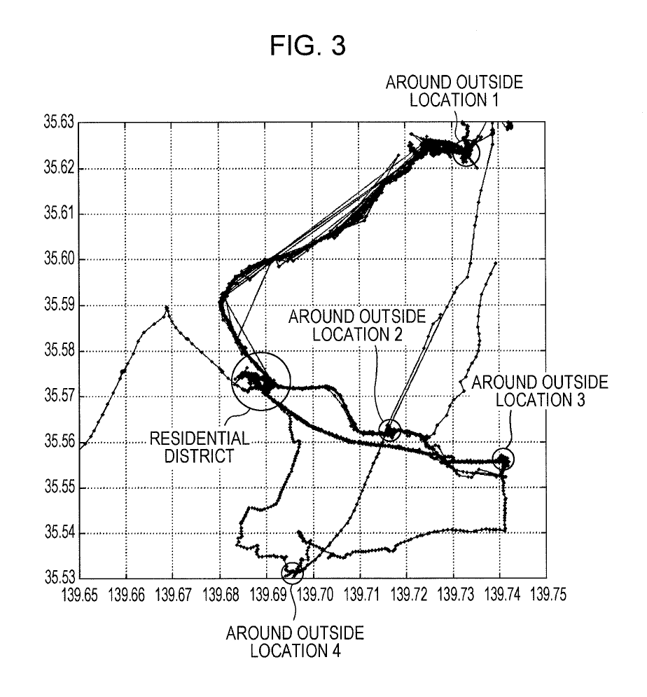

FIG. 3 is a diagram illustrating an example of the movement history data acquired in the prediction system 1. In FIG. 3, the transverse axis represents the longitude, and the longitudinal axis represents the latitude.

The movement history data shown in FIG. 3 is movement history data accumulated in a period of about one and a half months by an experimenter. As shown in FIG. 3, the movement history data mainly includes data on a residential district and four outside movement locations such as a work location. The movement history data also includes data in which the location data is in the sky without capturing the satellite.

### [Ergodic HMM]

Next, the ergodic HMM employed by the prediction system 1 as the learning model will be described.

FIG. 4 is a diagram illustrating an example of an HMM.

The HMM is a state transition model having state nodes and inter-state nodes transitions.

FIG. 4 is a diagram illustrating an example of a three-state HMM.

In FIG. 4 (the same with the subsequent Figures), a circle represents a state node, and an arrow represents a state node transition. Hereinafter, the state node is simply referred to as a node or state.

Further, in FIG. 4, sᵢ (i=1, 2 and 3 in FIG. 4) represents a state, aᵢⱼ represents a state transition probability to a state sⱼ from the state sᵢ. Further, bⱼ(x) represents an output probability density function in which an observation value x is observed in the state transition to the state sⱼ, and πᵢ represents an initial probability in which the state sᵢ is an initial state.

As the output probability density function bⱼ(x), for example, a normal probability distribution or the like may be used.

Here, the HMM (continuous HMM) is defined by the state transition probability aᵢⱼ, the output probability density function bⱼ(x) and the initial probability πᵢ. The state transition probability aᵢⱼ, the output probability density function bⱼ(x) and the initial probability πᵢ are referred to as HMM parameters λ={aᵢⱼ, bⱼ(x), πᵢ, where i=1, 2, . . . M, j=1, 2, . . . M}. Here, M represents the number of HMM states.

As a method for estimating the HMM parameters λ, a Baum-Welch's maximum likelihood estimation method is widely used. The Baum-Welch's maximum likelihood estimation method is a parameter estimation method based on the EM algorithm (Expectation-Maximization algorithm).

According to the Baum-Welch's maximum likelihood estimation method, the HMM parameters λ are estimated so that a likelihood calculated from an occurrence probability which is a probability that the time series data is observed (occurs) is maximized, on the basis of the observed time series data x=x₁, x₂, . . . x_{T}. Here, xₜ represents a signal (sample value) observed at a time t, and T represents the length (sample number) of the time series data.

The Baum-Welch's maximum likelihood estimation method is for example disclosed in “Pattern Recognition and Machine Learning (II)”, C. M. Bishop, P. 333 (English original: “Pattern Recognition and Machine Learning (Information Science and Statistics)”, Christopher M. Bishop, Springer, New York, 2006) hereinafter, referred to as “document A”).

The Baum-Welch's maximum likelihood estimation method is a parameter estimating method based on likelihood maximization, but does not ensure optimality, and may converge to a local solution (local minimum) according to a structure of the HMM or initial values of the parameters λ.

The HMM is generally used in a sound recognition. In the HMM used in the sound recognition, the number of states, types of state transitions and the like are generally determined in advance.

FIG. 5 is a diagram illustrating an example of the HMM used in the sound recognition.

The HMM in FIG. 5 is called a left-to-right type.

In FIG. 5, the number of the states becomes 3, and the state transition is restricted to a structure in which only a self transition (state transition to a state sᵢ from a state sᵢ) and a state transition to a right neighboring state from the left are allowed.

With respect the HMM having the restriction to the state transition as shown in FIG. 5, the HMM without having the restriction to the state transition as shown in FIG. 4, that is, the HMM in which the state transition is possible from an arbitrary state sᵢ to an arbitrary state sⱼ is referred to as “ergodic HMM”.

The ergodic HMM is an HMM having the highest degree of freedom as a structure, but if the number of the states is increased, it is difficult to estimate the parameters λ.

For example, if the number of the states in the ergodic HMM is 1000, the number of the state transitions becomes 1,000,000 (=1000×1000).

Accordingly, in this case, for example, it is necessary to estimate 1,000,000 items of state transition probabilities aᵢⱼ, with respect to the state transition probability aᵢⱼ in the parameters λ.

Thus, a restriction (sparse restriction) called a sparse structure may be applied to the state transition set for the state, for example.

Here, the sparse structure is a structure in which states capable of being state-transited from a certain state are limited, which is not a denset state transition structure such as an ergodic HMM in which the state transition is possible from an arbitrary state to another arbitrary state. In this respect, it is assumed that at least one state transition to other states exists even in the sparse structure, and a self transition exists.

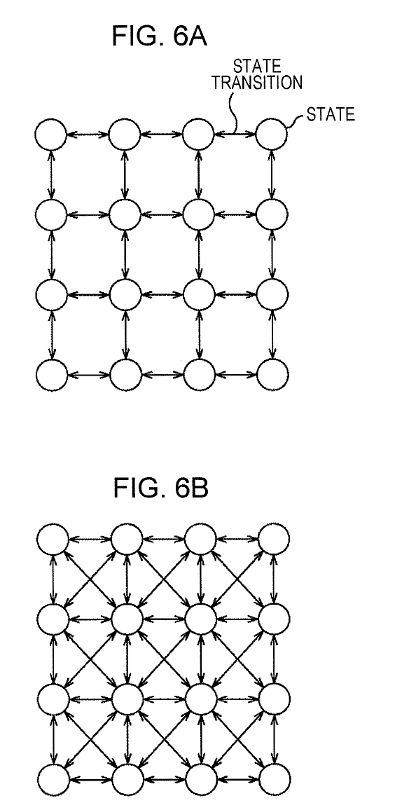

FIGS. 6A and 6B illustrate the HMM to which a sparse restriction is applied.

In FIGS. 6A and 6B, a bi-directional arrow which connects two states represents a state transition from a first direction of the two states to a second direction thereof, and a state transition from the other direction thereof to the first direction thereof. Further, in FIGS. 6A and 6B, a self transition can be performed in each state, and an arrow indicating the self transition is not shown in the Figure.

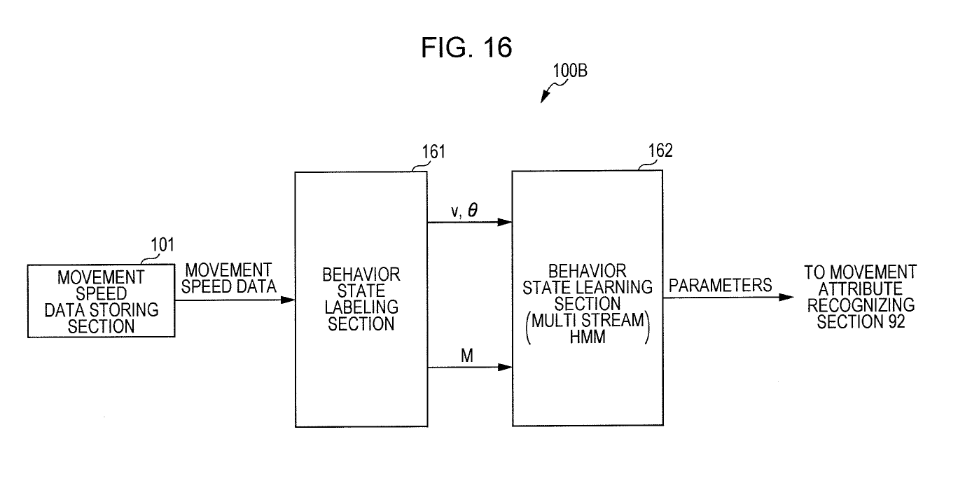

In FIGS. 6A and 6B, 16 states are arranged in a two-dimensional space in a lattice shape. That is, in FIGS. 6A and 6B, 4 states are arranged in the transverse direction and 4 states are also arranged in the longitudinal direction.

If it is assumed that the distance between the states adjacent to each other in the transverse direction, and the distance between the states adjacent to each other in the longitudinal direction are all 1, FIG. 6A illustrates the HMM to which a sparse restriction is applied, in which a state transition to a state in which the distance is equal to 1 or smaller is allowed, and a state transition to other states is not allowed.

Further, FIG. 6B illustrates the HMM to which a sparse restriction is applied, in which a state transition to a state in which the distance is equal to √2 or smaller is allowed, and a state transition to other states is not allowed.

In the example in FIG. 1, the movement history data x=x₁, x₂, . . . x_{T} is supplied to the prediction system 1, and the learning block 11 estimates the HMM parameters λ indicating the user activity model using the movement history data x=x₁, x₂, . . . x_{T}.

That is, the location (latitude and longitude) data at each time indicating a movement trace of the user is considered as observation data on probability variables which are normally distributed using spreading of a predetermined variance value from one point on a map corresponding to any one of the HMM states sᵢ. The learning block 11 optimizes the one point (center value μᵢ) on the map corresponding to each state sᵢ, the variance value σᵢ² thereof, and the state transition probability aᵢⱼ.

The initial probability πᵢ of the state sᵢ can be set to a constant value. For example, the initial probability πᵢ of each of M states sᵢ is set to 1/M.

The current location node estimating section 41 applies the Viterbi algorithm to the user activity model (HMM) obtained through learning, and calculates a course (state series) (route) (hereinafter, referred to as “maximum likelihood route”) of a state transition in which the likelihood in which the movement history data x=x₁, x₂, . . . x_{T} is observed becomes the maximum. Thus, the state sᵢ corresponding to the current location of the user is recognized.

Here, the Viterbi algorithm is an algorithm for determining a route (maximum likelihood route), among the routes of the state transitions using each state sᵢ as a starting point, in which a value (occurrence probability) obtained by accumulating the state transition probability aᵢⱼ in which the state sᵢ is transited to the state sⱼ at the time t and a probability (output probability obtained from the output probability density function bⱼ(x)) in which a sample value xₜ at the time t in the movement history data x=x₁, x₂, . . . x_{T} in the state transition is observed, over the length T of the time series data x after processing, becomes the maximum. Details of the Viterbi algorithm are disclosed in the above-described document A, P 347.

### [Example of Configuration of the Learning Pre-Processing Section 22]

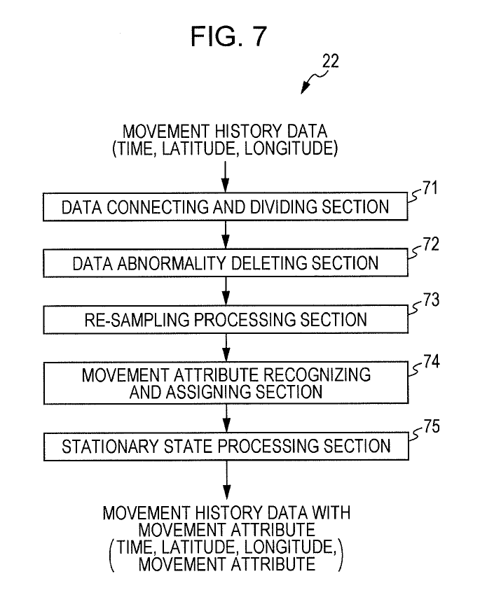

FIG. 7 is a block diagram illustrating an example of a detailed configuration of the learning pre-processing section 22 of the learning block 11.

The learning pre-processing section 22 includes a data connecting and dividing section 71, a data abnormality deleting section 72, a re-sampling processing section 73, a movement attribute recognizing and assigning section 74, and a stationary state processing section 75.

The data connecting and dividing section 71 performs connection and division processes of the movement history data. The movement history data is supplied to the data connecting and dividing section 71 as a log file in a predetermined unit such as one day, from the sensor device. Accordingly, the movement history data which is continuous during movement to a certain destination may be divided and obtained over a number of dates. The data connecting and dividing section 71 connects the divided movement history data. Specifically, if the time difference between the latest three-dimensional (latitude, longitude and time) data in one log file and the first three dimensional data in a log file created after the log file is within a predetermined time, the data connecting and dividing section 71 connects the movement history data in the files.

Further, for example, since a GPS sensor is not able to capture a satellite in a tunnel or underground, the acquisition interval of the movement history data may be long. In a case where the movement history data is lacking for a long time, it is difficult to estimate the user's location. Accordingly, in a case where the interval between before and after the acquisition time is equal to or longer than a predetermined time interval (hereinafter, referred to as “gap threshold time”) in the obtained movement history data, the data connecting and dividing section 71 divides the movement history data before and after the interval. Here, the gap threshold time corresponds to 5 minutes, 10 minutes, 1 hour or the like, for example.

The data abnormality deleting section 72 performs a process of deleting an obvious abnormality of the movement history data. For example, in a case where data on a position at a certain time is spaced (jumped) from the previous or next positions by 100 m or longer, the data on the position is erroneous. Thus, in a case where the data on the position at the certain time is spaced from the previous and next positions by the predetermined distance or longer, the data abnormality deleting section 72 deletes the three dimensional data from the movement history data.

The re-sampling processing section 73 performs a process of filling in a gap in the data in which the time interval between the acquisition times is shorter than the gap threshold time by a linear interpolation or the like. That is, in a case where the time interval between the acquisition times is equal to or longer than the gap threshold time, the movement history data is divided by the data connecting and dividing section 71, but a data gap in which the time interval between the acquisition times is shorter than the gap threshold time remains. Thus, the re-sampling processing section 73 fills in a gap in the data in which the time interval between the acquisition times is shorter than the gap threshold time.

The movement attribute recognizing and assigning section 74 recognizes the movement attribute regarding whether each piece of three dimensional data on the movement history is any one of the “stationary state” indicating that the user stays (stops) at the same position and the “movement state” indicating that the user moves, and assigns the movement attribute. Accordingly, movement history data with the movement attribute, in which the movement attribute is given to each item of three dimensional data of the movement history data, is generated.

The stationary state processing section 75 processes the three dimensional data in which the movement attribute is the “stationary state”, on the basis of the movement history data with the movement attribute supplied from the movement attribute recognizing and assigning section 74. More specifically, in a case where the movement attribute of the “stationary state” continues for a predetermined time or longer (hereinafter, referred to as “stationary threshold time”), the stationary state processing section 75 divides the movement history data before and after the stationary threshold time. Further, in a case where the movement attribute of the “stationary state” continues for a time shorter than the stationary threshold time, the stationary state processing section 75 holds location data of the plurality of pieces of three dimensional data which is in the “stationary state” which continues for a predetermined time within the stationary threshold time (modified into the same location data). Thus, it is possible to prevent the plurality of “stationary state” nodes from being allocated to the movement history data on the same destination or stopover. In other words, it is possible to prevent the same destination or stopover from being expressed as the plurality of nodes.

### [Process of the Learning Pre-Processing Section 22]

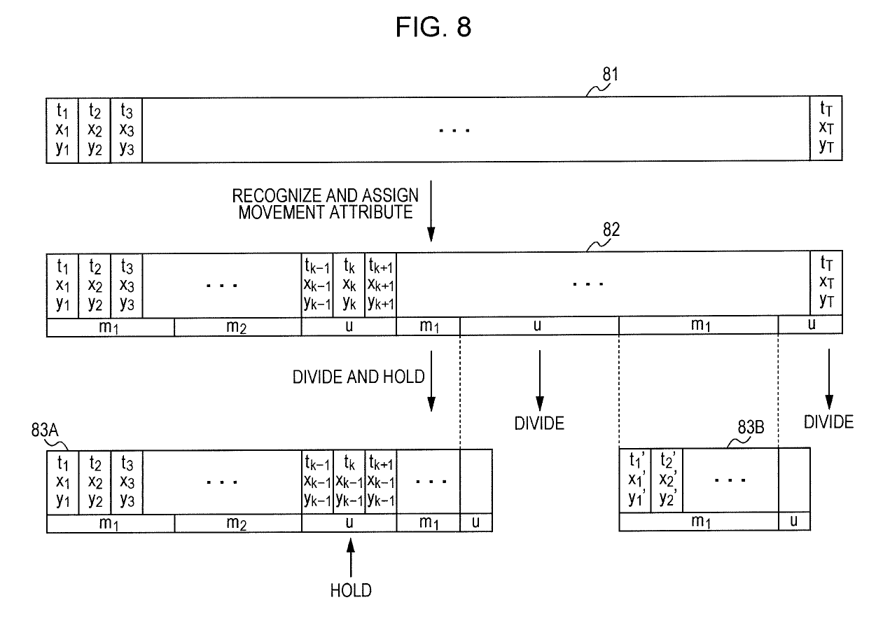

FIG. 8 is an image diagram conceptually illustrating a learning pre-process of the learning pre-processing section 22.

The movement attribute recognizing and assigning section 74 recognizes the movement attribute of the “stationary state” or the “movement state” and assigns the movement attribute, with respect to the movement history data 81 after the data is filled in by the re-sampling processing section 73, which is shown on the upper part of FIG. 8. As a result, movement history data 82 with the movement attribute is generated, which is shown in the middle of FIG. 8.

In the movement history data 82 with the movement attribute shown in the middle of FIG. 8, “m₁” and “m₂” represent movement attributes of the “movement state”, and “u” represents a movement attribute of the “stationary state”. Here, “m₁” and “m₂” represent the same “movement state”, but transportation means (vehicle, bus, train, walking or the like) are different.

Further, a process of dividing and holding the movement history data is performed by the stationary state processing section 75 with respect to the movement history data 82 with the movement attribute shown in the middle of FIG. 8, and thus, movement history data 83 (83A and 83B) with the movement attribute is generated in the lower part of FIG. 8.

In the movement history data 83 with the movement attribute, the division process is performed at the “movement state” location (three dimensional data) which is secondly generated in the movement history data 82 with the movement attribute, and the movement history data 83 with the movement attribute is divided into the movement history data 83A and 83B with two movement attributes.

In the division process, the movement history data is initially divided into the “movement state” which is secondly generated in the movement history data 82 with the movement attribute and the plurality of three dimensional data thereafter, to thereby generate the two movement history data 83A and 83B with the movement attribute. Then, the three dimensional data on the plurality of “movement states” which is equal to or longer than the latest stationary threshold time of the movement history data 83A with the movement attribute which is earlier in terms of time, among the movement history data 83A and 83B with the movement attribute after the division, is grouped into three dimensional data on one “stationary state”. Thus, unnecessary movement history data is deleted, and thus, the learning time can be reduced.

In the example shown in FIG. 8, the three dimensional data on the plurality of “movement states” which is thirdly generated the movement history data 82 with the movement attribute is data in which the “movement state” continues for the stationary threshold time or longer, and the same division process is performed therefor. However, since the three dimensional data after the division is not present, the three dimensional data on the plurality of “movement states” for the stationary threshold time or longer is grouped into the three dimensional data on one “stationary state”.

On the other hand, in the movement history data on the first “movement state” in the movement history data 83A with the movement attribute, the hold process is performed.

After the hold process, three dimensional data on three “movement states” {(tₖ₋₁, xₖ₋₁, yₖ₋₁), (tₖ, xₖ, yₖ), (tₖ₊1, xₖ₊₁, yₖ₊₁)} becomes {(tₖ₋₁, xₖ₋₁, yₖ₋₁), (tₖ, xₖ₋₁, yₖ₋₁), (tₖ₊₁, xₖ₋₁, yₖ₋₁)}. That is, the location data is modified into initial location data on the “movement state”. In the hold process, the location data may not be changed into the initial location data of the “movement state”, but may be changed into an average value of the locations, location data at a time in the middle of the “movement state” period, or the like.

### [Configuration Example of the Movement Attribute Recognizing and Assigning Section 74]

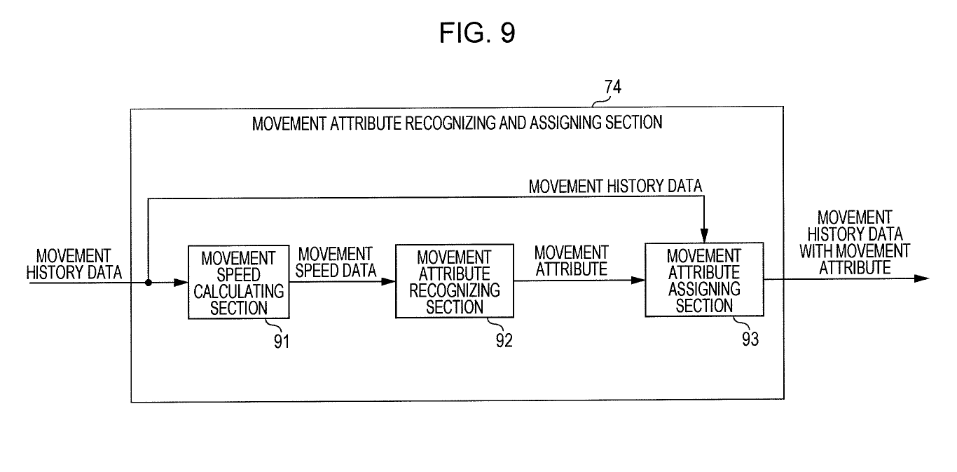

FIG. 9 is a block diagram illustrating a detailed configuration example of the movement attribute recognizing and assigning section 74.

The movement attribute recognizing and assigning section 74 includes a movement speed calculating section 91, a movement attribute recognizing section 92 and a movement attribute assigning section 93.

The movement speed calculating section 91 calculates the movement speed from the supplied movement history data.

Specifically, when the three dimensional data obtained in a k-th step (k-th) at a predetermined time interval is expressed as time tₖ, longitude yₖ, and latitude xₖ, a movement speed vxₖ in the k-th step in an x direction and a movement speed vyₖ in the k-th step in a y direction can be calculated by the following formula (1).

$${vx}_{k} = \frac{{x}_{k} - {x}_{k - 1 }}{{t}_{k} - {t}_{k - 1}} \\ {vy}_{k} = \frac{{y}_{k} - {y}_{k - 1}}{{t}_{k} - {t}_{k - 1}} \qquad ( 1 )$$

In the formula (1), data on the latitude and longitude is used as it is, but the process of converting the latitude and longitude into distances, or converting the speed to be expressed in the unit of per-hour or per-minute may be appropriately performed as necessary.

Further, the movement speed calculating section 91 may calculate the k-th movement speed vₖ expressed by the following formula (2) and the change θₖ in the proceeding direction, from the movement speeds vxₖ and vyₖ obtained by the formula (1), and may make use of them.

$${v}_{k} = \sqrt{{vx}_{k}^{2} + {vy}_{k}^{2}} \\ {θ}_{k} = {sin}^{- 1} ( \frac{{vx}_{k} \cdot {vy}_{k - 1} - {vx}_{k - 1} \cdot {vy}_{k}}{{v}_{k} \cdot {v}_{k - 1}} ) \qquad ( 2 )$$

If the movement speed vₖ and the change θₖ in the proceeding direction expressed by the formula (2) is used, it is possible to desirably extract characteristics in view of the following aspects, compared with the movement speeds vxₖ and vyₖ in the formula (1).

1. Since the data distribution of the movement speeds vxₖ and vyₖ is offset with reference to the latitude and longitude axes, if angles are different even with the same transportation means (train, walking or the like), it may be difficult to recognize it. However, in the case of the movement speed vₖ, such a possibility is decreased.

2. If the learning is performed by only the absolute value (|v|) of the movement speed, it is difficult to distinguish walking from staying stationary due to the absolute value |v| generated by noise in the device. Thus, it is possible to reduce the influence of the noises in consideration of the change in the proceeding direction.

3. Since the change in the proceeding direction is small during the movement but the proceeding direction is not determined during stay stationary, if the change in the proceeding direction is used, it is easy to recognize the movement and staying stationary.

According to these reasons, the movement speed calculating section 91 calculates the movement speed vₖ and the change θₖ in the proceeding direction shown by the formula (2), as data on the movement speed, and supplies it to the movement attribute recognizing section 92.

Further, in order to remove noise components before the calculation of the movement speed vₖ and the change θₖ in the proceeding direction, the movement speed calculating section 91 may perform a filtering process (pre-processing) using a moving average.

The sensor device may include a sensor device capable of outputting the movement speed. If such a sensor device is adopted, the movement speed calculating section 91 may be omitted, and the movement speed output by the sensor device may be used as it is. Hereinafter, the change θₖ in the proceeding direction is simply referred to as “proceeding direction θₖ”.

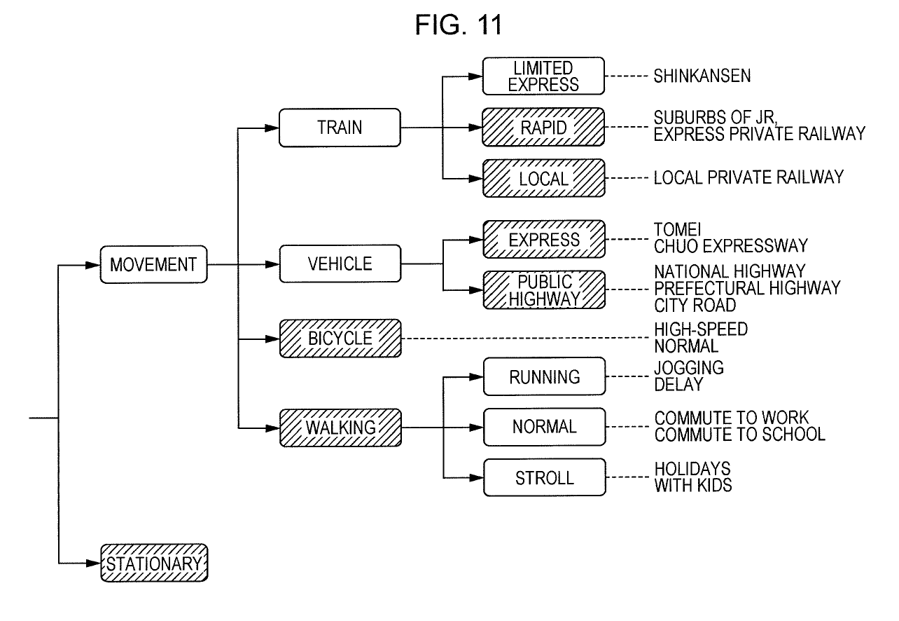

The movement attribute recognizing section 92 recognizes the movement attribute on the basis of the supplied movement speed, and supplies the recognition result to the movement attribute assigning section 93. More specifically, the movement attribute recognizing section 92 learns the behavior states (movement states) of the user as the probabilistic state transition model (HMM), and recognizes the movement attribute using the probabilistic state transition model obtained by the learning. As the movement attribute, it is necessary that at least the “stationary state” and the “movement state” are present. In this embodiment, as described later with reference to FIG. 11 or the like, the movement attribute recognizing section 92 outputs movement attributes obtained by classifying the “movement state” by the plurality of transportation means such as walking, a bicycle or a vehicle.

The movement attribute assigning section 93 assigns the movement attribute recognized by the movement attribute recognizing section 92, to each piece of three dimensional data which forms the movement history data, from the re-sampling processing section 73, generates the movement history data with the movement attribute, and then outputs it to the stationary state processing section 75.

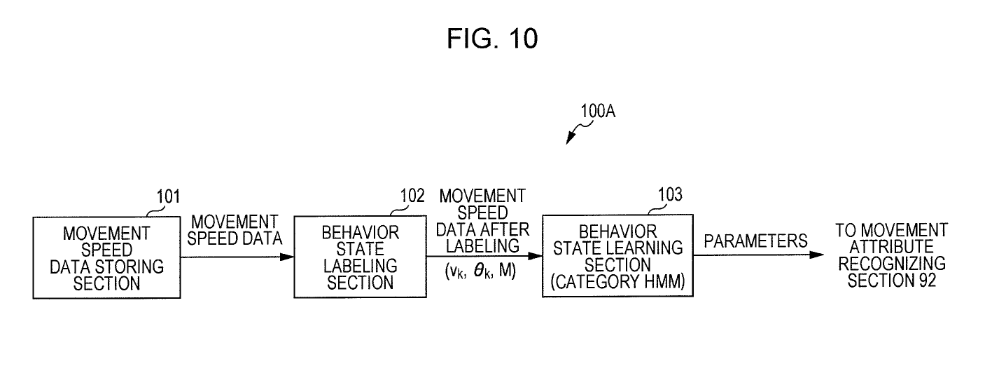

Next, a method of obtaining parameters of the probabilistic state transition model indicating the behavior state of the user which is used in the movement attribute recognizing section 92 will be described with reference to FIGS. 10 to 17.

### [First Configuration Example of the Learning Machine in the Movement Attribute Recognizing Section 92]

FIG. 10 is a diagram illustrating a configuration example of a learning machine 100A which learns parameters of the probabilistic state transition model used in the movement attribute recognizing section 92 by the category HMM.

In the category HMM, that teaching data for learning is data which belongs to any category (class) in advance, and the HMM parameters are learned according to categories.

The learning machine 100A includes a movement speed data storing section 101, a behavior state labeling section 102, and a behavior state learning section 103.

The movement speed data storing section 101 stores time series data on the movement speed as learning data.

The behavior state labeling section 102 assigns the behavior state of the user as a label (category), to the data on the movement speed which is sequentially supplied in a time series manner from the movement speed data storing section 101. The behavior state labeling section 102 supplies movement speed data in which the labeling in which the behavior state matches with the movement speed data is finished, to the behavior state learning section 103. For example, the data in which a label M indicating a behavior state is assigned to the k-th movement speed vₖ and the proceeding direction θₖ may be supplied to the behavior state learning section 103.

The behavior state learning section 103 classifies the movement speed data in which labeling is finished which is supplied from the behavior state labeling section 102 according to categories, and learns the parameters of the user behavior model (HMM) in the category unit. The parameters for every category obtained as the result of the learning are supplied to the movement attribute recognizing section 92.

### [Classification Example of Behavior States]

FIG. 11 is a diagram illustrating a classification example in a case where the behavior states are classified according to categories.

As shown in FIG. 11, firstly, the behavior states of the user may be classified into the stationary state and the movement state. In this embodiment, since it is necessary that at least the stationary state and the movement state exist, as described above, as the behavior state of the user recognized by the movement attribute recognizing section 92, it is necessary to classify the behavior state into the above-described two states.

Further, the movement state may be classified into a train, a vehicle (including bus or the like), a bicycle and walking, according to the transportation means. The train may be classified into limited express, rapid, local and the like. The vehicle may be classified into express, public highway and the like. Further, the walking may be classified into running, normal, stroll and the like.

In this embodiment, the behavior state of the user may be classified into “stationary”, “train (rapid)”, “train (local)”, “vehicle (express)”, “vehicle (public highway)”, “bicycle” and “walking”, as represented by oblique lines in FIG. 11. Further, the “train (limited express)” is omitted since learning data is hardly obtained.

The classification method of the category is not limited to the example shown in FIG. 11. Further, the change in the movement speed according to the transportation means is not significantly different according to the user, and thus, the time series data on the movement speeds as the learning data is not necessarily limited to a specific user which is a recognition target.

### [Processing Example of the Behavior State Labeling Section 102]

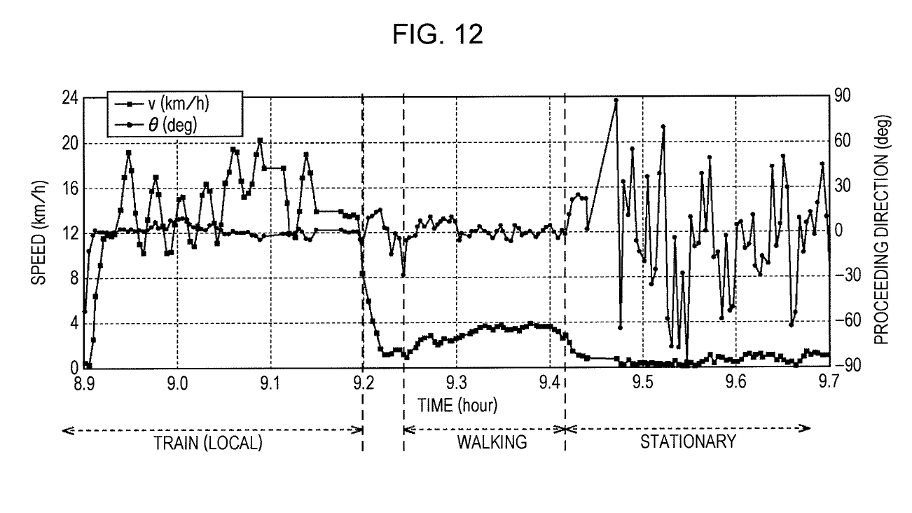

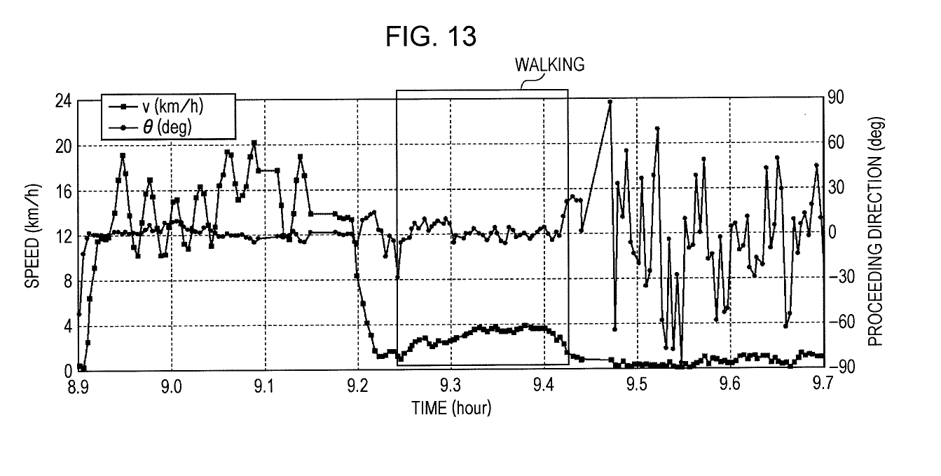

Next, a processing example of the behavior state labeling section 102 will be described with reference to FIGS. 12 and 13.

FIG. 12 is a diagram illustrating an example of time series data on the movement speed supplied to the behavior state labeling section 102.

In FIG. 12, the movement speed data (v, θ) supplied from the behavior state labeling section 102 is shown as patterns of (t, v) and (t, θ). In FIG. 12, a square plot (▪) represents the movement speed v, and a circle plot () represents the proceeding direction θ. Further, the transverse axis represents the time t, the right longitudinal axis represents the proceeding direction θ, and the left longitudinal axis represents the movement speed v.

Characters such as “train (local)”, “walking” and “stationary” shown in a lower part of the time axis in FIG. 12 are added for description. An initial part of the time series data in FIG. 12 is movement speed data in a case where the user is moving by train (local), the next part of thereof is movement speed data in a case where the user is moving on foot (“walking”), and the final part thereof is movement speed data in a case where the user is in the “stationary” state.

In a case where the user moves by the “train (local)”, since the train stops at a station, accelerates when leaving, and stops at a station by reducing the speed again, repeatedly, the plots of the movement speed v are repeated and fluctuate up and down. The reason why the movement speed does not become 0 even in a case where the train stops is that a filtering process is performed using a moving average.

Further, in a case where the user is moving “on foot (walking)” and in a case where the user is in the “stationary” state, it is difficult to distinguish the states from each other, but there is an obvious difference in the movement speeds v, through the filtering process using the moving average. Further, in the “stationary” state, the proceeding direction θ is instantaneously and significantly changed, and thus, differentiation from the “walking” becomes easy. In this way, it can be understood that the “walking” is easily distinguished from the “stationary” state through the filtering process using the moving average and expressing the movement of the user by the movement speed v and the proceeding direction θ.

A part between the “train (local)” and the “walking” is an obscure part in which behavior switching points are not clear for the filtering process.

FIG. 13 is a diagram illustrating an example in which labeling is performed to the time series data shown in FIG. 12.

For example, the behavior state labeling section 102 displays the movement speed data shown in FIG. 12 on a display. Further, the user performs an operation of surrounding a portion to be labeled in the movement speed data displayed on the display with a rectangular region using a mouse or the like. Further, the user inputs the label which is to be assigned to the designated data through a keyboard or the like. The behavior state labeling section 102 assigns the input label to the movement speed data included in the rectangular region designated by the user, to thereby perform the labeling.

FIG. 13 illustrates an example in which the movement speed data in the portion corresponding to the “walking” is indicated in the rectangular region. At this time, the portion in which the behavior switching points are not clear may not be included in the indicated region, for the filtering process. The length of the time series data is determined from the length in which the behavior difference obviously appears to the time series data. For example, the length may be about 20 steps (15 seconds×20 steps=300 seconds).

### [Configuration Example of the Behavior State Learning Section 103]

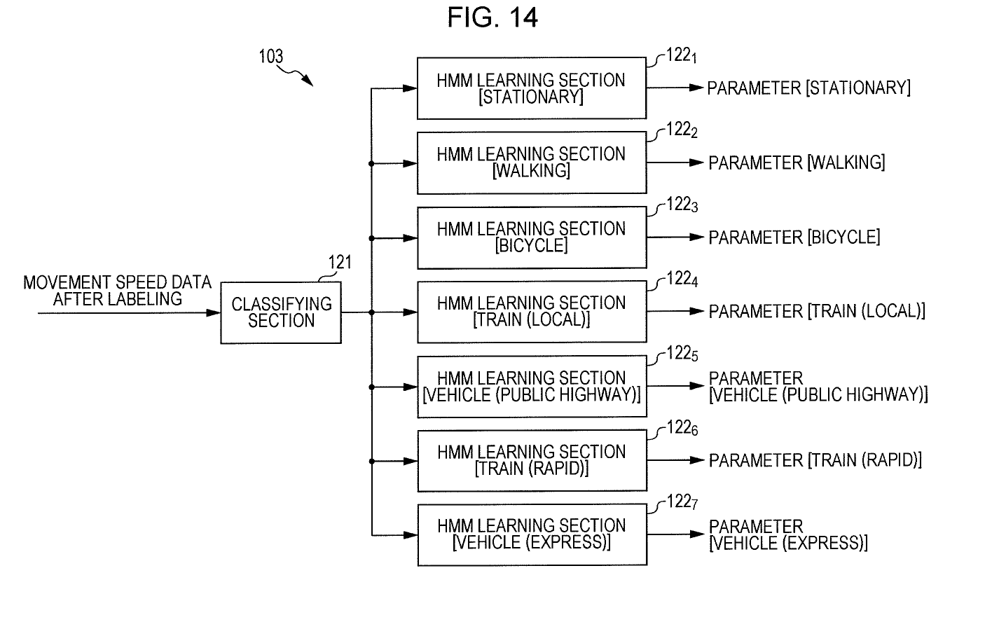

FIG. 14 is a block diagram illustrating an example of a configuration of the behavior state learning section 103 in FIG. 10.

The behavior state learning section 103 includes a classifying section 121 and HMM learning sections 122₁ to 122₇.

The classifying section 121 refers to the label of the movement speed label in which the labeling is finished, which is supplied from the behavior state labeling section 102, and supplies it to any one of the HMM learning sections 122₁ to 122₇ corresponding to the label. That is, in the behavior state learning section 103, the HMM learning section 122 is prepared according to the label (category), and the movement speed data in which the labeling is finished, which is supplied from the behavior state labeling section 102, is classified according to the label and supplied.

Each of the HMM learning sections 122₁ to 122₇ learns the learning model (HMM) using the supplied labeling-finished movement speed data. Further, each of the HMM learning sections 122₁ to 122₇ supplies the HMM parameters λ obtained by the learning to the movement attribute recognizing section 92 in FIG. 9.

The HMM learning section 122₁ learns a learning model (HMM) in a case where the label indicates the “stationary” state. The HMM learning section 122₂ learns a learning model (HMM) in a case where the label indicates the “walking” state. The HMM learning section 122₃ learns a learning model (HMM) in a case where the label indicates the “bicycle”. The HMM learning section 122₄ learns a learning model (HMM) in a case where the label indicates the “train (local)”. The HMM learning section 122₅ learns a learning model (HMM) in a case where the label indicates the “vehicle (public highway)”. The HMM learning section 122₆ learns a learning model (HMM) in a case where the label indicates the “train (rapid)”. The HMM learning section 122₇ learns a learning model (HMM) in a case where the label indicates the “vehicle (limited express)”.

### [First Configuration Example of the Movement Attribute Recognizing Section 92]

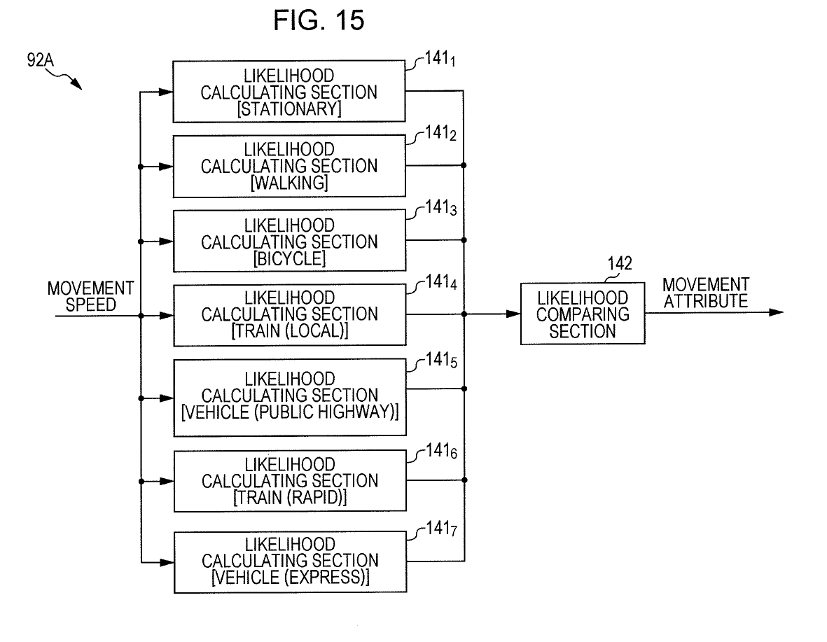

FIG. 15 is a block diagram illustrating a configuration example of a movement attribute recognizing section 92A which is the movement attribute recognizing section 92 in a case where the parameters learned by the learning machine 100A are used.

The movement attribute recognizing section 92A includes likelihood calculating sections 141₁ to 141₇ and a likelihood comparing section 142.

The likelihood calculating section 141₁ calculates a likelihood for the time series data on the movement speeds supplied from the movement speed calculating section 91 (FIG. 9), using the parameters obtained by the learning of the HMM learning section 122₁. That is, the likelihood calculating section 141₁ calculates the likelihood in which the behavior state is the “stationary” state.

The likelihood calculating section 141₂ calculates a likelihood for the time series data on the movement speeds supplied from the movement speed calculating section 91, using the parameters obtained by the learning of the HMM learning section 122₂. That is, the likelihood calculating section 141₂ calculates the likelihood in which the behavior state is the “walking” state.

The likelihood calculating section 141₃ calculates a likelihood for the time series data on the movement speeds supplied from the movement speed calculating section 91, using the parameters obtained by the learning of the HMM learning section 122₃. That is, the likelihood calculating section 141₃ calculates the likelihood in which the behavior state is the “bicycle”.

The likelihood calculating section 141₄ calculates a likelihood for the time series data on the movement speeds supplied from the movement speed calculating section 91, using the parameters obtained by the learning of the HMM learning section 122₄. That is, the likelihood calculating section 141₄ calculates the likelihood in which the behavior state is the “train (local)”.

The likelihood calculating section 141₅ calculates a likelihood for the time series data on the movement speeds supplied from the movement speed calculating section 91, using the parameters obtained by the learning of the HMM learning section 122₅. That is, the likelihood calculating section 141₅ calculates the likelihood in which the behavior state is the “vehicle (public highway)”.

The likelihood calculating section 141₆ calculates a likelihood for the time series data on the movement speeds supplied from the movement speed calculating section 91, using the parameters obtained by the learning of the HMM learning section 122₆. That is, the likelihood calculating section 141₆ calculates the likelihood in which the behavior state is the “train (rapid)”.

The likelihood calculating section 141₇ calculates a likelihood for the time series data on the movement speeds supplied from the movement speed calculating section 91, using the parameters obtained by the learning of the HMM learning section 122₇. That is, the likelihood calculating section 141₇ calculates the likelihood in which the behavior state is the “vehicle (express)”.

The likelihood comparing section 142 compares the likelihoods supplied from the respective likelihood calculating sections 141₁ to 141₇, selects a behavior state having the highest likelihood, and outputs it as the movement attribute.

### [Second Configuration Example of the Learning Machine in the Movement Attribute Recognizing Section 92]

FIG. 16 is a diagram illustrating a configuration example of a learning machine 100B which learns parameters of the user behavior model used in the movement attribute recognizing section 92 by a multi stream HMM.

The learning machine 100B includes a movement speed data storing section 101, a behavior state labeling section 161 and a behavior state learning section 162.

The behavior state labeling section 161 assigns the behavior state of the user to the movement speed data which is sequentially supplied in a time series manner from the movement speed data storing section 101, as a label (behavior mode). The behavior state labeling section 161 supplies time series data (v, θ) on the movement speeds and time series data on the behavior mode M associated with it to the behavior state learning section 162.

The behavior state learning section 162 learns the behavior state of the user by the multi stream HMM.

Here, the multi stream HMM is an HMM in which data is output according to a plurality of different probabilistic rules, from the state node having the same transition probability as a normal HMM. In the multi stream HMM, an output probability density function bⱼ(x) among the parameters λ, is prepared for each piece of time series data. In the multi stream HMM, it is possible to perform learning while associating the time series data (stream) of different types.

To the behavior state learning section 162 is supplied the time series data on the movement speed v which is a continuous quantity and the proceeding direction θ, and the time series on the behavior mode M which is a discrete quantity. The behavior state learning section 162 learns distribution parameters of the movement speed output from each state node and probabilities of the behavior mode. According to the multi stream HMM obtained by the learning, for example, a current state node is obtained from the time series data on the movement speeds. Further, it is possible to recognize the behavior mode from the obtained state node.

In the first configuration example using the category HMM, it is necessary to prepare seven HMMs for every category, but one HMM is sufficient in the multi stream HMM. Here, it is necessary that as many of the state nodes is prepared as the total number of the state nodes used in seven categories in the first configuration example.

### [Second Configuration Example of the Movement Attribute Recognizing Section 92]

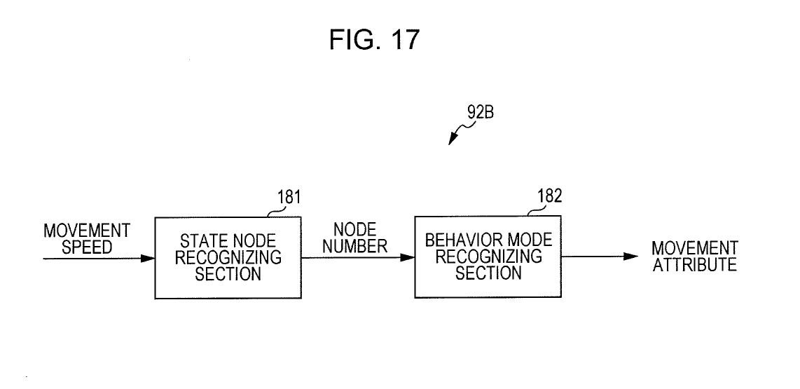

FIG. 17 is a block diagram illustrating a configuration example of a movement attribute recognizing section 92B which is the movement attribute recognizing section 92 in a case where the parameters learned by the learning machine 100B are used.

The movement attribute recognizing section 92B includes a state node recognizing section 181 and a behavior mode recognizing section 182.

The state node recognizing section 181 recognizes a state node of the multi stream HMM from the time series data on the movement speeds supplied from the movement speed calculating section 91, using the parameters of the multi stream HMM learned by the learning machine 100B. The state node recognizing section 181 supplies a node number of the recognized current state node to the behavior mode recognizing section 182.

The behavior mode recognizing section 182 outputs a behavior mode having the highest probability in the state nodes recognized in the state node recognizing section 181, as a movement attribute.

### [Process of the Learning Pre-Processing Section 22]

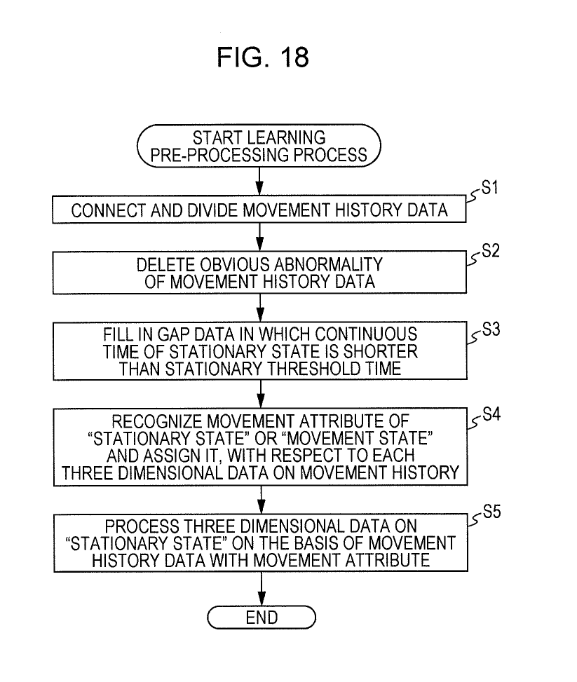

FIG. 18 is a flowchart illustrating a learning pre-processing process through the learning pre-processing section 22.

In the learning pre-processing process, firstly, in step S1, the data connecting and dividing section 71 performs the process of connecting and dividing the movement history data.

In step S2, the data abnormality deleting section 72 performs the process of deleting an obvious abnormality of the movement history data.

In step S3, the re-sampling processing section 73 performs the process of filling in a gap in the data in which the time interval between the acquisition times is shorter than the stationary threshold time using linear interpolation or the like.

In step S4, the movement attribute recognizing and assigning section 74 recognizes the movement attribute of the “stationary state” or the “movement state” and assigns it, with respect to each piece of three dimensional data on the movement history.

In step S5, the stationary state processing section 75 processes the three dimensional data in which the movement attribute is the “stationary state”, on the basis of the movement history data with the attribute supplied from the movement attribute recognizing and assigning section 74. Further, the stationary state processing section 75 outputs the movement history data with the movement attribute after the processing process to the learning main processing section 23, and then terminates the process.

As described above, in the learning pre-processing section 22, the movement history data is divided as necessary, and then the movement attribute is assigned, and thus, the movement history data with the movement attribute is supplied to the learning main processing section 23.

### [Detailed Configuration Example of the Learning Main Processing Section 23]

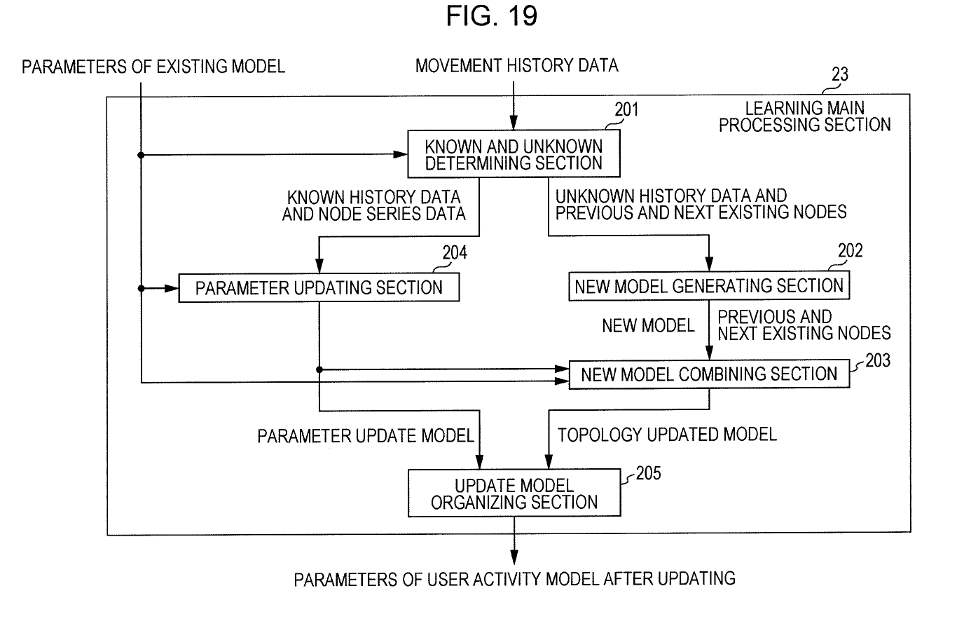

FIG. 19 is a block diagram illustrating a detailed configuration example of the learning main processing section 23 of the learning block 11.

The learning main processing section 23 includes a known or unknown determining section 201, a new model generating section 202, a new model combining section 203, a parameter updating section 204 and an updated model organizing section 205.

The movement history data supplied from the learning pre-processing section 22 (FIG. 1) is supplied to the known or unknown determining section 201. Further, in a case where learning is already performed at least once through the learning main processing section 23, the parameters of the user activity model obtained by the previous learning are obtained as the parameters of the existing model, from user model parameter storing section 12 (FIG. 1). The parameters of the existing model are supplied to the known or unknown determining section 201, the new model combining section 203 and the parameter updating section 204.

The known or unknown determining section 201 determines whether the movement history data supplied from the learning pre-processing section 22 is movement history data on a known route. In the second learning and thereafter, a part of the supplied movement history data may be movement history data on an unknown route and the remaining part thereof may be movement history data on the known route. The known or unknown determining section 201 estimates that each item of three dimensional data on the movement history data corresponds to any state node of the existing model, with respect to the movement history data which is determined as movement history data which is determined as being known. Further, the known or unknown determining section 201 supplies the known movement history data and the node series data corresponding thereto to the parameter updating section 204.

On the other hand, in a case where it is determined that the supplied movement history data is the movement history data on the unknown route, the known or unknown determining section 201 supplies the movement history data on the unknown data to the new model generating section 202. Further, in a case where the movement history data on the unknown route is connected with the movement history data on the known route, the known or unknown determining section 201 supplies the state nodes of the existing model corresponding to the previous and next known movement history data which become connection targets of the movement history data on the unknown route, to the new model generating section 202. Further, in a case where the state node of the existing model after the unknown movement history data is not present, for example, in a case where the user reaches an unknown destination through the unknown route from the known route and comes back, only the state node of the previous existing model is supplied to the new model generating section 202.

In the first learning, all the movement history data supplied from the learning pre-processing section 22 is supplied to the new model generating section 202 as the unknown movement history data. Further, in the first learning, since the previous and next state nodes of the existing model are not present, the supply to the new model generating section 202 is not performed.

The new model generating section 202 learns the user activity model using the unknown movement history data supplied from the known or unknown determining section 201. That is, the new model generating section 202 obtains parameters when the unknown movement history data is modeled using the probabilistic state transition model, and supplies it to the new model combining section 203. Here, the learned user activity model becomes a new model which is different from the existing model obtained by the previous learning. In the first learning and the second learning and thereafter, the data quantities of the unknown movement history data which is a learning target are only different from each other, and thus, parameters of the user activity model can be calculated by the same learning.

The new model generating section 202 supplies the parameters of the new model obtained by the learning to the new model combining section 203. Further, in a case where the previous and next state nodes of the existing model are supplied from the known or unknown determining section 201, the new model generating section 202 supplies the previous and next state nodes of the existing model to the new model combining section 203.

The new model combining section 203 updates the existing model obtained by the previous learning on the basis of the unknown movement history data in the second learning and thereafter. That is, the new model combining section 203 combines the existing model with the new model from the new model generating section 202 on the basis of the previous and next state nodes of the existing model of the unknown movement history data, and generates a user activity model after being updated. The user activity model updated by the new model combining section 203 is a topology updated model to which the state node is added according to the unknown movement history data.

In the new model combining section 203, in a case where the movement history data on the known route is not included in the movement history data supplied to the learning main processing section 23, the existing model which is combined with the new model from the new model generating section 202 becomes the existing model obtained from the user model parameter storing section 12 (FIG. 1). On the other hand, in a case where the movement history data on the known route is partly included in the movement history data supplied to the learning main processing section 23, the existing model which is combined with the new model becomes the existing model updated by the parameter updating section 204.

The parameter updating section 204 updates the existing model obtained by the previous learning, on the basis of the known movement history data and the node series data corresponding to the known movement history data. The parameters of the updated existing model are output to the new model combining section 203 and the updated model organizing section 205. In the updating through the parameter updating section 204, the state node is not added as described above.

The updated model organizing section 205 deletes a state node in which transition from other state nodes is not present and organizes the updated model, only using self transition, from among the topology updated model updated by the new model combining section 203 or the parameter updated model updated by the parameter updating section 204. The parameters of the updated model after organization is supplied to the learning post-processing section 24 and the user model parameter storing section 12 as the parameters of the user activity model obtained by the learning (update learning).

Next, details of the known or unknown determining section 201 will be described.

### [Detailed Configuration Example of the Known or Unknown Determining Section 201]

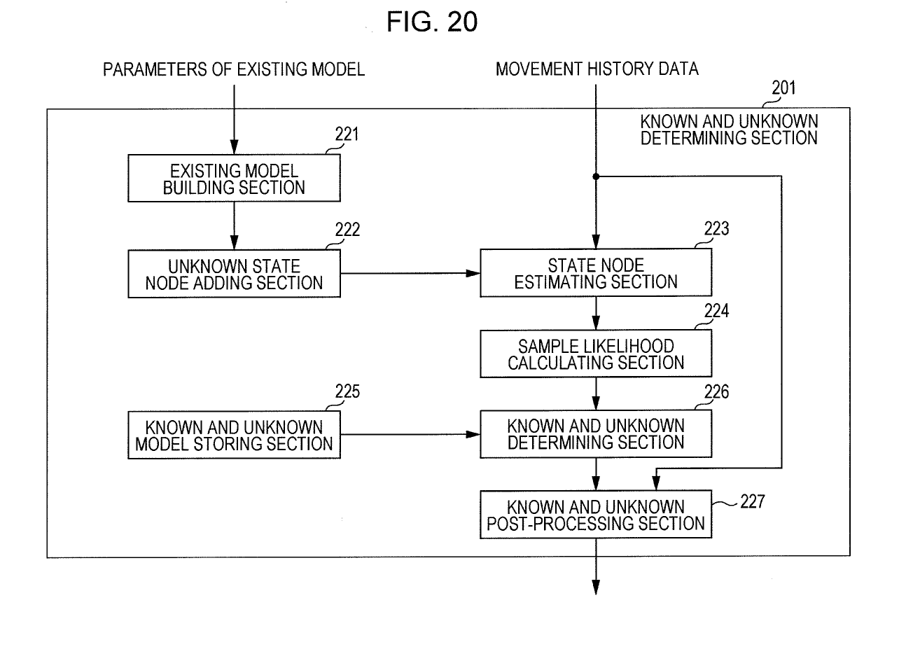

FIG. 20 is a block diagram illustrating a detailed configuration example of the known or unknown determining section 201.

In a case where the learning process is performed at least once using the learning main processing section 23, the parameters of the existing model are supplied to an existing model building section 221 from the user model parameter storing section 12 (FIG. 1). The existing model building section 221 builds the existing model on the basis of the parameters of the supplied existing model, and supplies it to an unknown state node adding section 222.

In a state where the learning process is not performed even once, initial parameters of the existing model are set in advance to the existing model building section 221. In the initial parameters of the existing model, the node number is 1, the transition probability of one state node is only the self transition, the center value is a value outside the range in which the three dimensional data (time, latitude and longitude) can be obtained, the variance value is the minimum variance value, and the node frequency is set to 1. Since at least one learning process is performed and the parameters of the existing model are supplied from the user model parameter storing section 12 (FIG. 1), the initial parameters of the existing model are overwritten and deleted.

The unknown state node adding section 222 adds one state node (hereinafter, referred to as “unknown state node”) which takes the unknown movement history data to the existing model built by the existing model building section 221. Thus, the learning model in which one state node is added to the existing model (hereinafter, referred to as “unknown state addition model) is built, and is supplied to a state node estimating section 223.

The state node estimating section 223 estimates the state node of the unknown state addition model corresponding to each item of three dimensional data of the supplied movement history data, by the Viterbi algorithm using the unknown state addition model supplied from the unknown state node adding section 222. Since one node which takes the unknown movement history data is added to the unknown state addition model, even though the input movement history data is the unknown movement history data, the Viterbi estimation is performed without failure. In contrast, in a case where one node which takes the movement history data is not added, the corresponding state node is not found with respect to the unknown movement history data, and thus, the Viterbi estimation fails.

A sample likelihood calculating section 224 calculates an expectation value of the observation likelihood as an index used for the known or unknown determination. The expectation value of the observation likelihood at a time t is obtained as L(t). In a case where the movement history data is data on the known route, the expectation value L(t) of the observation likelihood becomes large, and in a case where the movement history data is data on the unknown route, the expectation value L(t) of the observation likelihood becomes small.

A known or unknown determining section 226 performs the Viterbi determination using two known or unknown state models stored in a known or unknown model storing section 225, for the time series data on the expectation value L(t) of the observation likelihood (observation likelihood series data), to thereby perform the known or unknown determination.

A known or unknown post-processing section 227 modifies the state node which is determined as being known by the known or unknown determining section 226 in the state node which is estimated as being unknown by the state node estimating section 223, into the unknown state. That is, in the unknown determination, the estimation result in the state node estimating section 223 has priority.

Further, the known or unknown post-processing section 227 outputs the movement history data supplied from the learning pre-processing section 22 (FIG. 1) to the new model generating section 202 or the parameter updating section 204 with reference to the determination result after modification. That is, the known or unknown post-processing section 227 supplies movement history data in which the determination result is known and node series data corresponding to the movement history data to the parameter updating section 204 (FIG. 19). On the other hand, the known or unknown post-processing section 227 supplies movement history data in which the determination result is unknown to the new model generating section 202. In a case where the unknown movement history data is connected with the known movement history data, the known or unknown post-processing section 227 supplies the state node of the existing model corresponding to the previous and next known movement history data which become connection targets of the unknown movement history data to the new model generating section 202.

### [Configuration Process of Unknown State Addition Model]

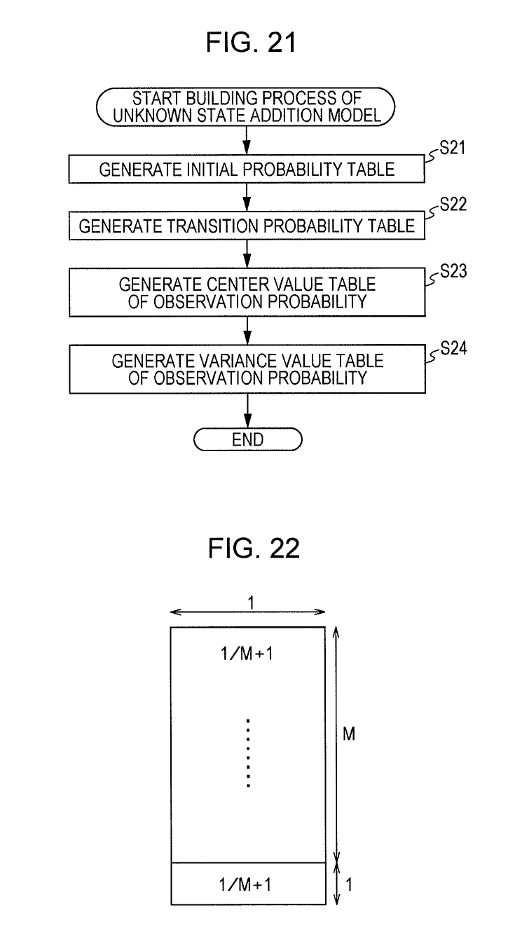

A building process of an unknown state addition model through the unknown state node adding section 222 will be described with reference to a flowchart in FIG. 21.

Firstly, in step S21, the unknown state node adding section 222 generates an initial probability table of the unknown state addition model which stores an initial probability of each state node of the unknown state addition model.

As shown in FIG. 22, in the initial probability table, the initial probability of each state node is set to, for example, 1/(M+1) of a equal probability, in a table of (M+1) rows and one column in which one state node which takes the unknown movement history data is added to M state nodes of the existing model.

In step S22, the unknown state node adding section 222 generates the transition probability table of the unknown state addition model in which the transition probability of each state node of the unknown state addition model is stored.

As shown in FIG. 23, the transition probability table includes a table of (M+1) rows and (M+1) columns. In the transition probability table, (1−eps) is multiplied by the state transition probability aᵢⱼ between the respective states of the existing model of the first row and the first column to the M-th row and the M-th column. Further, “eps” is set to each element of the (M+1)-th column of the transition probability table except for the lowest (M+1)-th row, and eps is set to each element of the (M+1)-th row except for the lowest (M+1)-th column. Here, “eps” is a predetermined value which is sufficiently smaller than 1, for example, which is about 1.0E-8, and is lower than any one of the transition probabilities between the state nodes of the existing model. In the unknown state addition model, the transition probability to the unknown state node from each state node of the existing model is set to eps, and the transition probability to each state nod of the existing model from the unknown state node is set to eps. Further, the element of the (M+1)-th row and the (M+1)-th column represents a self transition of the unknown state node, which is (1−M×eps). In the unknown state addition model in FIG. 23, the sum in the respective rows becomes 1.

In step S23, the unknown state node adding section 222 generates a center value table of the unknown state addition model in which the center value μₛᵢ(d) of the observation probability of each state node of the unknown state addition model is stored.

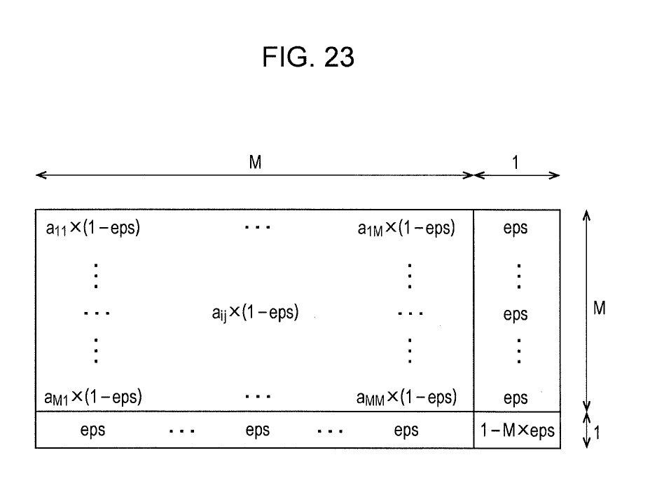

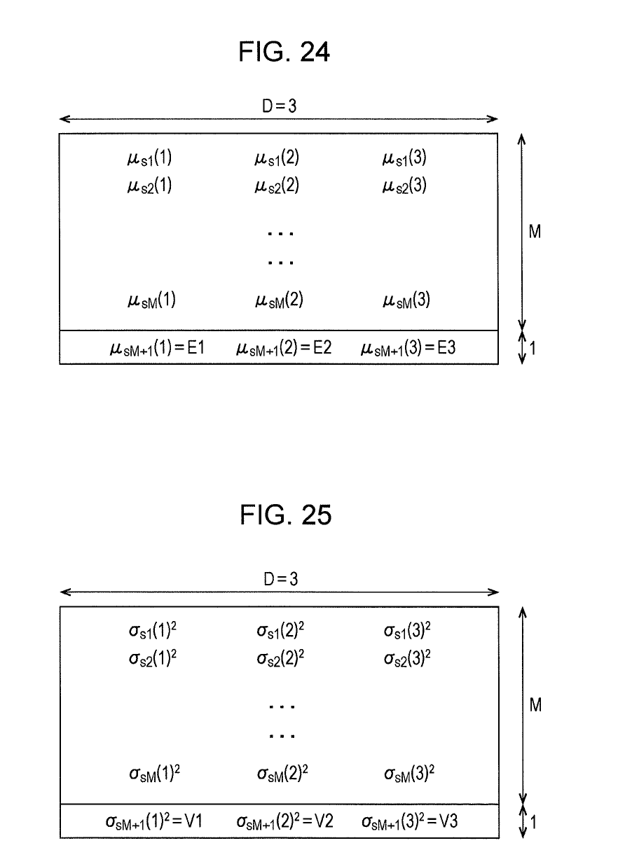

FIG. 24 is a diagram illustrating the center value table of the unknown state addition model generated in step S23. The column number of the center value table of the unknown state addition model corresponds to the dimension number D of the movement history data and the row number thereof corresponds to the number of the state nodes. Accordingly, in this embodiment, the center value table of the unknown state addition model includes (M+1) rows and three columns. Further, the center value table of the unknown state addition model is obtained by adding one row having center values of the unknown state nodes μ_{sM+1}(1)=E1, μ_{sM+1}(2)=E2, and μ_{sM+1}(3)=E3, as the (M+1)-th row, to the center value table of the M rows and D columns of the existing model.

Here, an arbitrary value can be set to E1, E2 and E3, respectively. For example, E1 may be set to “12” which is the center value of obtained times (0 to 24), and E2 and E3 may be set to “0” which is the center value of obtained latitudes and longitudes (−180 to 180). Further, for example, each of E1, E2 and E3 may be set to an average value of M center values μₛ₁(d) to μ_{sM}(d) of the existing model.

In step S24, the unknown state node adding section 222 generates a variance value table of the unknown state addition model in which a variance σₛᵢ(d)′² of the observation probability of each state node of the unknown state addition model is stored.

FIG. 25 is a diagram illustrating the variance value table of the unknown state addition model generated in step S24. The column number of the variance value table of the unknown state addition model corresponds to the dimension number D of the movement history data, and the row number thereof corresponds to the number of the state nodes. Accordingly, in this embodiment, the variance value table of the unknown state addition model includes (M+1) rows and three columns. Further, the variance value table of the unknown state addition model is obtained by adding one row having variance values of the unknown state node σ_{sM+1}(1)²=V1, σ_{sM+1}(2)²=V2, and σ_{sM+1}(3)²=V3, as the (M+1)-th row, to the variance value table of the M rows and D columns of the existing model.

Here, an arbitrary value may be set to V1, V2 and V3, respectively, but it is preferable to use a large value. For example, V1 is set to a value which is larger than the square of “12” so as to cover an obtained time range from 0 to 24. Further, V2 and V3 are set to a value which is larger than the square of 180 so as to cover an obtained latitude and longitude range from −180 to 180.

Through the above-described processes, the respective parameters of the unknown state addition model are set, and the unknown state addition model is built.

### [Calculation of Observation Likelihood of the Sample Likelihood Calculating Section 224]

Next, calculation of the observation likelihood performed by the sample likelihood calculating section 224 will be described.

The sample likelihood calculating section 224 calculates the expectation value L(t) of the observation likelihood as an index used for the known or unknown determination. The expectation value L(t) of the observation likelihood can be calculated by the following formula (3).

L(t)=Σ_{Si=1}^{M+1}N(xₜ|μₛᵢ,σₛᵢ²)·δ(si,t) (3)

Here, N(xₜ|μₛᵢ,σₛᵢ²) represents the observation likelihood in which the observation data xₜ is observed from the state node sᵢ. The observation data is based on the normal distribution of (μₛᵢ, σₛᵢ²). Further, δ(sᵢ,t) is a probability in which the observation data xₜ at the time t is output from the state node sᵢ. The probability δ(sᵢ,t) is calculated using the Viterbi algorithm. Specifically, the probability δ(sᵢ,t) is calculated according to the following processes 1) and 2). 1) A state node in which the product of the Viterbi estimation probability and the observation likelihood N(xₜ|μₛᵢ, σₛᵢ²) is the largest is selected from a state node sᵢ₋₁ immediately before the state node sᵢ. 2) The Viterbi estimation probability of the current state node sᵢ is normalized so as to be proportional to the observation likelihood of the Viterbi estimation probability of the selected immediately previous state node sᵢ₋₁. Here, 1) means that the movement history data so far is estimated in terms of maximum likelihood using the Viterbi algorithm while considering model transition restrictions, and 2) means that as the likelihood which survives in the maximum likelihood is normalized, a probability that the user currently exists in a specific state node is calculated.

The expectation value L(t) of the observation likelihood calculated by the following formula (3) becomes large if the unknown state addition model can sufficiently describe the observation data. On the other hand, in a case where the unknown state addition model does not sufficiently describe the observation data and in a case where the observation data is described using the unknown state node, the expectation value L(t) of the observation likelihood becomes small. Accordingly, the known or unknown determination can be performed using the size of the expectation value L(t) of the observation likelihood. Hereinafter, the expectation value L(t) of the observation likelihood is simply referred to as “observation likelihood L(t)”.

### [Known or Unknown Determination Process of the Known or Unknown Determining Section 226]

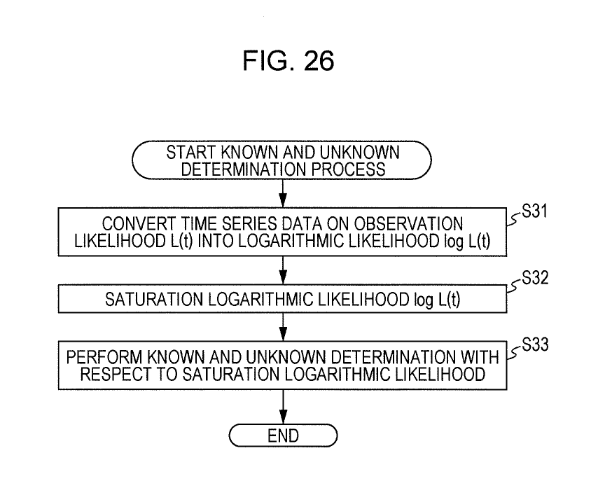

Next, a known or unknown determination process of the known or unknown determining section 226 which performs the known or unknown determination using the observation likelihood L(t) calculated in the sample likelihood calculating section 224 will be described with reference to a flowchart in FIG. 26.

Firstly, in step S31, the known or unknown determining section 226 obtains time series data on the observation likelihood L(t) corresponding to the node series data, from the sample likelihood calculating section 224. Further, the known or unknown determining section 226 converts each of the time series data item on the observation likelihood L(t) into a logarithmic likelihood log L(t). That is, the known or unknown determining section 226 calculates the log of the observation likelihood L(t) at each time t.

In step S32, the known or unknown determining section 226 performs a process of obtaining a saturation logarithmic likelihood in which the logarithmic likelihood log L(t) is saturated. Specifically, the known or unknown determining section 226 inputs a result obtained by subtracting a predetermined offset (threshold value) from the logarithmic likelihood log L(t) and by dividing it by a predetermined value to a tan h function, to thereby saturate the logarithmic likelihood log L(t). Through the processes in steps S31 and S32, the observation likelihood L(t) is converted into parameters which take a range from −1 to 1.

In step S33, the known or unknown determining section 226 performs the Viterbi determination using the HMM including two known or unknown states, to thereby perform the known or unknown determination for the saturated logarithmic likelihood.

The HMM including two states of the known state and the unknown state is expressed as the following formula (4).

$$π = \frac{1}{2} ( \begin{matrix}1 \\ 1\end{matrix} ) , A = ( \begin{matrix}1 - ɛ & ɛ \\ ɛ & 1 - ɛ\end{matrix} ) , μ = ( \begin{matrix}1 \\ - 1\end{matrix} ) , {σ}^{2} = ( \begin{matrix}1 \\ 1\end{matrix} ) \qquad ( 4 )$$

That is, initial probabilities π of the known state and the unknown state are the same probability (0.5). Further, in a case where the user movement history is considered, it is difficult to frequently switch the known state and the unknown state. Further, in a case where the user moves along the known route and in a case where the user moves along the unknown route, it can be considered that the user continues to move along the route to some degree after switching. Accordingly, a transition probability A is set so that the self transition probability becomes high in each of the known state and the unknown state, using a predetermined value which is very much smaller than 1 as ε. The observation probability is distributed between 1 in the known state and −1 in the unknown state, and the variance value is set to 1.

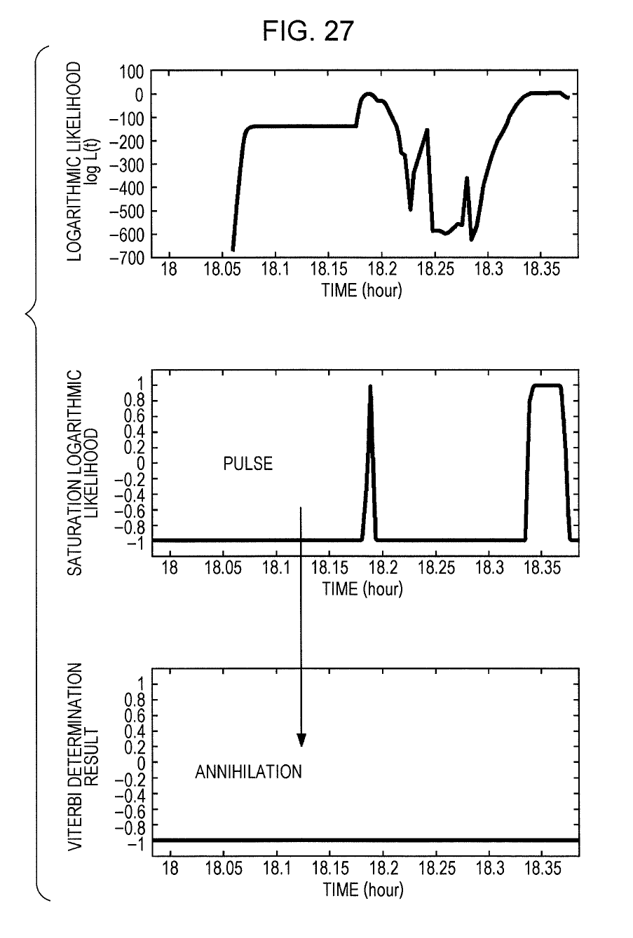

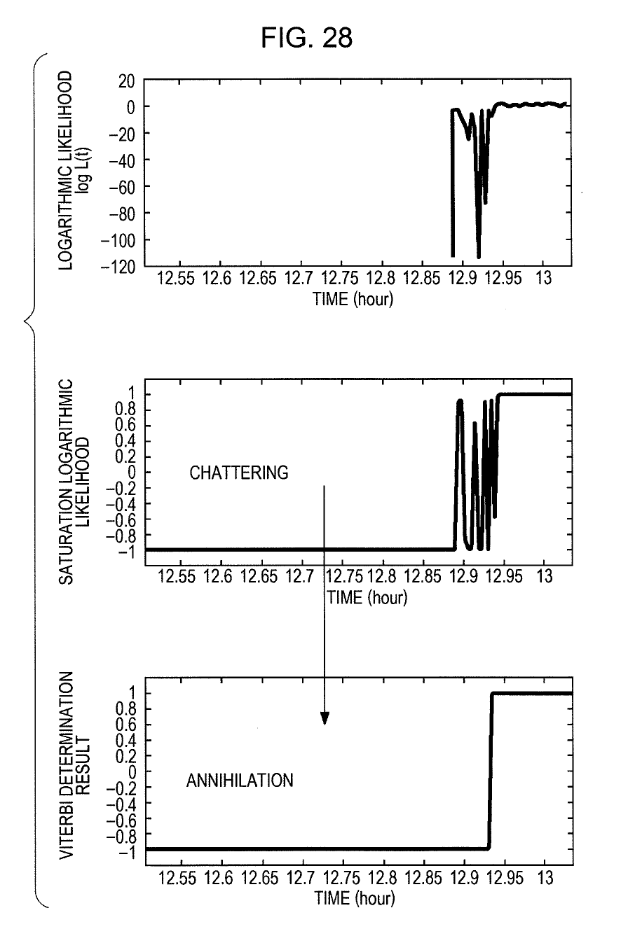

FIGS. 27 and 28 illustrate results obtained by performing the known or unknown determination process in FIG. 27, with respect to the time series data on two certain observation likelihoods L(t).

In FIGS. 27 and 28, an upper graph illustrates a result obtained by converting the time series data on the observation likelihood L(t) into the logarithmic likelihood log L(t), a mid graph illustrates the saturated logarithmic likelihood in which the logarithmic likelihood log L(t) is saturated, and a lower graph illustrates a known or unknown determination result. According to the known or unknown determination result, “−1” represents the unknown state, and “1” represents the known state.

Referring to FIGS. 27 and 28, in a case where the logarithmic likelihood log L(t) is simply compared with a predetermined threshold value, the known state and the unknown state may be frequently switched. However, as described above, since the user movement behavior is performed with a certain purpose, it is difficult to frequently switch the known state and the unknown state.

Thus, the determination is performed by the hidden Markov's model of two states set so that the self transition probability becomes high in each of the known state and the unknown state, and thus, it is possible to switch the known state and the unknown state at an appropriate timing, as shown in the lower known or unknown determination result. As seen from the calculation result of the saturated logarithmic likelihood, the known state may be generated in only a short time in FIG. 27, and a chattering may be generated in FIG. 28, but the known or unknown determination result shows that a stable known or unknown state can be obtained. Accordingly, it is possible to perform the stable known or unknown determination with respect to the time series data on the observation likelihood L(t) using the known or unknown determination process in FIG. 27.

Since the known or unknown determination method is sufficient if two values of the known state and the unknown state can be discriminated on the basis of the time series data on the observation likelihood L(t), it is not limited to the above-described method. For example, a method may be used in which low pass filtering is performed for the time series data on the observation likelihood L(t) to binarize the known state and the unknown state.

Further, in the known or unknown determination using the Viterbi estimation or the low pass filter, a state node estimated as the unknown state in the state node estimating section 223 is rarely determined as the known state. In such a case, it is possible to employ any one of the following (1) and (2) methods. (1) The estimation result (that is, unknown) of the state node is prior to the determination result of the above-described known or unknown determination. (2) The state node is replaced with the estimation result (that is, known) of the state node before or after the state node of the unknown estimation result appears. Here, the state node which becomes the replacement target may be determined in advance as any one of the state nodes before and after the state node of the unknown estimation result appears, or may be a state node having a high observation likelihood among the previous and next state nodes. In (1), the estimation result has the priority, and the determination result is modified into the unknown state. In (2), the determination result has the priority, and the estimation result is modified into the known state.

Next, details of the new model generating section 202 will be described.

### [Detailed Configuration Example of the New Model Generating Section 202]

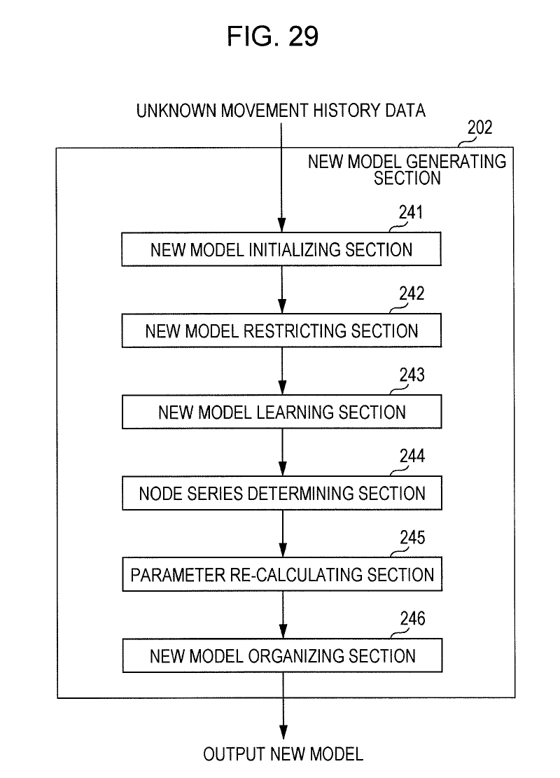

FIG. 29 is a block diagram illustrating a detailed configuration example of the new model generating section 202.

The new model generating section 202 includes a new model initializing section 241, a new model restricting section 242, a new model learning section 243, a node series determining section 244, a parameter re-calculating section 245, and a new model organizing section 246.

The unknown movement history data is supplied to the new model generating section 202 from the known or unknown determining section 201. Further, in a case where the unknown movement history data is connected with the known movement history data, the state nodes of the existing model before and after the unknown movement history data are also supplied. The unknown movement history data supplied from the known or unknown determining section 201 and the previous and next state nodes of the existing model can be acquired by each section of the new model generating section 202 as necessary.

The new model initializing section 241 designates (generates while securing a memory) an HMM having the same state node number as the sample number of the supplied unknown movement history data, as a new model.

The new model restricting section 242 sets a left-to-right restriction to the new model declared in the new model initializing section 241. This means that one movement behavior has a strong unidirectional characteristic, and time has a unidirectional characteristic restriction even though the unidirectional characteristic is not present in the movement direction.

The new model learning section 243 learns a new model using the unknown movement history data. That is, the new model learning section 243 obtains parameters of HMM with the left-to-right restriction indicating the new model, using the unknown movement history data supplied from the known or unknown determining section 201.

The node series determining section 244 generates the node series data obtained by converting each item of three dimensional data on the unknown movement history data into a state node sᵢ of the new model using the new model obtained by learning in the new model learning section 243, and then supplies it to the parameter re-calculating section 245. Specifically, the node series determining section 244 repeats a process of recognizing the user's current state node sᵢ corresponding to the input user time, latitude and longitude from the new model based on the parameters supplied from the new model learning section 243, up to the final step from the initial step of the unknown movement history data.

The parameter re-calculating section 245 calculates parameters of the node series data corresponding to the HMM parameters of the movement history data, on the basis of the node series data supplied from the node series determining section 244. That is, the parameter re-calculating section 245 calculates an initial probability of the node series data <πᵢ>, a state transition probability <Aᵢⱼ> and an observation probability (center value <μᵢ> and variance value <σᵢ²>) corresponding to the initial probability πᵢ of the HMM of the unknown movement history data, the state transition probability aᵢⱼ, and the observation probability (center value μᵢ and variance value σᵢ²). Hereinafter, the initial probability πᵢ, the state transition probability aᵢⱼ and the observation probability (center value μᵢ and variance value σᵢ²) surrounded by “< >” represent parameters recalculated in the node series data.

Further, the parameter re-calculating section 245 calculates a transition frequency ij> of each state transition, a state frequency <CNT_ALLᵢ> and a state initial frequency <CNT_STARTᵢ> of each state node sᵢ.

Here, the transition frequency ij> represents the frequency (count value) in which transition is performed to a state node sⱼ from a state node sᵢ, where i=1 to N, and j=1 to N (N is a final node number of the time series data (=node number)). The state frequency <CNT_ALLᵢ> is the total number of the state nodes sᵢ in all the node series data and the state initial frequency <CNT_STARTᵢ> is the number of the state nodes in which the head of the node series data is the state node sᵢ.

Generally, an initial probability πᵢ_{_{—}}_{updates} a state transition probability σᵢ_{_{—}}_{update}, and a center value μᵢ_{_{—}}_{update} and a variance value σᵢ_{_{—}}_{update}² of the observation probability after updating may be expressed as follows.

$${μ}_{i \_ update} = \frac{{μ}_{i \_ current } \cdot {n}_{i \_ current} + {μ}_{i \_ new} \cdot {n}_{i \_ new}}{{n}_{i \_ current} + {n}_{i \_ new}}$$

$${σ}_{i \_ update}^{2} + {μ}_{i \_ update}^{2} = \frac{( {σ}_{i \_ current}^{2} + {μ}_{i \_ current}^{2} ) \cdot {n}_{i \_ current} + ( {σ}_{i \_ new}^{2} + {μ}_{i \_ new}^{2} ) \cdot {n}_{i \_ new}}{{n}_{i \_ current} + {n}_{i \_ new}}$$

$${π}_{i \_ update} = \frac{{π}_{i \_ currenet} \cdot {n}_{i \_ current} + {π}_{i \_ new} \cdot {n}_{i \_ new}}{{n}_{i \_ current} + {n}_{i \_ new}}$$

$${a}_{ij \_ update} = \frac{{a}_{ij \_ current} \cdot {n}_{i \_ current} + {a}_{ij \_ new} \cdot {n}_{i \_ new}}{{n}_{i \_ current} + {n}_{i \_ new}}$$

Here, πᵢ_{_{—}}_{current}, aᵢⱼ_{_{—current}} and μᵢ_{_{—}}_{current} and σᵢ_{_{—}}_{current}² are the initial probability of the state node sᵢ, the state transition probability, and the center value and variance value of the observation probability, in the existing node series data. Further, πᵢ_{_{new}}, aᵢⱼ_{_{—}}_{new} and μᵢ_{_{—new}} and σᵢ_{_{—}}_{new}² are the initial probability of the state node sᵢ, the state transition probability, and the center value and variance value of the observation probability, in the added node series data. Here, nᵢ_{_{—}}_{current} and nᵢ_{_{—}}_{new} are the number of nodes corresponding to the existing part of the state node sᵢ of the node series data and the number of nodes of the added part thereof.

Accordingly, the parameter re-calculating section 245 calculates the transition frequency ij> of each state transition, the state frequency <CNT_ALLᵢ> and the state initial frequency <CNT_STARTᵢ> of each state node sᵢ for storage, to thereby easily perform the next updating calculation.

Instead of the frequency calculation and storage, the frequency may be probabilistically counted, to handle non-integer components. Further, instead of the frequency, parameters such as frequency×average value or frequency×variance value may be stored.

The parameter re-calculating section 245 calculates the state initial frequency <CNT_STARTᵢ> and the number of the node series data items which is the total number of the node series data items supplied from the node series determining section 244.

The new model organizing section 246 deletes an unused state node from each state node sᵢ of the HMM which is the new model which is declared by the new model initializing section 241, to thereby organize the new model. Specifically, the new model organizing section 246 deletes the state node sᵢ in which the state frequency <CNT_ALLᵢ> calculated in the parameter re-calculating section 245 is 0. The new model (parameters) after being organized by the new model organizing section 246 is output to the new model combining section 203. Further, in a case where the state nodes of the existing model before and after the unknown movement history data are supplied from the known or unknown determining section 201, these are also output to the new model combining section 203.

### [Learning Process of the New Model Learning Section 243]

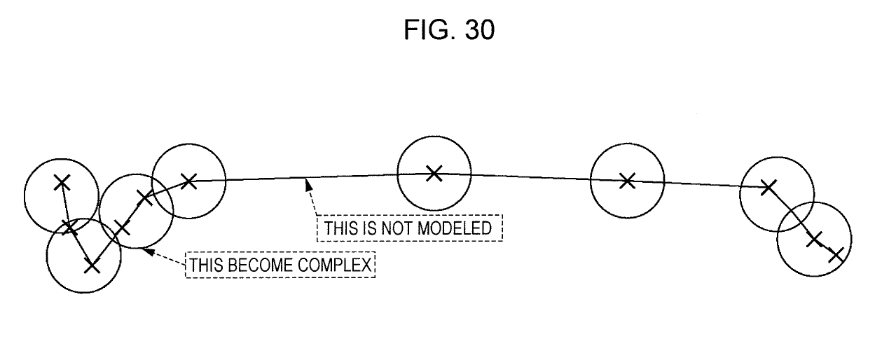

Next, a learning process of the new model learning section 243 will be described with reference to FIGS. 30 to 33.

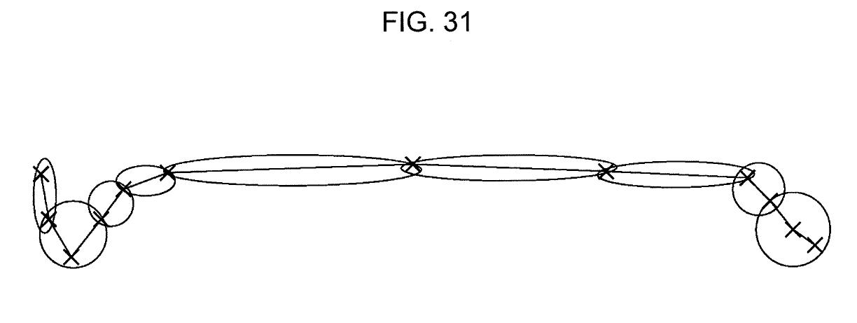

Firstly, a difference between the learning model through a normal HMM and the learning model performed by the new model learning section 243 will be described with reference to FIGS. 30 and 31.

In a case where the user movement history is modeled in a discrete state like the HMM, data obtained by sampling the movement route at a constant time interval is normally modeled. When the movement history data is obtained, in a case where sufficient samples are not obtained without shortening the sampling interval due to a power saving requirement or the like, the sample number and the node number may be not much changed or the sample number may be small compared with the node number. In such a case, in a case where state nodes are assumed in which the observed data is normally distributed around a predetermined position, one sample may be modeled by one node. In this case, the variance value of the nodes converges to a small value (or 0), and the proximity of the samples may not be modeled.

Accordingly, routes between the sampled samples are not modeled.

FIG. 30 is a diagram illustrating a concept when the movement history is modeled by the normal HMM. A straight line (line segment) in FIG. 30 represents an actual movement route of the user, an X-mark (X) represents a sample obtained as the movement history data, and a circle (∘) which surrounds the sample represents a node.

As shown in FIG. 30, since a place (region) where a sample is not obtained at a short distance is not modeled, for example, in a case where the user moves at a high speed by train, the route between the samples is not modeled. On the other hand, in a case where the user moves at a slow speed on foot, a plurality of samples may be modeled in one node. In such a case, the movement history may not be appropriately expressed by nodes.

Further, in a case where the user passes through the same movement route two times, if the variance value of the nodes converges to a very small value (or 0), the position where the user passes for the second time is not modeled by the node expressed when the user passes for the first time, and a different node may be allocated thereto.

In order to avoid such a problem, it may be considered that a lower limit is set to the variance value of the nodes, and a route of a predetermined region is necessarily modeled from the samples.

However, if the variance value is set to be large, a possibility that a different route is considered as the same route is increased. For example, there is a problem that it is considered that different routes proceeding parallel to each other are the same route. Further, if the variance value is set to be large, it is difficult to reproduce the movement history data when the movement speed is slow with high accuracy. In contrast, if the variance value is excessively small, the movement history data when the movement speed is high is not recognized as the same route. Since the actual movement history data samples have a variety of distance senses due to differences in movement speed, it is difficult to determine the lower limit of the variance value of the nodes which is suitable for all the samples.

Thus, as shown in FIG. 31, the new model learning section 243 assumes a model in which one state node necessarily reflects two continuous samples, and thus models the samples and the routes between the samples. In all the new models, the new model learning section 243 performs modeling in which each node sequentially connects two continuous samples. Accordingly, regions of all routes may be expressed as the new model to be connected in chains.

Further, even though the interval between the samples is long, since the modeling is performed to include two samples, the variance value of the nodes can be set to be small. In contrast, since the modeling can be similarly performed even in the case where the interval between the samples is short, it is possible to realize a scale free modeling.

As described later, the new model learning section 243 can perform modeling so that one state node reflects three or more continuous samples, and the number of the samples reflected by one state node for modeling can be appropriately determined.

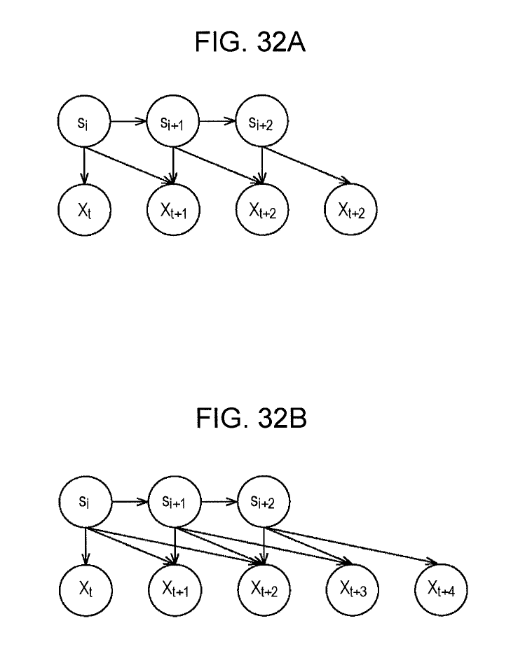

FIGS. 32A and 32B are diagrams illustrating the learning model of the new model learning section 243 using a graphic model.

The learning model in FIG. 32A is a model in which a certain current state node observes current data and the previous (next) two samples. In FIG. 32A, an arrow mark from one state node directs downward and to a lower right portion, but a certain model in which an arrow directs downward and to a lower left portion may be used.

In this embodiment, as shown in FIG. 31, the model in which one state node expresses two continuous samples is employed, but a model in which one state node expresses three or more continuous samples may be employed. A model in FIG. 32B is a graphic model in which one state node expresses three continuous samples.

### [New Model Learning Process of the New Model Learning Section 243]

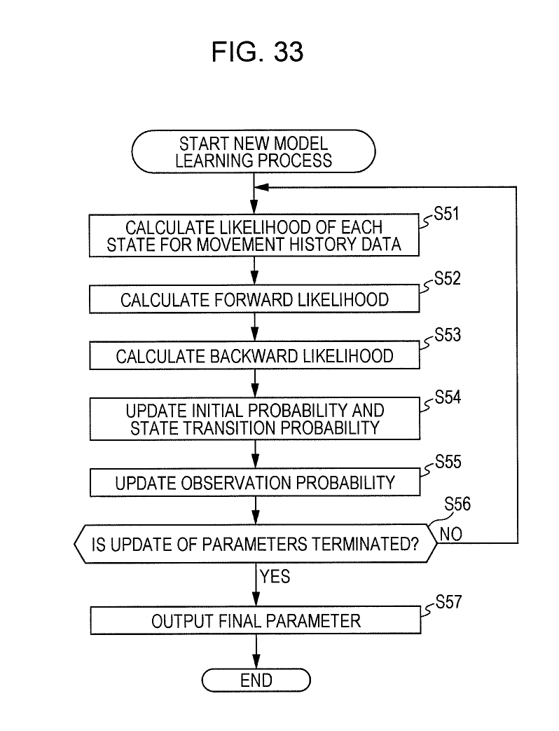

Next, the new model learning process of the new model learning section 243 will be described with reference to a flowchart in FIG. 33.

Firstly, in step S51, the new model learning section 243 calculates the likelihood of each state for the unknown movement history data. Specifically, the new model learning section 243 calculates an observation likelihood P(xₜ, xₜ₊₁|sᵢ) in which it is assumed that two samples of the movement history data, location data xₜ at a time t, and location data xₜ₊ᵢ at a time t+1 are output at the time of transition to the state sᵢ in the HMM indicting the user activity model, using the following formula (5).

$$P ( {x}_{t} , {x}_{t + 1} \vert {s}_{i} ) = N ( {x}_{t} ( 1 ) \vert {μ}_{si} ( 1 ) , {{σ}_{si} ( 1 )}^{2} ) \cdot N ( {x}_{t + 1} ( 1 ) \vert {μ}_{si} ( 1 ) , {{σ}_{si} ( 1 )}^{2} ) \times N ( {x}_{t} ( 2 ) \vert {μ}_{si} ( 2 ) , {{σ}_{si} ( 2 )}^{2} ) \cdot N ( {x}_{t + 1} ( 2 ) \vert {μ}_{si} ( 2 ) , {{σ}_{si} ( 2 )}^{2} ) \times N ( {x}_{t} ( 3 ) \vert {μ}_{si} ( 3 ) , {{σ}_{si} ( 3 )}^{2} ) \cdot N ( {x}_{t + 1} ( 3 ) \vert {μ}_{si} ( 3 ) , {{σ}_{si} ( 3 )}^{2} ) \qquad ( 5 )$$

Here, the time t represents the order (the number of steps) of the time series data, which is not a measured time of the time series data, and takes a value of 1 to T (the number of samples of the time series data). Further, in formula (5), xₜ(1), xₜ(2), and xₜ(3) represent the time, latitude and longitude of the movement history data xₜ, respectively. Further, N( ) in the formula (5) represents a singular normal distribution, μₛᵢ(1) and σₛᵢ(1)² represent a center value and a variance value of the singular normal distribution in time. Further, μₛᵢ(2) and σₛᵢ(2)² represent a center value and a variance value in latitude, and μₛᵢ(3) and σₛᵢ(3)² represent a center value and a variance value of the singular normal distribution in longitude.

The observation likelihood P(xₜ, xₜ₊₁|sᵢ) becomes the product of distributions in respective observation series, since the original time series data has the same time distribution as time series data which is adjacent thereto.

The observation likelihood P(xₜ, x_{t+w}|sᵢ) of a model in which one state node expresses W or more continuous samples can be expressed by the following formula (6). It is possible to generalize the dimension number D of the time series data to value larger than 3.

$$P ( {x}_{t} , … , {x}_{t + w} \vert {s}_{i} ) = {\prod }_{w = 1}^{W} N ( {x}_{t + w - 1} ( 1 ) \vert {μ}_{si} ( 1 ) , {{σ}_{si} ( 1 )}^{2} ) \times {\prod }_{w = 1}^{W} N ( {x}_{t + w - 1} ( 2 ) \vert {μ}_{si} ( 2 ) , {{σ}_{si} ( 2 )}^{2} ) \times {\prod }_{w = 1}^{W} N ( {x}_{t + w - 1} ( 3 ) \vert {μ}_{si} ( 3 ) , {{σ}_{si} ( 3 )}^{2} ) \qquad ( 6 )$$

In step S51, the observation likelihood P(xₜ, xₜ₊₁|sᵢ) through the formula (5) is calculated by the new model learning section 243, with respect to a combination of all the states sᵢ and the three dimensional data xₜ.

Next, in step S52, the new model learning section 243 calculates a forward likelihood αₜ(sᵢ) in all the states sᵢ at each time t. That is, the new model learning section 243 sequentially calculates the forward likelihood αₜ(s₁) in the states sᵢ at each time t from the time 1 to the final time T, using the following formulas (7) and (8).

$$\begin{matrix}{α}_{1} ( {s}_{i} ) = {π}_{si} & ( 7 ) \\ {α}_{t} ( {s}_{i} ) = {\sum }_{j = 1}^{M} {α}_{t - 1} ( {s}_{j} ) {a}_{ji} P ( {x}_{t} , {x}_{t + 1} \vert {s}_{i} ) & ( 8 )\end{matrix}$$

Here, “πₛᵢ” in the formula (7) represents an initial probability of the state sᵢ. Further, “aⱼᵢ” in the formula (8) represents a state transition probability from the state s₃ to the state sᵢ. The initial probability πₛᵢ and the initial value of the state transition probability aⱼᵢ are given from the outside, for example.

In step S53, the new model learning section 243 calculates backward likelihoods βₜ(sᵢ) of all the states sᵢ at each time t. That is, the new model learning section 243 backwardly calculates the backward likelihoods βₜ(sᵢ) of the states sᵢ at the time t, from the final time T to the time 1, using the following formulas (9) and (10).

$$\begin{matrix}{β}_{T} ( {s}_{i} ) = \frac{1}{M} & ( 9 ) \\ {β}_{t} ( {s}_{i} ) = {\sum }_{j = 1}^{M} {a}_{ij} P ( {x}_{t} , {x}_{t + 1} \vert {s}_{i} ) {β}_{t + 1} ( {s}_{j} ) & ( 10 )\end{matrix}$$

In the formula (9), it is assumed that probabilities of the respective states sᵢ at the time T are all the same.

In this way, through the processes of steps S51 to S53, various likelihoods of the hidden Markov's model for the movement history data are calculated.

In step S54, the new model learning section 243 updates the initial probability and the state transition probability. That is, the new model learning section 243 updates the initial probability πₛᵢ in each state sᵢ and the state transition probability aᵢⱼ between the states into an initial probability πₛᵢ′ and a state transition probability aᵢⱼ′ which are calculated by the following formulas (11) and (12), respectively.

$$\begin{matrix}{π}_{si}^{′} = \frac{{α}_{1} ( {s}_{i} ) {β}_{1} ( {s}_{i} )}{{\sum }_{i = 1}^{M} {α}_{t} ( {s}_{i} )} & ( 11 ) \\ {a}_{ij}^{′} = \frac{{\sum }_{t = 1}^{T - 1} {α}_{t} ( {s}_{i} ) {a}_{ij} P ( {x}_{t} , {x}_{t + 1} \vert {s}_{i} ) {β}_{t + 1} ( {s}_{j} )}{{\sum }_{t = 1}^{T - 1} {α}_{t} ( {s}_{i} ) {β}_{t} ( {s}_{i} )} & ( 12 )\end{matrix}$$

The formulas (11) and (12) are obtained by applying the observation likelihood P(xₜ, xₜ₊₁|sᵢ) to formulas which are generally used in the Baum-Welch's maximum likelihood estimation method.

In step S55, the new model learning section 243 updates the observation probability. That is, the new model learning section 243 updates a center value μₛᵢ(d) and a variance value σₛᵢ(d)² of the observation probability (probability distribution) in each state sᵢ into a center value μₛᵢ(d)′ and a variance value σₛᵢ(d)′² which are calculated by the following formulas (13) and (14), respectively.

$$\begin{matrix}{{μ}_{si} ( d )}^{′} = \frac{1}{{\sum }_{t = 1}^{T - 1} {α}_{t} ( {s}_{i} ) {β}_{t} ( {s}_{i} )} \cdot {\sum }_{t = 1}^{T - 1} {α}_{t} ( {s}_{i} ) {β}_{t} ( {s}_{i} ) ( \frac{{x}_{t} ( d ) + {x}_{t + 1} ( d )}{2} ) \\ d = 1 , 2 , 3 & ( 13 ) \\ {{σ}_{si} ( d )}^{′2} = \frac{1}{{\sum }_{t = 1}^{T - 1} {α}_{t} ( {s}_{i} ) {β}_{t} ( {s}_{i} )} \cdot {\sum }_{t = 1}^{T - 1} {α}_{t} ( {s}_{i} ) {β}_{t} ( {s}_{i} ) ( \frac{{{x}_{t} ( d )}^{2} + {{x}_{t + 1} ( d )}^{2}}{2} ) - {{μ}_{si} ( d )}^{′2} \\ d = 1 , 2 , 3 & ( 14 )\end{matrix}$$

Here, “d” in the formulas (13) and (14) corresponds to the dimension D of data, which becomes any one of 1, 2 and 3.

The center value μₛᵢ(d)′ and the variance value σₛᵢ(d)′² of the observation probability in a case where the dimension number is D in a model in which one state node expresses W or more continuous samples can be calculated by the following formulas (15) and (16).

$$\begin{matrix}{{μ}_{si} ( d )}^{′} = \frac{1}{{\sum }_{t = 1}^{T - W + 1} {α}_{t} ( {s}_{i} ) {β}_{t} ( {s}_{i} )} \cdot {\sum }_{t = 1}^{T - W + 1} {α}_{t} ( {s}_{i} ) {β}_{t} ( {s}_{i} ) ( {\sum }_{w = 1}^{W} \frac{{x}_{t + w - 1} ( d )}{W} ) \\ d = 1 , 2 , 3 … D & ( 15 ) \\ {{σ}_{si} ( d )}^{′2} = \frac{1}{{\sum }_{t = 1}^{T - W + 1} {α}_{t} ( {s}_{i} ) {β}_{t} ( {s}_{i} )} \cdot {\sum }_{t = 1}^{T - 1} {α}_{t} ( {s}_{i} ) {β}_{t} ( {s}_{i} ) ( {\sum }_{w = 1}^{W} \frac{{{x}_{t + w - 1} ( d )}^{2}}{W} ) - {{μ}_{si} ( d )}^{′2} \\ d = 1 , 2 , 3 … D & ( 16 )\end{matrix}$$

The center value μₛᵢ(d)′ in the formulas (13) and (15) and the variance value σₛᵢ(d)′² in the formulas (14) and (16) can be easily calculated by solving a formula which minimizes the likelihood.

In step S56, the new model learning section 243 determines whether to terminate the parameter updating. For example, in a case where an increment in each likelihood becomes a predetermined value or lower and a convergence condition of the parameter updating is satisfied, the new model learning section 243 determines that the parameter updating is terminated. Alternatively, in a case where the processes in step S51 to S55 are repeatedly performed by a predetermined time, the new model learning section 243 may determine that the parameter updating is terminated.

In step S56, in a case where it is determined that the parameter updating is not terminated, the process returns to step S51.

In step S51, the new model learning section 243 calculates the likelihood in each state on the basis of the updated parameters. That is, the likelihood in each state is calculated on the basis of data indicating the initial probability πₛᵢ′, the center value μₛᵢ(d)′ and the variance σₛᵢ(d)′² in each state sᵢ and the state transition probability aᵢⱼ′ between the states, which are updated in the processes in steps S54 and S55.

Then, the processes in steps S52 to S55 are similarly performed. Thus, the HMM parameter updating is performed so that the various likelihoods of the state sᵢ series, that is, the observation likelihood P(xₜ, xₜ₊₁|sᵢ), the forward likelihood αₜ(sᵢ), the backward likelihood βₜ(sᵢ) are sequentially increased to be maximum in the end. Further, in step S56, it is determined whether the parameter updating is terminated again.

In a case where it is determined in step S56 that the parameter updating is terminated, the process goes to step S57.

In step S57, the new model learning section 243 outputs the final parameters to the node series determining section 244. That is, the new model learning section 243 outputs the data indicating the initial probability πₛᵢ′, the center value μₛᵢ(d)′ and the variance σₛᵢ(d)′² in each state sᵢ and the state transition probability aᵢⱼ′ between the states, which are finally obtained to the node series determining section 244, and then terminates the process.

### [Parameter Re-Calculation Process of the Parameter Re-Calculating Section 245]

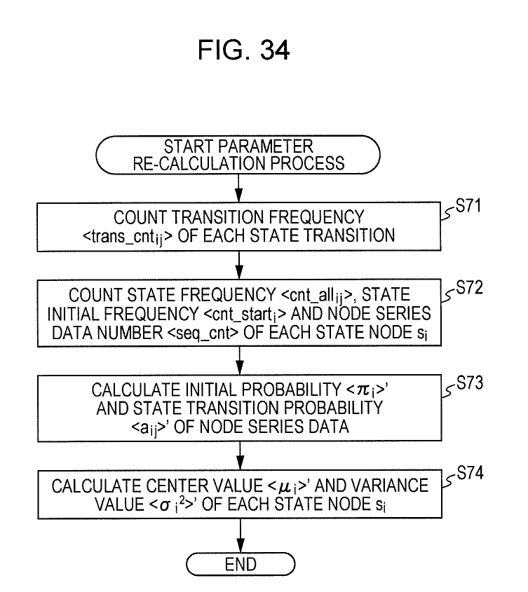

Next, a parameter re-calculation process of the parameter re-calculating section 245 will be described with reference to a flowchart in FIG. 34.

Firstly, in step S71, the parameter re-calculating section 245 counts the transition frequency _cntᵢⱼ> (i=1 to N, j=1 to N, N is a final node number of the time series data (=the number of nodes)) in respective state transitions, using all the node series data supplied from the node series determining section 244 as a target.

In step S72, the parameter re-calculating section 245 counts the state frequency <CNT_ALLᵢ>, the state initial frequency <CNT_STARTᵢ>, and the node series data number in each state node sᵢ, using all the node series data supplied from the node series determining section 244 as a target.

In step S73, the parameter re-calculating section 245 calculates (updates) the initial probability <πᵢ>′ and the state transition probability <Aᵢⱼ>′ of the node series data. The initial probability <πᵢ>′ and the state transition probability <Aᵢⱼ>′ of the node series data can be calculated by the following formulas (17) and (18).

$$\begin{matrix}{〈 {π}_{i} 〉}^{′} = \frac{〈 {cnt\_ start}_{i} 〉}{〈 seq\_cnt 〉} & ( 17 ) \\ {〈 {a}_{ij} 〉}^{′} = \frac{〈 {trans\_ cnt}_{ij} 〉}{〈 {cnt\_ all}_{i} 〉} & ( 18 )\end{matrix}$$

In step S74, the parameter re-calculating section 245 calculates (updates) the observation probability of the node series data, that is, the center value <μⱼ>′ and the variance value <σⱼ²>′ in each state node sᵢ. The center value <μⱼ>′ and the variance value <σⱼ²>′ in each state node sᵢ can be calculated by the following formulas (19) and (20).

$$\begin{matrix}{〈 {μ}_{si} 〉}^{′} = \frac{1}{〈 cnt\_ {all}_{i} 〉} {\sum }_{k = 1}^{〈 cnt\_ {all}_{i} 〉} ( \frac{{x}_{t\_k} + {x}_{t\_k + 1}}{2} ) & ( 19 ) \\ {〈 {σ}_{si}^{2} 〉}^{′} = \frac{1}{〈 cnt\_ {all}_{i} 〉} {\sum }_{k = 1}^{〈 cnt\_ {all}_{i} 〉} ( \frac{{( {x}_{t\_k} )}^{2} + {( {x}_{t\_k + 1} )}^{2}}{2} ) - {〈 {μ}_{si} 〉}^{′2} & ( 20 )\end{matrix}$$

In the formulas (19) and (20), xₜ_{_{—}}ₖ represents three dimensional data corresponding to the state node sᵢ, among the three dimensional data xₜ on the movement history data. Accordingly, the number of xₜ_{_{—}}ₖ becomes equal to the state frequency <CNT_ALLᵢ> in the state node sᵢ.

The center value <μⱼ>′ and the variance value <σⱼ²>′ in each state node sᵢ can be calculated by the following formulas (21) and (22), in the model in which one state node expresses W or more continuous samples.

$$\begin{matrix}{〈 {μ}_{si} 〉}^{′} = \frac{1}{〈 cnt\_ {all}_{i} 〉} {\sum }_{k = 1}^{〈 cnt\_ {all}_{i} 〉} ( \frac{{\sum }_{w = 1}^{W} {x}_{t\_k + w - 1}}{W} ) & ( 21 ) \\ {〈 {σ}_{si}^{2} 〉}^{′} = \frac{1}{〈 cnt\_ {all}_{i} 〉} {\sum }_{k = 1}^{〈 cnt\_ {all}_{i} 〉} ( \frac{{\sum }_{w = 1}^{W} {( {x}_{t\_k + w - 1} )}^{2}}{W} ) - {〈 {μ}_{si} 〉}^{′2} & ( 22 )\end{matrix}$$

In this way, the parameter re-calculation process through the parameter re-calculating section 245 is terminated.

Here, the graphic model in FIGS. 32A and 32B is used, but this is reflected in the new model learning section 243 in FIG. 29 (formulas (5), (6) and (13) to (16)) and the parameter re-calculating section 245 (formulas (19) to (22)). Accordingly, for example, if there is a request for simplifying the process, an embodiment may be employed in which the graphic model in FIGS. 32A and 32B is reflected in only the parameter re-calculating section 245 in FIG. 29. In this case, the learning through the normal Baum-Welch's algorithm may be employed to the new model learning section 243 in FIG. 29. Further, for further simplification, instead of the normal Baum-Welch's algorithm, a process may be changed in which numbers are sequentially allocated to the obtained movement history data from the front to use the numbers as numbers of the state nodes. In this case, if the movement attribute of the three dimensional data on the current movement history is not the stationary state in view of the movement attribute given in the movement attribute recognizing and assigning section 74 in FIG. 7, a number in which the number allocated to the previous three dimensional data is increased by 1 is allocated as the number of the state node. On the other hand, if the movement attribute of the three dimensional data on the current movement history is the stationary state, the same number as the number allocated to the previous three dimensional data is allocated as the number of the state node.

### [New Model Generating Process of the New Model Generating Section 202]

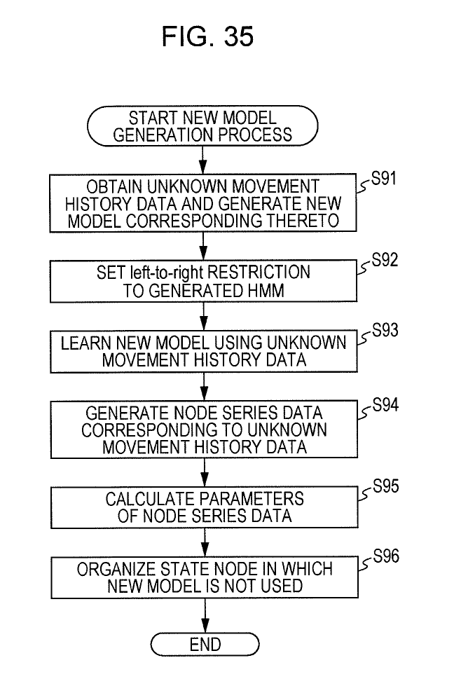

FIG. 35 is a flowchart illustrating an overall new model generating process performed by the new model generating section 202.

Firstly, in step S91, the new model initializing section 241 obtains the unknown movement history data supplied from the known or unknown determining section 201, and generates a new model corresponding to the obtained data. That is, the new model initializing section 241 generates the HMM having the same state node number as the sample number of the obtained unknown movement history data.

In step S92, the new model restricting section 242 sets the left-to-right restriction to the HMM generated in the new model initializing section 241.

In step S93, the new model learning section 243 learns the new model using the unknown movement history data. That is, in step S93, as shown in FIG. 31, the new model is a model in which one state node necessarily reflects two continuous samples, in which the new model learning process described with reference to FIG. 33 is performed.

In step S94, the node series determining section 244 generates node series data corresponding to the unknown movement history data using the new model obtained by the new model learning process in step S93, and supplies it to the parameter re-calculating section 245.

In step S95, the parameter re-calculating section 245 calculates the node series data parameters corresponding to the HMM parameters of the movement history data, on the basis of the node series data supplied from the node series determining section 244. More specifically, the parameter re-calculating section 245 calculates the initial probability <πᵢ>′ and the state transition probability <Aᵢⱼ>′ in the node series data, and the center value <μⱼ>¹ and the variance value <σⱼ²>′ in each state node sᵢ. Further, the parameter re-calculating section 245 calculates the state frequency <CNT_ALLᵢ> and the state initial frequency <CNT_STARTᵢ> in each state node sᵢ.

In step S96, the new model organizing section 246 deletes an unused state node from each state node sᵢ of the HMM which is the generated new model, to thereby organize the new model. Further, the new model organizing section 246 outputs the parameters of the new model after organization and the previous and next state nodes of the existing model of the unknown movement history data supplied from the known or unknown determining section 201 to the new model combining section 203, and then terminates the process.

### [Topology Updated Model Generating Process of the New Model Combining Section 203]

Next, a topology updated model generating process of the new model combining section 203 in which a topology model is generated by combining the existing model obtained by the previous learning and the new model generated by the unknown movement history data will be described.

Firstly, the following variables are defined on the premise of description.

Existing model: xhmm

New model: yhmm

Topology updated model: zhmm

The existing model xhmm, the new model yhmm and the topology updated model zhmm respectively have the following variables. Here, hmm is a common notation in the learning model (HMM), which may be read as xhmm in the existing model, yhmm in the new model, and zhmm in the topology updated model.
The number of state nodes: hmm.node
The number of state nodes of the existing model xhmm xhmm.node=M
The number of state nodes of the new model yhmm yhmm.node=N
The number of state nodes of the topology updated model zhmm
zhmm.node=M+N

The dimension number D of the time series data on the learning target: hmm.D

The initial probability in each state node πᵢ: hmm.pi(i)

The initial probabilities hmm.pi of all hmms form a table (initial probability table) of hmm.node rows and one column.

Transition probability aᵢⱼ in each state node: hmm.a(i,j)

The transition probabilities hmm.a of all hmms form a table (transition probability table) of hmm.node rows and hmm.node columns.

Center value μᵢ of probability distribution in each state node: hmm.mu(i)

The center values hmm.mu of probability distribution of all hmms form a table (center value table) of hmm.node rows and hmm.D columns.

Variance value σᵢ² of probability distribution in each state node: hmm.sigma2(i)

The variance values hmm.sigma2 of probability distribution of all hmms form a table (variance value table) of hmm.node rows and hmm.D columns.

The number of learned time series data seq_cnt: hmm.seq_cnt

State frequency in each state node cnt_allᵢ: hmm.cnt_all(i)

The state frequencies of all hmms hmm.cnt_all form a table (state frequency table) of hmm.node rows and one column.

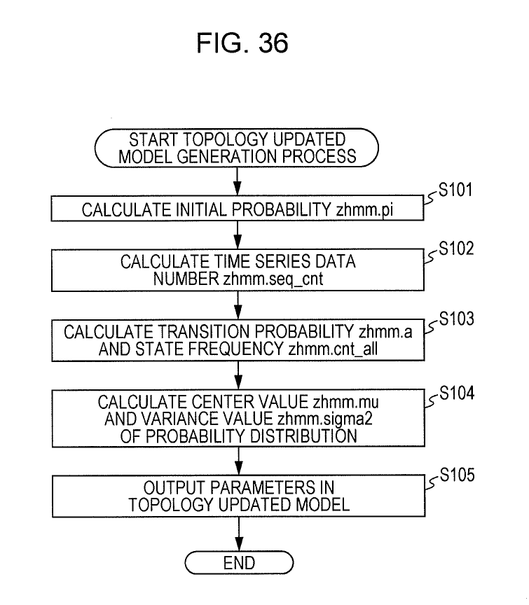

The topology updated model generating process through the new model combining section 203 will be described with reference to a flowchart in FIG. 36.

Firstly, in step S101, the new model combining section 203 calculates an initial probability zhmm.pi of the topology updated model.

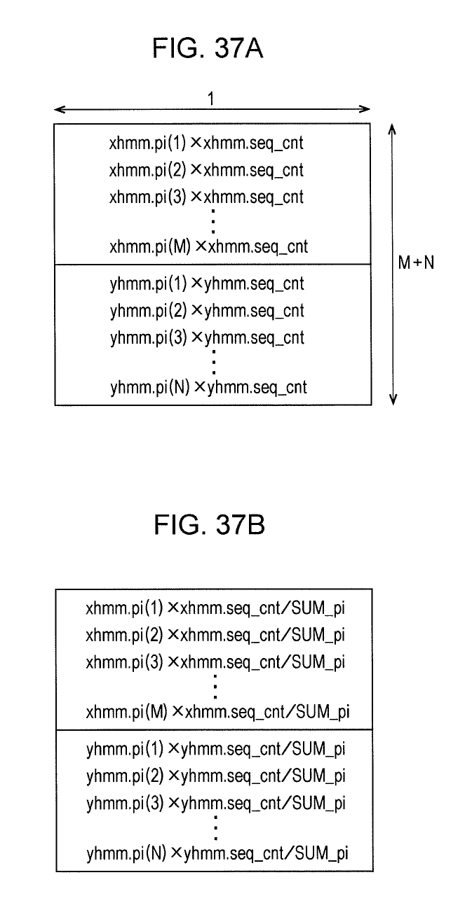

In step S101, firstly, the new model combining section 203 generates an initial probability table of (M+N) rows and one column as the initial probability zhmm.pi, as shown in FIG. 37A, since the existing model includes M state nodes and the new model includes N state nodes.

Further, as shown in FIG. 37A, the new model combining section 203 sets a value obtained by multiplying the time series data number xhmm.seq_cnt of the existing model by the initial probability xhmm.pi(m) of the existing model, to an m-th row of the first row to the M-th row (m=1, 2, . . . M) in the initial probability table of the topology updated model. Further, the new model combining section 203 sets a value obtained by multiplying the time series data number yhmm.seq_cnt of the new model by the initial probability yhmm.pi(n) of the new model, to an (M+n)-th row of the (M+1)-th row to the (M+N)-th row (n=1, 2, . . . N) in the initial probability table of the topology updated model.

Further, as shown in FIG. 37B, each row in the initial probability table of the topology updated model is divided by the sum SUM_pi of all elements of the initial probability table for normalization, and then the generation of the initial probability table zhmm.pi of the topology updated model is terminated.

Next, in step S102, the new model combining section 203 calculates the time series data number zhmm.seq_cnt of the topology updated model. Specifically, the new model combining section 203 calculates the sum of the time series data number xhmm.seq_cnt of the existing model and the time series data number yhmm.seq_cnt of the new model, to obtain the time series data number zhmm.seq_cnt of the topology updated model.

In step S103, the new model combining section 203 calculates the transition probability zhmm.a and the state frequency zhmm.cnt_all of the topology updated model.

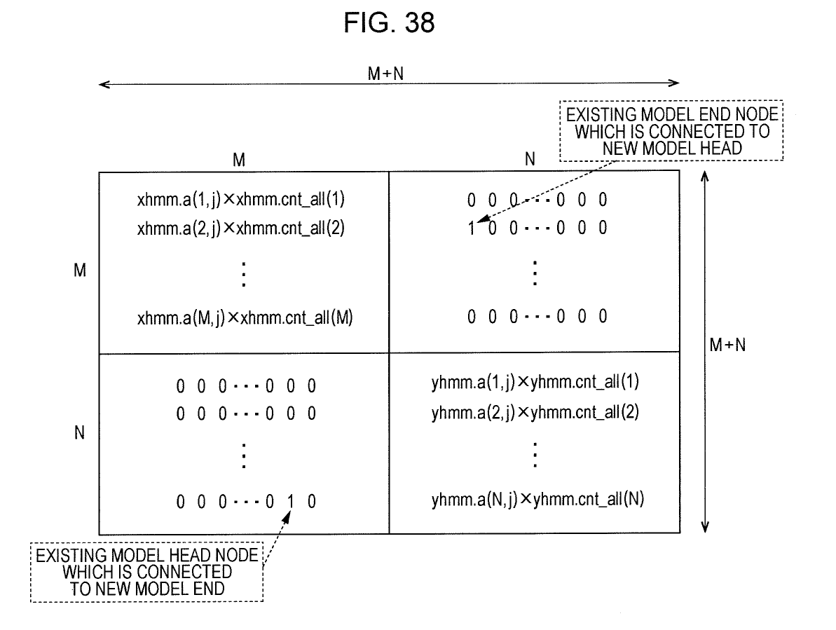

In step S103, firstly, the new model combining section 203 generates a transition probability table of (M+N) rows and (M+N) columns, as shown in FIG. 38, since the existing model includes M state nodes and the new model includes N state nodes. In the transition probability table, the M-th row and N-th column from the first row and first column is referred to as an upper left region, the (M+N)-th row and (M+N)-th column from (M+1)-th row and (M+1)-th column is referred to as a lower right region, the M-th row and (M+N)-th column from the first row and (M+1)-th column is referred to as an upper right region, and the (M+N)-th row and M-th column from the (M+1)-th row and the first column is referred to as a lower left region.

Further, the new model combining section 203 sets a value obtained by multiplying the state frequency xhmm.cnt_all(m) in the state node sₘ of the existing model by the transition probability xhmm.a(m,j) in the state node sₘ of the existing model, to each element in the upper left region of the generated transition probability table (j=1, . . . , M).

Further, the new model combining section 203 sets a value obtained by multiplying the state frequency yhmm.cnt_all(m) in the state node sₘ of the new model by the transition probability yhmm.a(m,j) in the state node sₘ of the new model, to each element in the lower right region of the generated transition probability table (j=1, . . . M).

In FIG. 38, xhmm.a(m,j)×xhmm.cnt_all(m) and yhmm.a(m,j)×yhmm.cnt_all(m) are shown in the same row due to space limitation.

Further, the new model combining section 203 basically assigns “0” to each element on the upper right region in the generated transition probability table. Here, in a case where the previous state node of the existing model of the unknown movement history data is supplied from the new model generating section 202 and the new model is connected to follow the node series data of the existing model, “1” is assigned to only the element corresponding to the state node of the connection target. Specifically, in a case where the state node of the connection target is sᵢ, “1” is set to an element of the i-th row and (M+1)-th column.

Similarly, the new model combining section 203 basically assigns “0” to each element on the lower left region in the generated transition probability table. Here, in a case where the next state node of the existing model of the unknown movement history data is supplied from the new model generating section 202 and the node series data of the existing mode is connected to follow the new model, “1” is assigned to only the element corresponding to the state node of the connection target. Specifically, in a case where the state node of the connection target is sⱼ, “1” is set to an element of the (M+N)-th row and j-th column.

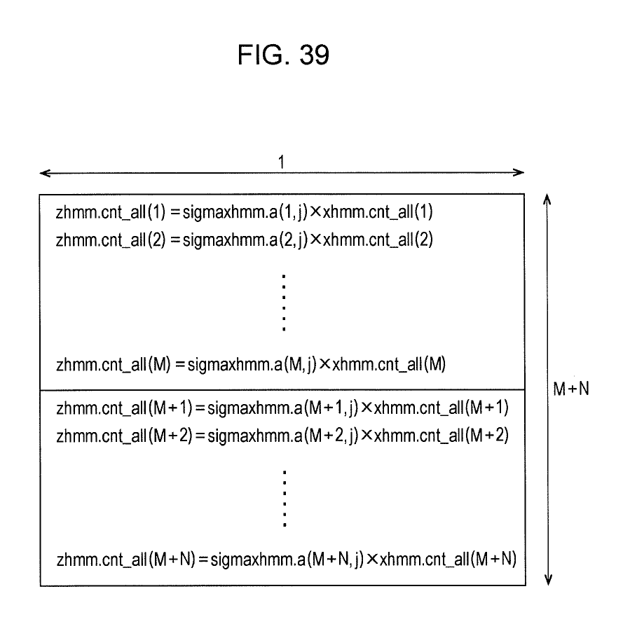

Next, as shown in FIG. 39, the new model combining section 203 calculates the sum in the row direction with respect to the upper left region and the lower right region in the generated transition probability table, to thereby calculate the state frequency zhmm.cnt_all of the topology updated model. The state frequency table in FIG. 39 includes a table of (M+N)-th rows and one column.

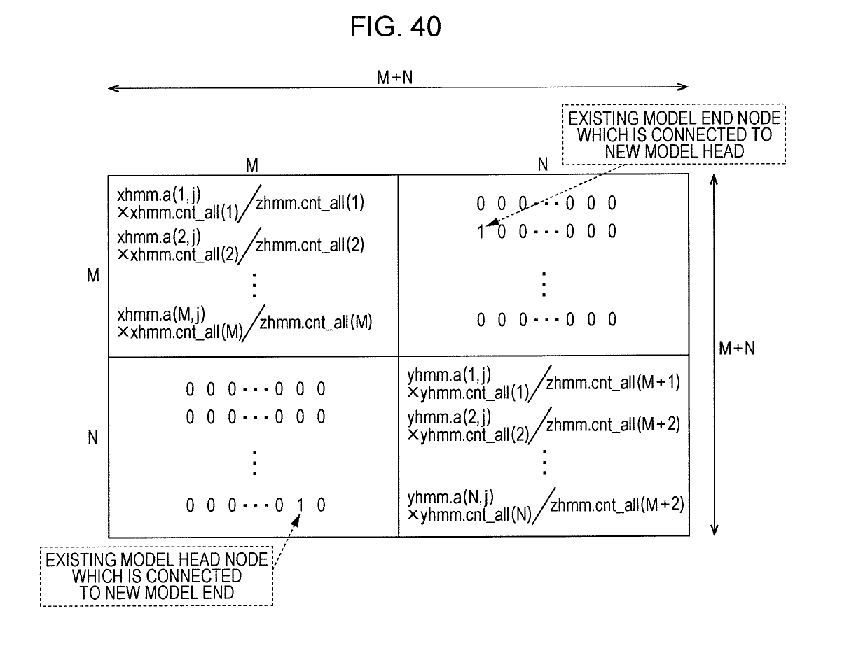

Finally, as shown in FIG. 40, the new model combining section 203 divides each row in the upper left region and the lower right region in the transition probability table in FIG. 38 by the respective rows zhmm.cnt_all(i) in the state frequency table of the topology updated model, for normalization. In this way, the generation of the transition probability table of the topology updated model is terminated.

Further, the process goes to step S104, and the new model combining section 203 calculates the center value zhmm.mu and the variance value zhmm.sigma2 of the probability distribution of the topology updated model.

In step S104, the center value table corresponding to the center value zhmm.mu of the topology updated model includes (M+N)-th rows and D-th columns, since the existing model includes M state nodes and the new model includes N state nodes.

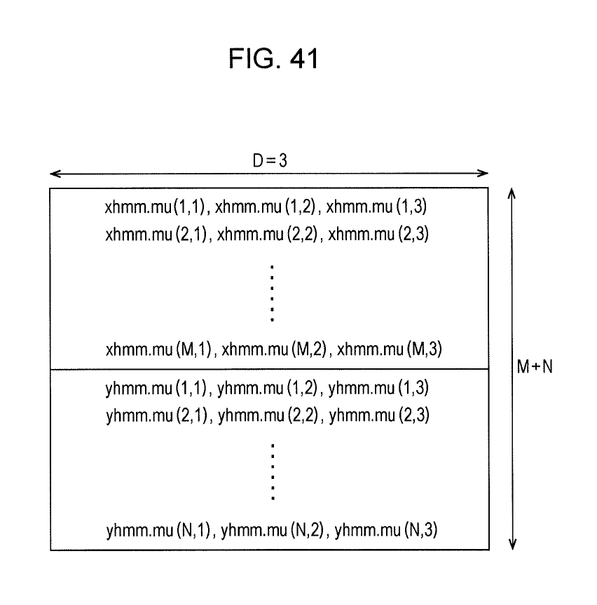

As shown in FIG. 41, center values xhmm.mu(i,1), xhmm.mu(i,2) and xhmm.mu(i,3) of the existing model are assigned to the respective rows from the first row to the M-th row in the center value table of (M+N) rows and D columns (here, i=1, . . . M). Further, center values yhmm.mu(i,1), yhmm.mu(i,2) and yhmm.mu(i,3) of the new model are assigned to the respective rows from the (M+1)-th row to the (M+N)-th row in the center value table of (M+N) rows and D columns (here, i=1, . . . N). Here, xhmm.mu(i,1) and yhmm.mu(i,1) are center values of the times in the movement history data, xhmm.mu(i,2) and yhmm.mu(i,2) are center values of the latitudes in the movement history data, and xhmm.mu(i,3) and yhmm.mu(i,3) are center values of the longitudes in the movement history data.

Similarly, a variance value table corresponding to the variance value zhmm.sigma2 of the probability distribution of the topology updated model includes (M+N) rows and D columns.

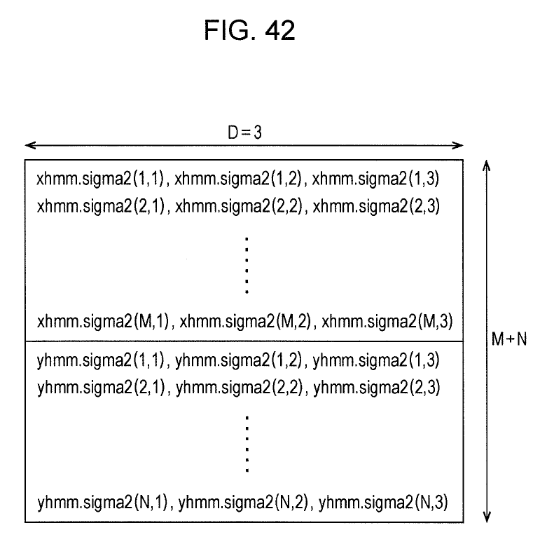

As shown in FIG. 42, variance values xhmm.sigma2(i,1), xhmm.sigma2(i,2) and xhmm.sigma2(i,3) of the existing model are assigned to the respective rows from the first row to the M-th row in the variance value table of (M+N) rows and D columns (here, i=1, . . . M). Further, variance values yhmm.sigma2(i,1), yhmm.sigma2(i,2) and yhmm.sigma2(i,3) of the new model are assigned to the respective rows from the (M+1)-th row to the (M+N)-th row in the variance value table of (M+N) rows and D columns (here, i=1, . . . , N). Here, xhmm.sigma2(i,1) and yhmm.sigma2(i,1) are variance values of the times in the movement history data, xhmm.sigma2(i,2) and yhmm.sigma2(i,2) are variance values of the latitudes in the movement history data, and xhmm.sigma2(i,3) and yhmm.sigma2(i,3) are variance values of the longitudes in the movement history data.

Further, the process goes to step S105, and the new model combining section 203 outputs the parameters of the topology updated model to the update model organizing section 205. That is, the initial probability zhmm.pi, the time series data number zhmm.seq_cnt, the transition probability zhmm.a, the state frequency zhmm.cnt_all, in the topology updated model, and the center value zhmm.mu and the variance value zhmm.sigma2 of the probability distribution are output to the updated model organizing section 205. In this way, the topology updated model generating process is terminated.

### [Parameter Update Process of the Parameter Updating Section 204]

Next, the parameter update process through the parameter updating section 204 will be described.

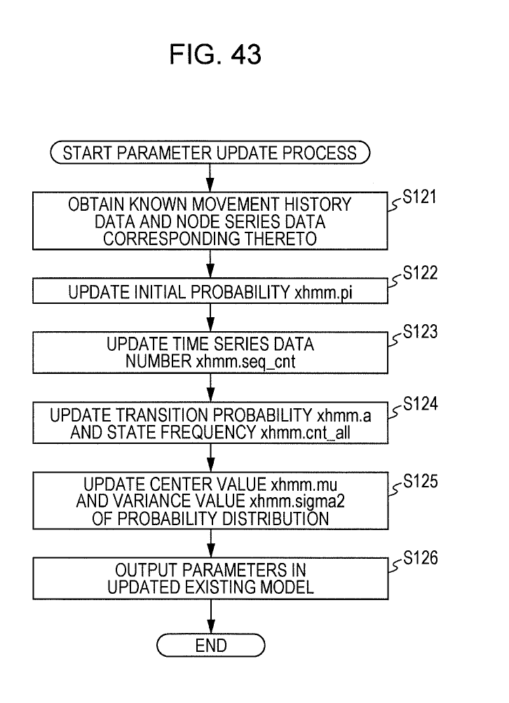

FIG. 43 is a flowchart of the overall parameter update process performed by the parameter updating section 204.

Firstly, in step S121, the parameter updating section 204 obtains the known movement history data and the node series data corresponding to the supplied data, supplied from the known or unknown determining section 201. Hereinafter, for ease of description, it is assumed that one piece of known movement history data and the node series data corresponding thereto are obtained.

In step S122, the parameter updating section 204 updates the initial probability xhmm.pi of the existing model.

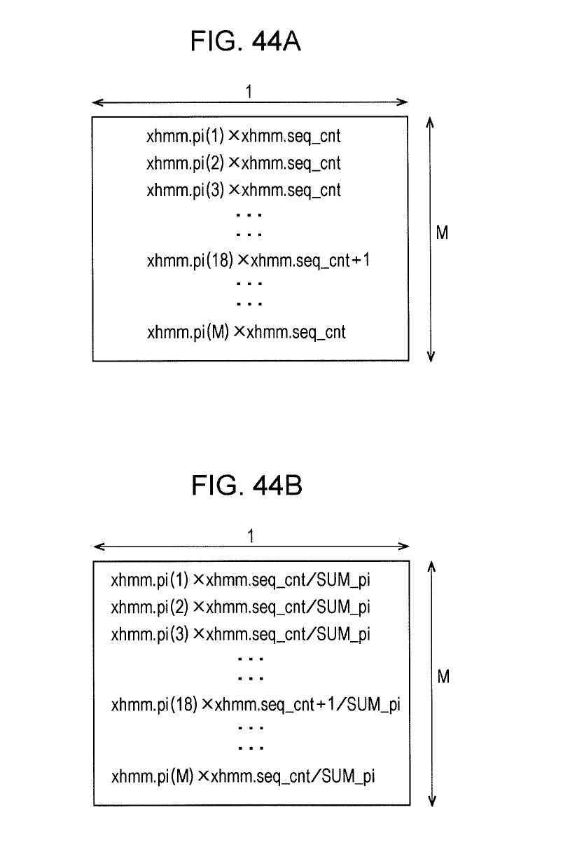

In step S122, firstly, “1” is added to the initial probability xhmm.pi(i) corresponding to the head node of the obtained state node series, in the initial probability table of M rows and one column which is the initial probability xhmm.pi. In FIG. 44A, “1” is added to xhmm.pi(18), as an example in which the head node of the state node series is a state node s₁₈.

Further, as shown in FIG. 44B, since the probability condition is satisfied, each row in the initial probability table is divided by the sum SUM_pi of all elements for normalization, and the updating of the initial probability xhmm.pi of the existing model is terminated.

Then, in step S123, the parameter updating section 204 updates the time series data number xhmm.seq_cnt of the existing model. Since the time series data number is increased by only one, the number obtained by adding “1” to the current number xhmm.seq_cnt is obtained as the time series data number xhmm.seq_cnt of the existing model after updating.

In step S124, the parameter updating section 204 updates the transition probability xhmm.a and the state frequency xhmm.cnt_all of the existing model.

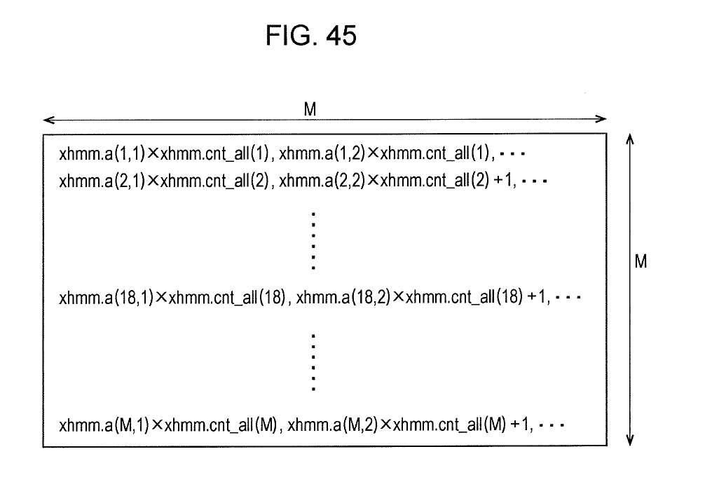

In step S124, firstly, “1” is added to each element in the transition probability table corresponding to the state transitions generated in the obtained state node series. For example, in an example in FIG. 45, a transition to a state node s₂ from a state node s₁₈ and a transition to a state node s₂ from a state node s₁₈ at least occur, and “1” is added to each of xhmm.a(18,2)×xhmm.cnt_all(18) and xhmm.a(M,2)×xhmm.cnt_all(M).

Further, “1” is added to an element in the transition probability table corresponding to the self transition with respect to a state node of the final end part of the obtained state node series. For example, in FIG. 45, “1” is added to xhmm.a(2,2)×xhmm.cnt_all(2), as an example in which the state node of the final end part of the state node series is s₂.

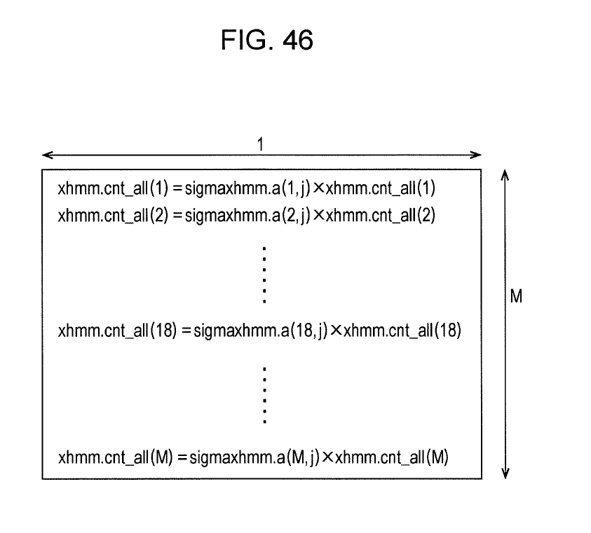

Next, as shown in FIG. 46, the parameter updating section 204 calculates the sum in the row directions for the transition probability table after adding “1” thereto, to calculate (updates) the state frequency xhmm.cnt_all of the existing model.

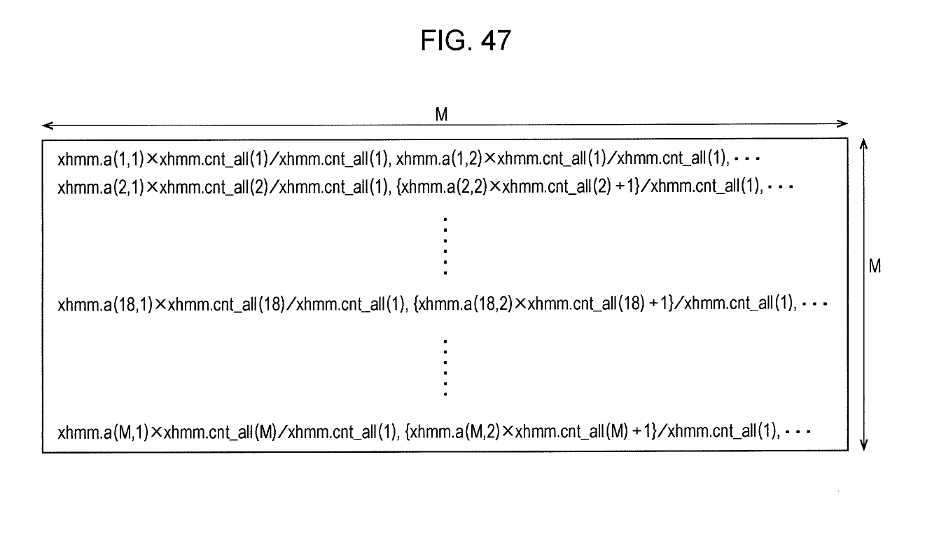

Finally, as shown in FIG. 47, the parameter updating section 204 divides each row in the transition probability table after adding “1” thereto by the state frequency xhmm.cnt_all(i) of the existing model after updating, for normalization. Through the above-described calculation, the transition probability table of the existing model is updated.

Then, the process goes to step S125, and the parameter updating section 204 updates the center value xhmm.mu and the variance value xhmm.sigma2 of the probability distribution of the existing model.

Generally, in a case where M state nodes sᵢ appear in the existing model and its average value is μₛᵢ, the following relationship is established between an average value μₛᵢ^{(M)} before updating when a new sample x_{M+1} which is recognized as the (M+1)-th state node sᵢ is increased and an average value μₛᵢ^{(M+1}) after updating thereof.

$$\begin{matrix}{μ}_{si}^{( M )} = \frac{1}{M} {\sum }_{i = 1}^{M} {x}_{i} & ( 23 ) \\ \begin{matrix}{μ}_{si}^{( M + 1 )} = \frac{1}{M + 1} {\sum }_{i = 1}^{M + 1} {x}_{i} \\ = \frac{1}{M + 1} ( M \times {μ}_{si}^{( M )} + {x}_{M + 1} )\end{matrix} & ( 24 )\end{matrix}$$

In the formulas (23) and (24), superscripts outside the parentheses represent the number of appearances of the state node sᵢ.

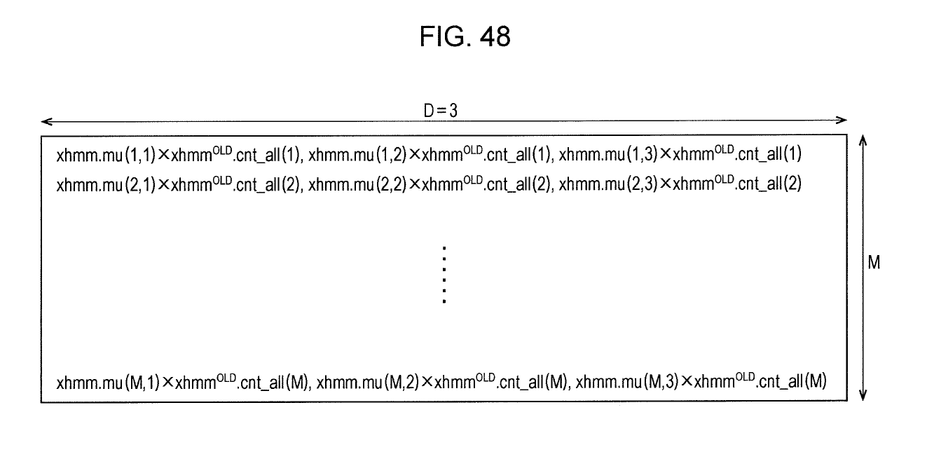

Thus, as shown in FIG. 48, the parameter updating section 204 multiplies an element of each row in the center value table of the M rows and the D columns (here, i=1, . . . , M) by an immediately previous state frequency xhmm^{OLD}.cnt_all(i), before updating the state frequency xhmm.cnt_all(i) in step S124. Accordingly, it is necessary that the immediately previous state frequency xhmm^{OLD}.cnt_all(i) is stored in a predetermined place before the process of step S124 is performed.

Next, the parameter updating section 204 adds the known movement history data (each item of three dimensional data) as a new sample x_{M+1} to a row in the center value table corresponding to the state node corresponding to the new sample x_{M+1}.

Further, the parameter updating section 204 divides the element of each row in the center value table of the M rows and the D columns by the state frequency xhmm.cnt_all(i) updated in step S124. In this way, the updating of the center value xhmm.mu of the probability distribution of the existing model is terminated.

On the other hand, in a case where M state nodes sᵢ appear in the existing model, its average value is μₛᵢ and the variance value is σₛ₁², the following relationship is established between an average value σₛᵢ^{2(M)} before updating when the new sample x_{M+1} which is recognized as the (M+1)-th state node sᵢ is increased and an average value σₛᵢ^{2(M+1)} after updating thereof.

$$\begin{matrix}{σ}_{si}^{2 ( M )} = \frac{1}{M} {\sum }_{i = 1}^{M} {x}_{i}^{2} - {( {μ}_{si}^{( M )} )}^{2} & ( 25 ) \\ \begin{matrix}{σ}_{si}^{2 ( M + 1 )} = \frac{1}{M + 1} {\sum }_{i = 1}^{M + 1} {x}_{i}^{2} - {( {μ}_{si}^{( M + 1 )} )}^{2} \\ = \frac{M \times \{ {σ}_{si}^{2 ( M )} + {( {μ}_{si}^{( M )} )}^{2} \} + {X}_{M + {1}^{2}}}{M + 1} - {( {μ}_{si}^{( M + 1 )} )}^{2}\end{matrix} & ( 26 )\end{matrix}$$

In the formulas (25) and (26), superscripts outside the parentheses represent the number of appearances of the state node sᵢ.

Then, the parameter updating section 204 adds the square of the immediately previous center value xhmm^{OLD}.mu before updating the center value xhmm.mu of the probability distribution of the existing model to the element of each row in the variance value table of the M rows and the D columns (i=1, . . . , M). Accordingly, it is necessary that the immediately previous center value xhmm^{OLD}.mu is also stored in a predetermined place before the above-described updating is performed.

Next, the parameter updating section 204 multiplies an element of each row in the variance value table of the M rows and the D columns after addition of the square of the immediately previous center value xhmm^{OLD}.mu by the immediately previous state frequency xhmm^{OLD}.cnt_all(i).

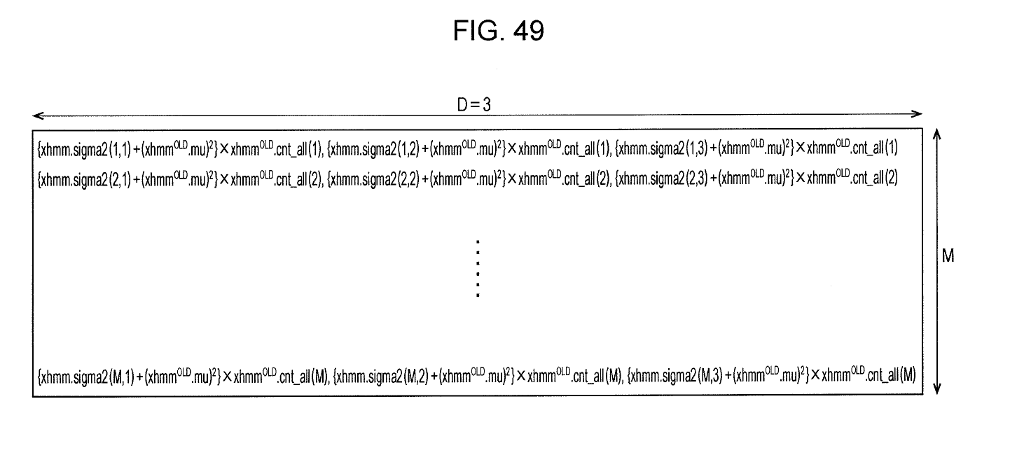

FIG. 49 is a diagram illustrating a variance value table after the multiplication of the state frequency xhmm^{OLD}.cnt_all(i).

Further, the parameter updating section 204 adds the square of the known movement history data (each item of three dimensional data) as the new sample x_{M+1} to the row in the center value table corresponding to the state node corresponding to the new sample x_{M+1}.

Finally, the parameter updating section 204 divides the element of each row in the center value table of the M rows and the D columns by the state frequency xhmm.cnt_all(i) updated in step S124, and subtracts the square of the center value xhmm.mu(i) after updating therefrom. In this way, the updating of the variance value xhmm.sigma2 of the probability distribution of the existing model is terminated.

Then, the process goes to step S126, and the parameter updating section 204 outputs the parameters of the updated existing model to the new model combining section 203 and the update model organizing section 205. That is, the initial probability xhmm.pi, the time series data number xhmm.seq_cnt, the transition probability xhmm.a, the state frequency xhmm.cnt_all, in the updated existing model, and the center value xhmm.mu and the variance value xhmm.sigma2 of the probability distribution are output. In this way, the parameter update process is terminated.

### [Overall Process of the Learning Main Processing Section 23]

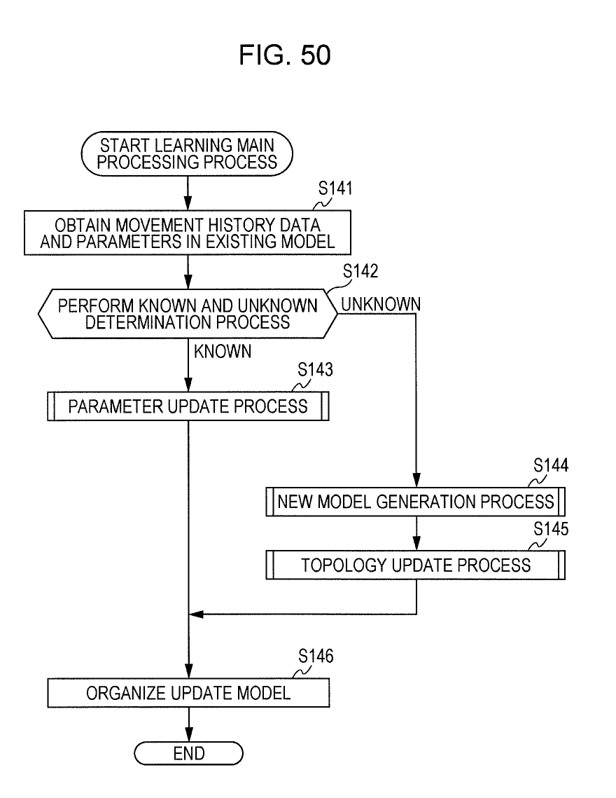

Next, the overall learning main processing process of the learning main processing section 23 will be described with reference to a flowchart in FIG. 50.

Firstly, in step S141, the learning main processing section 23 obtains the movement history data supplied from the learning pre-processing section 22 (FIG. 1) and the parameters of the existing model supplied from the user model parameter storing section 12 (FIG. 1). The movement history data is obtained by the known or unknown determining section 201, and the parameters of the existing model are obtained by the known or unknown determining section 201, the new model combining section 203 and the parameter updating section 204.

In step S142, the known or unknown determining section 201 performs a known or unknown determination process in which it is determined whether the supplied movement history data is movement history data on the known route.

As described with reference to FIGS. 20 to 28, in the known or unknown determination process, the Viterbi estimation is performed in the unknown state addition model in which the unknown state node is added to the state node of the existing model to perform the Viterbi determination through two known or unknown state models, to thereby perform the known or unknown determination.

In the known or unknown determination process, in a case where it is determined that the supplied movement history data is known, the supplied movement history data and the node series data which is the time series data of the corresponding state node are supplied to the parameter updating section 204. On the other hand, in the known or unknown determination process, in a case where it is determined that the supplied movement history data is unknown, the supplied movement history data is supplied to the new model generating section 202. Further, in a case where the unknown movement history data is connected with the known state node (route), the state node of the connection target is also supplied to the new model generating section 202.

In a case where it is determined in step S142 that the supplied movement history data is known, the process goes to step S143, and the parameter updating section 204 performs the parameter update process in which the parameters of the existing model are updated on the basis of the known movement history data and the node series data corresponding thereto. That is, the process described with reference to FIGS. 43 to 49 is performed.

On the other hand, in a case where it is determined in step S142 that the supplied movement history data is unknown, the process goes to step S144, and the new model generating section 202 performs the new model generating process in which the new model corresponding to the unknown movement history data is generated. In other words, the new model generating section 202 obtains parameters of the new model which express the unknown movement history data. The new model generating process is the process described with reference to FIGS. 29 to 35.

In step S145, the new model combining section 203 performs the topology update process of combining the existing model and the new model and of generating a topology updated model in which the unknown movement history data is imported and extended in the existing model after learning. That is, the new model combining section 203 performs the process described with reference to FIGS. 36 to 42.

After the process of step S143 or S145, in step S146, the updated model organizing section 205 deletes a state node in which transition from other state nodes is not present only using self transition, to organize the parameter updated model or the topology updated model. The updated model organizing section 205 supplies the parameters of the updated model after organization to the learning post-processing section 24 and the user model parameter storing section 12, and then terminates the process.

### [Process of the Destination and Stopover Detecting Section 25]

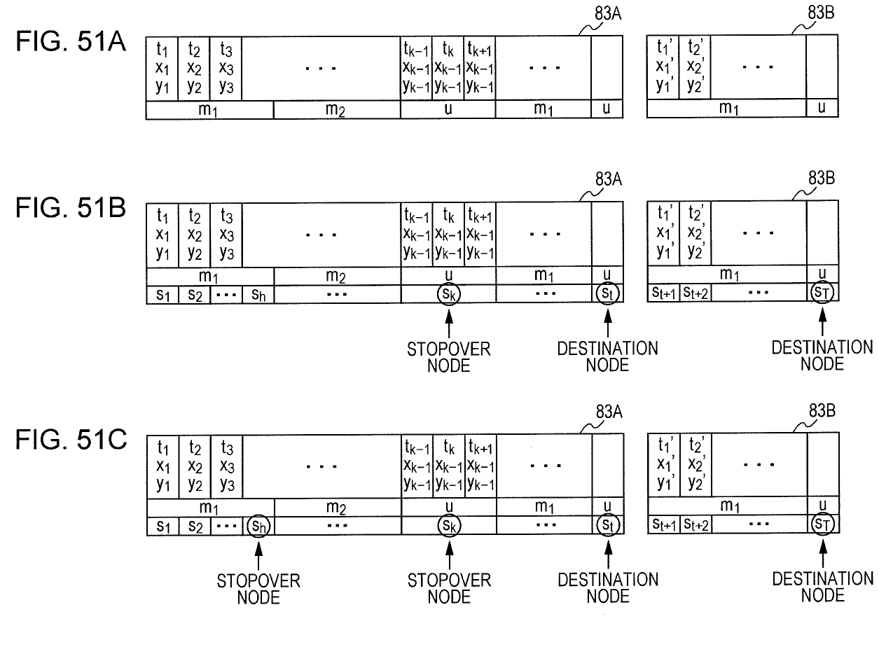

Next, the process of the destination and stopover detecting section 25 (FIG. 1) of the learning block 11 will be described with reference to FIGS. 51A to 51C.

As described above, the learning main processing section 23 learns the parameters of the user activity model, using the movement history data (with movement attribute) after the process of dividing and holding the movement history data is performed as the learning data. Further, the learning post-processing section 24 generates the state series data corresponding to the movement history data using the parameters obtained by learning.

FIG. 51A is a diagram illustrating the movement history data 83A and 83B with the movement attribute after the movement history data is divided and held by the learning pre-processing section 22, which are shown in a lower part of FIG. 8.

FIG. 51B is a diagram illustrating a state where the corresponding state series data is added to the movement history data 83A and 83B with movement attribute shown in the lower part of FIG. 8.

The state series nodes of s₁, s₂, . . . , sₖ, . . . , sₜ correspond to the movement history data 83A with movement attribute. The state series nodes of sₜ₊₁, sₜ₊₂, . . . , s_{T} correspond to the movement history data 83B with movement attribute.

The destination and stopover detecting section 25 detects the state node corresponding to the three dimensional data of the final “stationary state (u)” of one group of the movement history data with movement attribute, and assigns the destination attribute thereto. In the example in FIG. 51B, the destination attribute is assigned to the state node sₜ of the movement history data 83A with movement attribute and the state node s_{T} of the movement history data 83B with movement attribute. The state node sₜ and the state node s_{T} are state nodes in which the stationary state continues for a predetermined stationary threshold time or longer. In this way, the state node corresponding to the movement history data in which the stationary state continues for the stationary threshold time or longer using the destination and stopover detecting section 25 is estimated as the destination.

In the division process described with reference to FIG. 8, the plurality of “movement states” is reduced to one “stationary state” in the divided movement history data for the final stationary threshold time or longer. However, in the division process, all of the plurality of “movement states” in the movement history data for the final stationary threshold time or longer may be deleted. Referring to the example in FIG. 51A, three dimensional data on each final “stationary state (u)” of the movement history data 83A and 83B with movement attribute may be omitted. In this case, the destination and stopover detecting section 25 assigns the destination attribute to the state node corresponding to the final three dimensional data of one group of movement history data with the movement attribute. Referring to the example in FIG. 51B, a state node sₜ₋₁ immediately before the state node sₜ of the movement history data 83A with movement attribute and a state node s_{T-1} immediately before the state node s_{T} of the movement history data 83B with movement attribute may be determined as the destination.

Further, the destination and stopover detecting section 25 detects the state node corresponding to the three dimensional data on the “stationary state (u)” which is in the middle of one group of movement history data with movement attribute, and assigns the stopover attribute thereto. That is, the state node corresponding to the movement history data in which the continuous time of the stationary state is shorter than the stationary threshold time is estimated as the stopover. Referring to the example in FIG. 51B, the state node sₖ of the movement history data 83A with movement attribute is determined as the stopover.

When the transportation means is changed, the destination and stopover detecting section 25 may assign the stopover attribute to the final state node sₕ before change, as shown in FIG. 51C.

### [Process of the Learning Block 11]

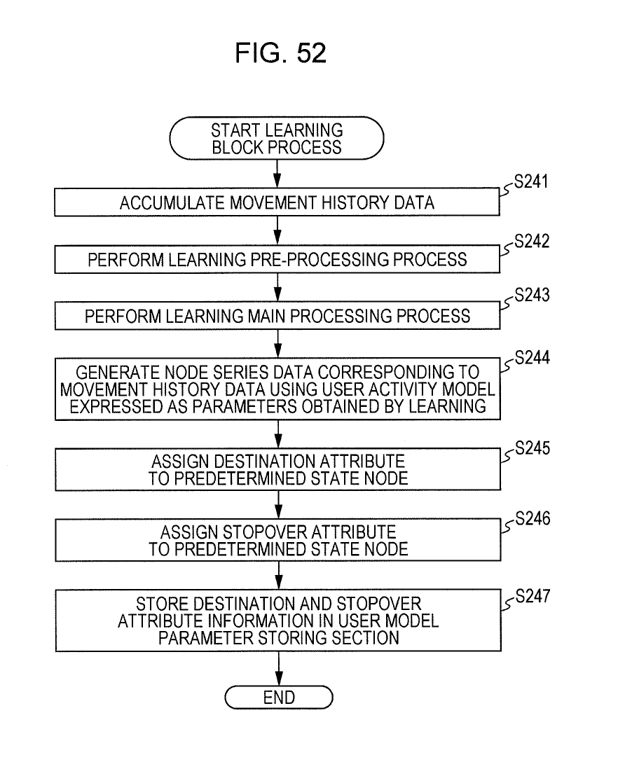

The overall process of the learning block 11 will be described with reference to a flowchart in FIG. 52.

Firstly, in step S241, the history data accumulating section 21 accumulates the movement history data supplied from the sensor device as the learning data.

In step S242, the learning pre-processing section 22 performs the learning pre-processing process described with reference to FIG. 18. That is, the connection and division process of the movement history data which is accumulated in the history data accumulating section 21, and the assignment of the movement attribute of the “stationary state” or the “movement state” to each item of three dimensional data which forms the movement history data are performed, for example.

In step S243, the learning main processing section 23 performs the learning main processing process described with reference to FIG. 50. That is, the learning main processing section 23 determines whether the supplied movement history data of the user is known or unknown, and updates the parameters of the HMM which is the user activity model according to the determination result. In a case where the unknown movement history data is supplied, the parameters of the HMM in which topology is extended according to expansion of the movement range are obtained. The parameters of the user activity model obtained by the learning main processing process are supplied to the learning post-processing section 24 and the user model parameter storing section 12, and are stored in the user model parameter storing section 12.

In step S244, the learning post-learning processing section 24 generates the node series data corresponding to the movement history data using the user activity model which is expressed by the parameters obtained by learning.

In step S245, the destination and stopover detecting section 25 assigns the destination attribute to a predetermined state node of the state series node corresponding to the movement history data with movement attribute. More specifically, the destination and stopover detection section 25 assigns the destination attribute to the state node corresponding to the movement history data in which the stationary state continues for the stationary threshold time or longer.

In step S246, the destination and stopover detection section 25 assigns the stopover attribute to the predetermined state node of the state series node corresponding to the movement history data with movement attribute. More specifically, the destination and stopover detection section 25 assigns the stopover attribute to the state node corresponding to the movement history data in which the continuous time of the stationary state is shorter than the stationary threshold time.

In step S247, the destination and stopover detection section 25 stores information about the destination attribute and the stopover attribute assigned to the state node in the user model parameter storing section 12 and then terminates the process.

### [Process of the Prediction Main Processing Section 33]

Next, a process performed by the prediction block 13 will be described.

Firstly, a tree search process for a current location node and thereafter through the prediction main processing section 33 will be described.

The tree search process for the current location node and thereafter is a process in which a reachable destination node from the current location node estimated by the current location node estimating section 41 of the prediction main processing section 33 and routes thereto are obtained. The reachable destination node is present in a tree structure formed by nodes which can be transited from the current location node. Accordingly, it is possible to predict the destination by searching for the destination node from the state nodes which form the tree. Further, in the tree search process for the current location node and thereafter, in a case where the state node (hereinafter, referred to as “stopover node”) to which the stopover attribute is assigned is detected, the route to the stopover is stored.

It may be considered that each state sᵢ of the HMM obtained by learning represents a predetermined point (location) on the map, and may represent a route from the state sᵢ to the state sⱼ when the state sᵢ and the state sⱼ are connected to each other.

In this case, each point corresponding to the state sᵢ can be classified into any one of an end point, a pass point, a branch point and a loop. The end point is a point in which a probability other than the self transition is very small (probability other than the self transition is equal to a predetermined value or lower), in which a further movable point does not exist. The pass point is a point in which there exists one significant transition other than the self transition, in other words, there exists one further movable point. The branch point is a point in which there exist two or more significant transitions other than the self transition, that is, there exist two or more further movable points. The loop is a point which coincides with any one on the routes which has been passed up to now.

In a case where the route for the destination is searched for, if there are different routes, it is preferable to present information regarding a necessary time or the like for the respective routes. Thus, in order to search for available routes moderately, the next conditions are set.

(1) Even though a route is branched once and joined again, it is considered as a different route.

(2) In a case where a route being searched for reaches the branch point, an unsearched list is created to search for a branch target in the unsearched list.

(3) In a case where the end point or the loop in the route appears, the search of the route is terminated. In a case where the route goes back to an immediately previous point from the current point, it is included in the loop.

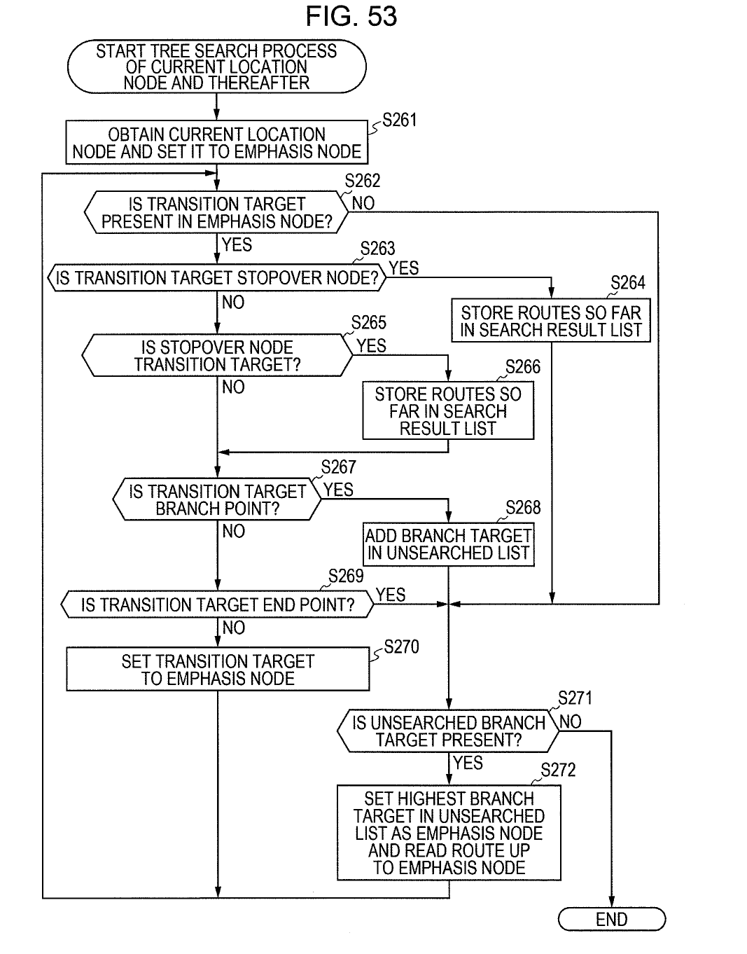

FIG. 53 is a flowchart illustrating the tree search process for the current location node and thereafter, through the destination and stopover predicting section 42 of the prediction main processing section 33.

In the process in FIG. 53, firstly, in step S261, the destination and stopover predicting section 42 obtains the current location node estimated by the current location node estimating section 41 of the prediction main processing section 33, and sets it to an emphasis node which is to be focused.

In step S262, the destination and stopover predicting section 42 determines whether a transition target is present in the emphasis node. If it is determined in step S262 that the transition target is not present in the emphasis node, the process goes to step S271 to be described later.

On the other hand, if it is determined in step S262 that the transition target is present in the emphasis node, the process goes to step S263, and then, the destination and stopover predicting section 42 determines whether the transition target is the destination node.

If it is determined in step S263 that the transition target is the destination node, the process goes to step S264, and then, the destination and stopover predicting section 42 stores the route so far (state node series) in a search result list in an inner memory. After step S264, the process goes to step S271.

On the other hand, if it is determined in step S263 that the transition target is not the destination node, the process goes to step S265, and then, the destination and stopover predicting section 42 determines whether the transition target is the stopover node.

If it is determined in step S265 that the transition target is the stopover node, the process goes to step S266, and then, the destination and stopover predicting section 42 stores the route so far (state node series) in the search result list of the inner memory.

In order to output a representative route, an arrival probability and a time to reach the destination as a prediction result, only a route when the transition target is the destination may be stored in the search result list. However, if a route when the transition target is the stopover is also stored, it is possible to directly obtain a route, a probability, and a time to the stopover as necessary.

In a case where it is determined in step S265 that the transition target is not the stopover node, or after step S266, the process goes to step S267, and then, the destination and stopover predicting section 42 determines whether the transition target is the branch point.

If it is determined in step S267 that the transition target is the branch point, the process goes to step S268, and then, the destination and stopover predicting section 42 stores (adds) two state nodes of the branch target in the unsearched list of the inner memory. After step S268, the process goes to step S271. Here, since the branch target forms the loop in a case where the branch target is any state node on the route being searched for, the destination and stopover predicting section 42 stores the state node of the branch target in the unsearched list.

If it is determined in step S267 that the transition target is not the branch point, the process goes to step S269, and then, the destination and stopover predicting section 42 determines whether the transition target is the end point. If it is determined in step S269 that the transition target is the end point, the process goes to step S271.

On the other hand, if it is determined in step S269 that the transition target is not the end point, the process goes to step S270, and then, the destination and stopover predicting section 42 sets the state node of the transition target to the emphasis node and returns the process to step S262. That is, in a case where the transition target is not any one of the destination node, the stopover node, the branch point and the end point, the state node of the search target proceeds to the next state node of the transition target.

In a case where the process goes to step S271 after steps S264, S268 or S269, the destination and stopover predicting section 42 determines whether there is a state node which is registered in the unsearched list, or whether an unsearched branch target is present.

If it is determined in step S271 that the unsearched branch target is present, the process goes to step S272, and then, the destination and stopover predicting section 42 sets the state node of the highest branch target in the unsearched list as the emphasis node and reads the route up to the emphasis node. Then, the process returns to step S262.

On the other hand, in a case where it is determined in step S271 that the unsearched branch target is not present, the tree search process is terminated.

As described above, in the tree search process, in the tree structure including the state nodes capable of being transited from the current location node of the user, the process is performed for searching all state nodes ranging from the current location node which is a starting point to the destination node or the end node (end point) in which the transition target is not present. Then, the route from the current location of the user to the destination is stored in the search result list as the state node series from the current location node. The tree search process may be performed until the number of searches reaches a predetermined time which is the termination condition.

### [Example of the Tree Search Process]

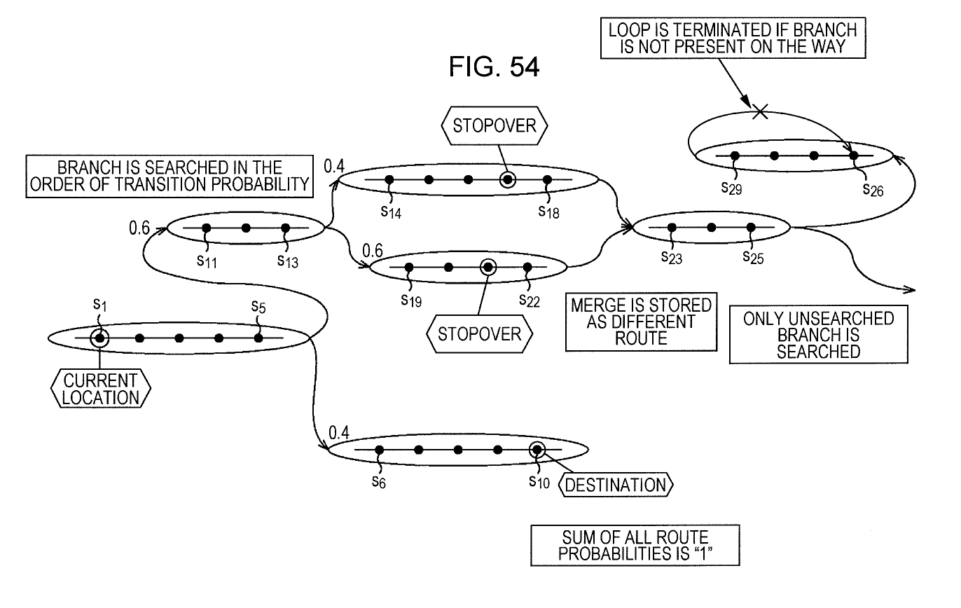

The tree search process of the destination and stopover predicting section 42 will be further described with reference to FIG. 54.

In an example in FIG. 54, in a case where the state s₁ is the current location, the following three routes or more are searched. The first route is a route leading to a state s₁₀ from the state s₁ through a state s₅, a state s₆ and the like (hereinafter, referred to as a route A). The second route is a route leading to a state s₂₉ from the state s₁ through a state s₅, a state s₁₁, a state s₁₄, a state s₂₃ and the like (hereinafter, referred to as a route B). The third route is a route leading to the state s₂₉ from the state s₁ through the state s₅, the state s₁₁, a state s₁₉, the state s₂₃ and the like (hereinafter, referred to as a route C).

The destination and stopover predicting section 42 calculates a probability (route selection probability) that each searched route is selected. The route selection probability is obtained by sequentially multiplying the transition probability between states for forming the route. Here, since it is necessary to consider only the case being transited to the next state but not necessary to consider the case of staying in the location, the route selection probability is calculated using a transition probability [aᵢⱼ] normalized by deleting the self transition probability from the state transition probability aᵢⱼ of each state obtained through learning.

The transition probability [aᵢⱼ] normalized by deleting the self transition probability can be expressed as the following formula (27).

$$[ {a}_{ij} ] = \frac{( 1 - {δ}_{ij} ) {a}_{ij}}{{\sum }_{j = 1}^{N} ( 1 - {δ}_{ij} ) {a}_{ij}} \qquad ( 27 )$$

Here, δ represents a Kronecker function, which becomes 1 only when suffixes i and j coincide with each other, and becomes 0 other than this case.

Accordingly, for example, in the state transition probability aᵢⱼ of the state s₅ in FIG. 54, in a case where a self transition probability a_{5,5} is 0.5, a transition probability a_{5,6} is 0.2, and a transition probability a_{5,11} is 0.3, a transition probability [a_{5,6}] and a transition probability [a_{5,11}] in a case where the state a₅ is branched to the state s₆ or the state s₁₁ are 0.4 and 0.6, respectively.

When a node number i of the state sᵢ of the searched route is (y₁, y₂, . . . , yₙ) the route selection probability can be expressed as the following formula (28), using the normalized transition probability [aᵢⱼ].

$$\begin{matrix}P ( {y}_{1} , {y}_{2} , … , {y}_{n} ) = [ {a}_{{y}_{1} {y}_{2}} ] [ {a}_{{y}_{2} {y}_{3}} ] … [ {a}_{{y}_{n - 1} {y}_{n}} ] \\ = {\prod }_{i = 1}^{n - 1} [ {a}_{{y}_{i - 1} {y}_{i}} ]\end{matrix} \qquad ( 28 )$$

In fact, since the normalized transition probability [aᵢⱼ] in the pass point is 1, the normalized transition probability [aᵢⱼ] at the time of branching may be sequentially multiplied. Accordingly, the destination and stopover predicting section 42 can calculate the selection probability of the selected route using the formula (28) while performing the tree search process in FIG. 53, at the same time.

In the example shown in FIG. 54, a selection probability of the route A is 0.4. Further, a selection probability of the route B is 0.24=0.6×0.4. A selection probability of the route C is 0.36=0.6×0.6. Further, it can be found that the total sum of the calculated selection probabilities of the routes is 1=0.4+0.24+0.36 and the search can be efficiently performed.

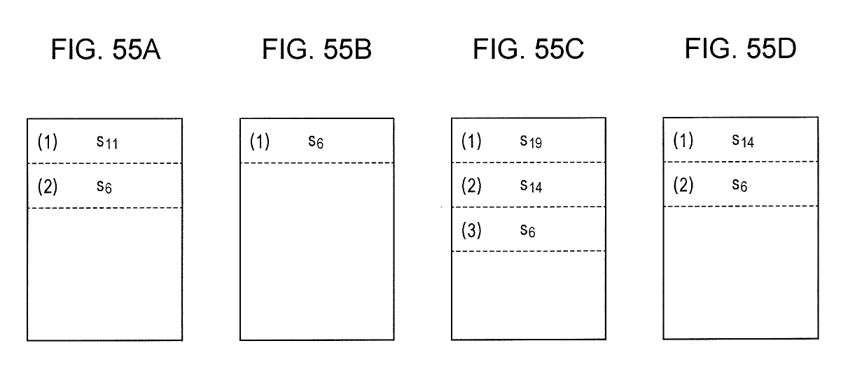

In the example in FIG. 54, when the emphasis node sequentially moves from the state s₁ of the current location and then the state s₄ is the emphasis node, since the state s₅ of the movement target is the branch point, step S268 in FIG. 53 is performed, and the state s₁₁ and the state s₆ of the branch target are stored in the unsearched list, as shown FIG. 55A. Here, since the selection probability of the state s₁₁ is high in the state s₁₁ and the state s₆, the state s₁₁ is stored in an upper part of the unsearched list.

Then, steps S271 and S272 in FIG. 53 are performed, the state s₁₁ stored in the upper part of the unsearched list is set to the emphasis node, and routes of the state s₁₁ and thereafter are searched. When the state s₁₁ is set to the emphasis node, the state s₁₁ is deleted from the unsearched list, as shown in FIG. 55B.

Then, if a search is performed using the state s₁₁ as the emphasis node, since branch targets of the state s₁₄ and the state s₁₉ are detected, step S268 in FIG. 53 is performed and the state s₁₄ and the state s₁₉ are stored in the unsearched list. At this time, the state s₁₄ and the state s₁₉ are stored at the highest level of the current unsearched list, and since the selection probability of the state s₁₉ is high in the state s₁₄ and the state s₁₉, the state s₁₉ is stored in a level higher than the state s₁₄. Accordingly, the unsearched list becomes as shown in FIG. 55C.

Hereinafter, similarly, steps S271 and S272 in FIG. 53 are performed, the state s₁₉ stored in the upper part of the unsearched list is set to the emphasis node, and routes of the state s₁₉ and thereafter are searched. When the state s₁₉ is set to the emphasis node, the state s₁₉ is deleted from the unsearched list, as shown in FIG. 55D.

In this way, in the tree search process through the destination and stopover predicting section 42, the process is performed by a depth priority algorithm in which a route having a higher selection probability is firstly searched for among the routes of the branch target by recording the detected branch target in the uppermost part of the unsearched list.

It may be considered that as the depth of the search increases, in other words, as a lower level layer becomes deep using the current location node as the highest level, it is difficult to search all routes. In such a case, for example, by adding conditions such as 1) not searching a branch target having a low transition probability, 2) not searching a route having a low occurrence probability, 3) limiting the depth for search, 4) limiting the number of search branches, the search may be terminated in the middle.

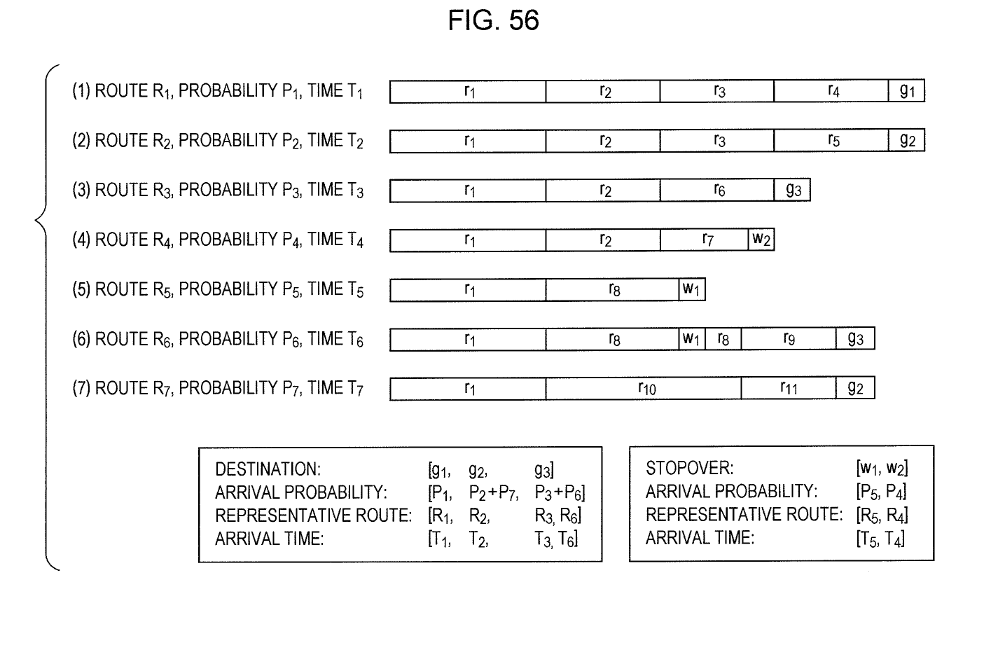

FIG. 56 is a diagram illustrating an example of the search result list in the tree search process.

As the tree search process is performed by the depth priority algorithm, a route having a high selection probability is preferentially registered in the search result list.

In the example in FIG. 56, a route R₁ (r₁, r₂, r₃ and r₄) up to a destination g₁ is registered in the first search result list, and in this case, a probability in which the route R₁ is selected is P₁, and a time taken to reach the destination g₁ using the route R₁ is T₁. A route R₂ (r₁, r₂, r₃ and r₅) up to a destination g₂ is registered in the second search result list, and in this case, a probability in which the route R₂ is selected is P₂, and a time taken to reach the destination g₂ using the route R₂ is T₂. A route R₃ (r₁, r₂ and r₆) up to a destination g₃ is registered in the third search result list, and in this case, a probability in which the route R₃ is selected is P₃, and a time taken to reach the destination g₃ using the route R₃ is T₃.

A route R₄ (r₁, r₂ and r₇) up to a stopover w₂ is registered in the fourth search result list, and in this case, a probability in which the route R₄ is selected is P₄, and a time taken to reach the stopover w₂ using the route R₄ is T₄. A route R₅ (r₁ and r₈) up to a stopover w₁ is registered in the fifth search result list, and in this case, a probability in which the route R₅ is selected is P₅, and a time taken to reach the stopover w₁ using the route R₅ is T₅.

A route R₆ (r₁, r₈, w₁, r₈ and r₉) up to a destination g₃ is registered in the sixth search result list, and in this case, a probability in which the route R₆ is selected is P₆, and a time taken to reach the destination g₃ using the route R₆ is T₆. A route R₇ (r₁, r₁₀ and r₁₁) up to the destination g₂ is registered in the seventh search result list in a probability in which the route R₇ is selected is P₇, and a time taken to reach the destination g₂ using the route R₇ is T₇.

The probability in which each route is selected up to the destination or stopover is calculated using the above described formula (13). Further, in a case where there is a plurality of routes up to the destination, the sum of the selection probabilities of the plurality of routes up to the destination becomes an arrival probability for the destination.

Accordingly, in the example in FIG. 56, since the route R₂ and the route R₇ may be used to reach the destination g₂, an arrival probability for the destination g₂ becomes (P₂+P₇). Similarly, since the route R₃ and the route R₆ may be used to reach the destination g₃, an arrival probability for the destination g₃ becomes (P₃+P₆). An arrival probability for the destination g₁ is the same as the probability P₁ in which the route R₁ is selected.

### [Process of the Prediction Post-Processing Section 34]

Next, a process performed by the prediction post-processing section 34 will be described.

A method of calculating a time taken to move along the selected route up to the destination or stopover will be described.

For example, it is assumed that the current location of the current time t₁ is a state s_{y1}, and routes determined at a time (t₁, t₂, . . . t_{g}) are (s_{y1}, s_{y2}, . . . s_{yg}). In other words, it is assumed that the node number i of the determined route state sᵢ is (y₁, y₂, . . . Y_{g}). Hereinafter, for simplicity of the description, the state sᵢ corresponding to the location may be simply indicated as the node number i.

Since the current location y₁ at the current time t₁ is specified by the current location node estimating section 41, a probability P_{y1}(t₁) that the current location at the current time t₁ is y₁ is 1. Further, a probability that the current location is in a state other than y₁ at the current time t₁ is 0.

On the other hand, a probability P_{yn}(tₙ) that the current location is in the node number yₙ at a predetermined time tₙ can be expressed as the following formula (29).

P_{yn}(tₙ)=P_{y}_{ₙ}(tₙ−1)a_{y}_{ₙ}_{y}_{ₙ}+P_{y}_{_{n−1}}(tₙ−1)a_{y}_{_{n−1}}yₙ (29)

Here, a first term on the right-hand side of the formula (29) represents a probability that the current location is disposed in the original location yₙ and the self transition is performed; and a second item on the right-hand side represents a probability that the transition is performed to the location yₙ from a location yₙ₋₁ which is disposed immediately before. In the formula (29), differently from the calculation of the route selection probability, the state transition probability aᵢⱼ obtained by learning is used as it is.

A prediction value <t_{g}> of the time t_{g} at the time of reaching the destination y_{g} can be expressed as the following formula (30), using a “probability that the current location is disposed in a location y_{g-1} immediately before the destination y_{g} at a time t_{g-1} immediately before the time t_{g} and moves to the destination y_{g} at the time t_{g}”.

$$〈 {t}_{g} 〉 = {\sum }_{t} {t}_{g} ( \frac{{P}_{{x}_{g - 1}} ( {t}_{g - 1} - 1 ) {a}_{{x}_{g - 1} {x}_{g}}}{{\sum }_{t} {P}_{{x}_{g - 1}} ( {t}_{g} - 1 ) {a}_{{x}_{g - 1} {x}_{g}}} ) \qquad ( 30 )$$

That is, the prediction value <t_{g}> is expressed as an expectation value of the time until “the current location is disposed in a state s_{yg-1} immediately before a state s_{yg} at the time t_{g-1} immediately before the time t_{g} and moves to the state s_{yg} at the time t_{g}”.

As described above, the time taken to move along the selected route up to the predetermined destination or stopover is calculated by the prediction value <t_{g}> of the formula (30).

A representative route selection process in which a representative route is selected in a case where the route to the destination is searched for will be described with reference to the example in FIG. 56.

In a case where such a search result list in FIG. 56 is obtained, since a route having a high selection probability is preferentially (at a high level) registered in the search result list, the first to third search result lists in which the selection probability is high and a different destination is given are output as the prediction result. That is, the destination g₁ and its route R₁, the destination g₂ and its route R₂, and the destination g₃ and its route R₃, are selected as the destination and its representative route.

Next, it is considered that the fourth and fifth search result lists are skipped since the fourth and fifth search result lists are routes up to the stopover and the route R₆ for reaching the destination g₃ in the sixth search result list is used as the representative route. The route R₆ uses the stopover w₁ which is not included in the route R₃ of the same destination g₃ which is already selected as the representative route. Accordingly, the route R₆ for reaching the destination g₃ is also selected as the representative route.

Next, it is considered to use the route R₇ for reaching the destination g₂ in the seventh search result list as the representative route. The route R₇ does not pass through a predetermined stopover route, in a similar way to the same destination g₂ in which the representative route is already selected. Accordingly, the route R₇ for reaching the destination g₂ is not selected as the representative route.

In this way, in the representative route selection process, it is possible to present a route passing through a different stopover which is considered to be beneficial to the user as the prediction result even in the case of the same destination, without presenting a similar route passing through almost the same route.

In the route R₆ for reaching the destination g₃ in the sixth search result list, the search stopover is terminated in the stopover w₁ in the former method disclosed in the prior application 2 in the related art. However, according to the prediction system 1, it is possible to perform the search process up to the route reaching the destination g₃ using the stopover w₁, without terminating in the stopover w₄₁.

According to the prediction system 1, as attributes are assigned to the state nodes obtained by learning while dividing the destination and the stopover, it is possible to prevent the stopover in the middle from being predicted as the destination. Further, in a case where a plurality of routes for the same destination is searched, it is possible to present a route passing through a different stopover which is considered to be beneficial to user without presenting a route passing through almost the same route.

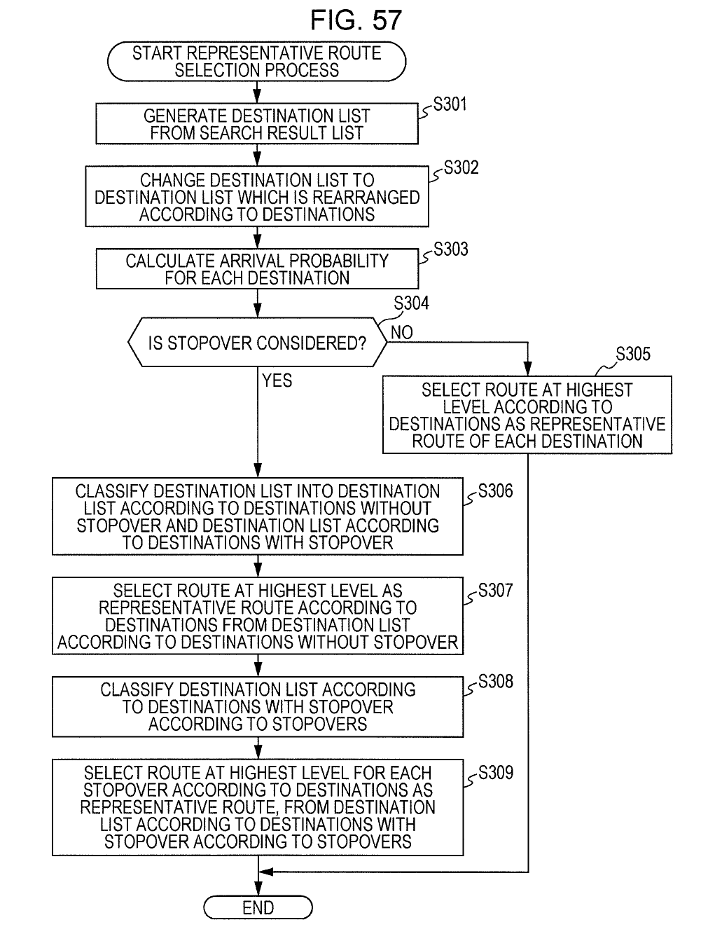

FIG. 57 is a flowchart illustrating the representative route selection process performed by the prediction post-processing section 34.

Firstly, in step S301, the prediction post-processing section 34 generates a destination list which is the search result list only for the destination except the route up to the stopover, from the search result list created by the destination and stopover predicting section 42.

In step S302, the prediction post-processing section 34 changes the destination list to a destination list which is rearranged according to destinations. At this time, the prediction post-processing section 34 generates a destination list according to destinations so that the order in the same destination is not changed.

In step S303, the prediction post-processing section 34 calculates an arrival probability for each destination. In a case where there is only one route for destination, the selection probability of the route becomes the arrival probability, and in a case where there is a plurality of routes for destination, the sum of the plurality of selection probabilities (occurrence probabilities) becomes the arrival probability of the destination.

In step S304, the prediction post-processing section 34 determines whether to consider a stopover in selection of the representative route. In a case where it is determined in step S304 that the stopover is not considered, the process goes to step S305, and then the prediction post-processing section 34 selects a route at the highest level according to destinations as a representative route for each destination. Then, the process is terminated. As a result, in a case where there is a plurality of routes up to the destination, a route up to the destination having a high selection probability is used as the representative route for each destination, and its necessary time is presented as a necessary time up to the destination. In a case where there is a plurality of destinations, it is possible to present only a predetermined number of destinations from the highest level.

On the other hand, in a case where it is determined in step S304 that the stopover is considered, the process goes to step S306, and then, the prediction post-processing section 34 classifies the destination list according to destinations into a destination list according to destinations without stopover and a destination list according to destinations with stopover.

Then, in step S307, the prediction post-processing section 34 selects a route at the highest level as a representative route according to destinations from the destination list according to destinations without stopover. Thus, a route without stopover for each destination is determined as a representative route.

Next, in step S308, the prediction post-processing section 34 further classifies the destination list according to destinations with stopover according to stopovers.

In step S309, the prediction post-processing section 34 selects the route at the highest level for each stopover according to destinations as the representative route, from the destination list according to destinations with stopover according to stopovers. Thus, the route with stopover for each destination is determined as the representative route. As a result, in a case where there is a route without stopover and a route with stopover as the route up to the destination, both routes are used as the representative route for each destination, and each necessary time is presented as a necessary time up to the destination.

In this way, the representative route selection process is terminated. As described above, in a case where there is a plurality of routes for a destination, if a method is employed in which the occurrence probabilities are classified and presented according to stopovers, other than a method in which a plurality of occurrence probabilities having high levels is presented, it is possible to make the prediction closer to an actual prediction of the user.

### [Overall Process of the Prediction Block 13]

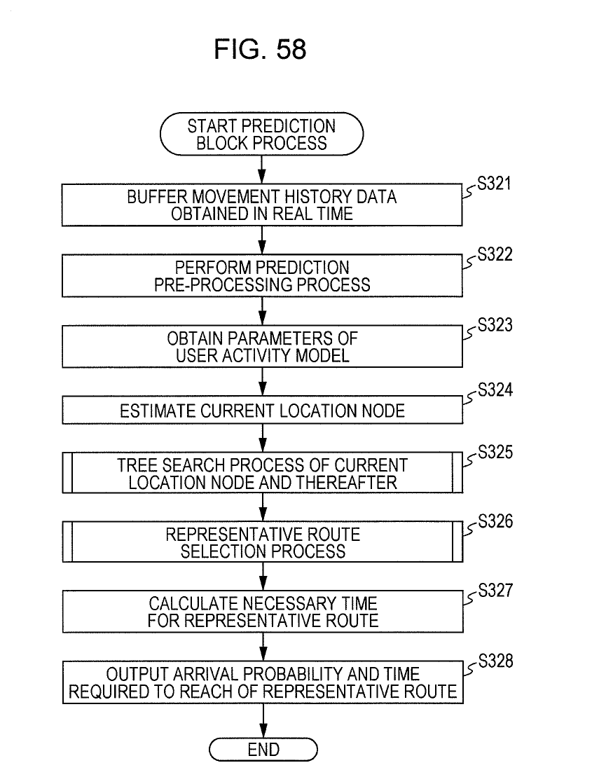

An overall process of the prediction block 13 will be described with reference to a flowchart in FIG. 58.

Firstly, in step S321, the buffering section 31 buffers the movement history data obtained in real time for the predication process.

In step S322, the predication pre-processing section 32 performs a predication pre-processing process. Specifically, the predication pre-processing section 32 performs a process of connecting and dividing the movement history data, a process of deleting an obvious abnormality of the movement history data, a process of filling in a gap in the data, which are similar to the learning pre-processing process performed by the learning pre-processing section 22. Here, a stationary threshold time which becomes a reference when the movement history data is divided may be a time different from that in the learning pre-processing process.

In step S323, the prediction main processing section 33 obtains parameters of the user activity model obtained by learning of the learning block 11 from the user model parameter storing section 12. The process of obtaining the parameters may be performed in advance, differently from the process of predicting the destination in FIG. 33.

In step S324, the current location node estimating section 41 of the prediction main processing section 33 estimates a state node (current location node) corresponding to a current location of the user, through the user activity model using the parameters obtained by learning of the learning block 11. More specifically, the current location node estimating section 41 calculates node series data corresponding to the movement history data through the user activity model using the parameters obtained by learning of the learning block 11. Thus, the current location node estimating section 41 uses the final state node in the node series data as the current location node. The Viterbi algorithm is employed for calculation of the node series data.

In step S325, the destination and stopover predicting section 42 of the prediction main processing section 33 performs the tree search process for the current location node and thereafter, described with reference to FIG. 53. The occurrence probabilities of the routes (node series) up to the destination and stopover are obtained by the formula (28) at the same time when the tree search process is performed.

In step S326, the prediction post-processing section 34 performs the representative route selection process described with reference to FIG. 57.

In step S327, the prediction post-processing section 34 calculates a necessary time for each selected representative route, using the formula (30).

In step S328, the prediction post-processing section 34 outputs the representative route, the arrival probability, and the time to reach the predicted destination as the prediction result, and then the process is terminated.

As described above, in the process of the prediction block 13, the route to the destination from the current location of the user is searched for using information about the estimated destination node, stopover node and current node, and the user activity model indicated as the parameters obtained by learning. Since the destination and stopover attribute is assigned to the state node obtained by learning, it is possible to prevent the stopover from being predicted as the destination.

Further, since the destination and stopover attribute is assigned to the state node obtained by learning, it is possible to output the route without stopover and the route with stopover as the representative route even in the case of routes to the same destination.

### [Example of Data Processing Result]

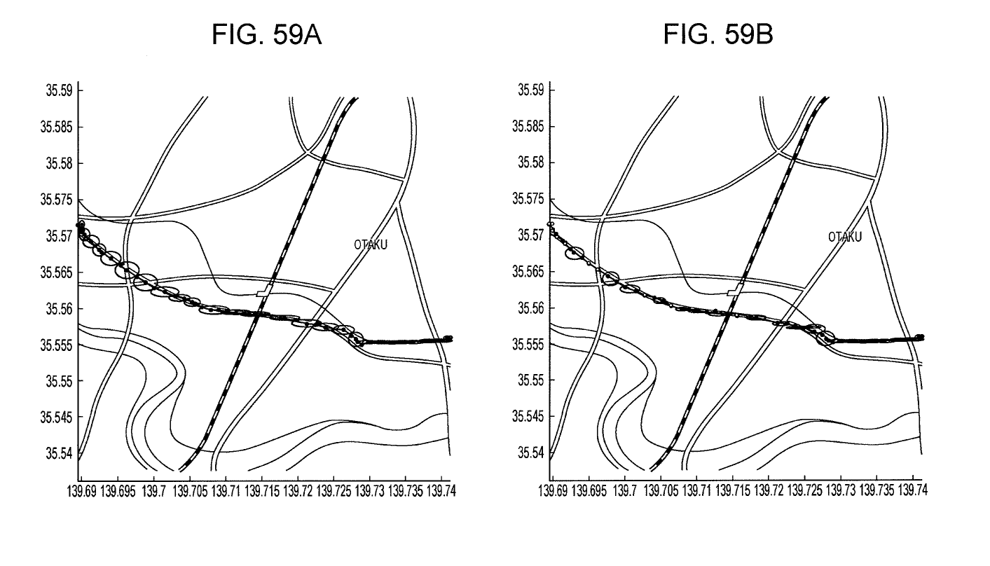

FIGS. 59A, 59B to 63 illustrate learning process results when movement history data of a certain user is learned by the learning main processing section 23 in the prediction system 1 according to the above-described present disclosure.

FIGS. 59A and 59B are diagrams obtained by comparing a learning result of state nodes in the modeling according to the present disclosure (learning main processing section 23) and a learning result of state nodes in the modeling through HMM in the related art.

FIG. 59A illustrates a learning result through the learning model which is modeled according to the present disclosure, that is, the modeling is performed so that one state node necessarily reflects two continuous samples, as shown in FIG. 31.

FIG. 59B illustrates a learning result through the leaning model which is modeled according to the HMM in the related art.

In FIGS. 59A and 59B, an ellipse represents a contour line of distribution (normal distribution) of data indicated by each state node. Here, the center of the ellipse is an average value of the latitudes and longitudes of respective state nodes, and the size of the ellipses is proportional to a variance value of the latitudes and longitudes of the respective state nodes.

In the modeling in the related art shown in FIG. 59B, the state node variance converges to the center of the sample (reaches the lower limit), but in the modeling in FIG. 59A according to the present disclosure, the node variance extends so as to cover a gap between samples. As a result, it can be understood that in the modeling in the related art shown in FIG. 59B, there are portions in which the vicinities of the samples are only covered in all the state nodes, but in the modeling in FIG. 59A according to the present disclosure, all the routes are covered.

In FIGS. 59A and 59B, the variance parameters are prepared in the respective dimensions of time, latitude and longitude. In such a case, the movement history data is modeled by the state nodes which are expressed as ellipses the long axis of which is parallel to the latitude and longitude. Then, in a case where the movement direction is parallel to any one of the latitude and longitude, the routes are modeled and regions other than the routes are not covered. However, in a case where the movement direction is inclined, extra regions other than the routes are significantly covered. Thus, in a case where it is desirable that the modeling of the extra regions is avoided as much as possible, covariance may be used for the variance parameters. In this case, the movement history data is modeled by the state nodes expressed as the inclined ellipses. As a result, even in a case where the movement direction is inclined, the extra regions other than the routes can be modeled without covering.

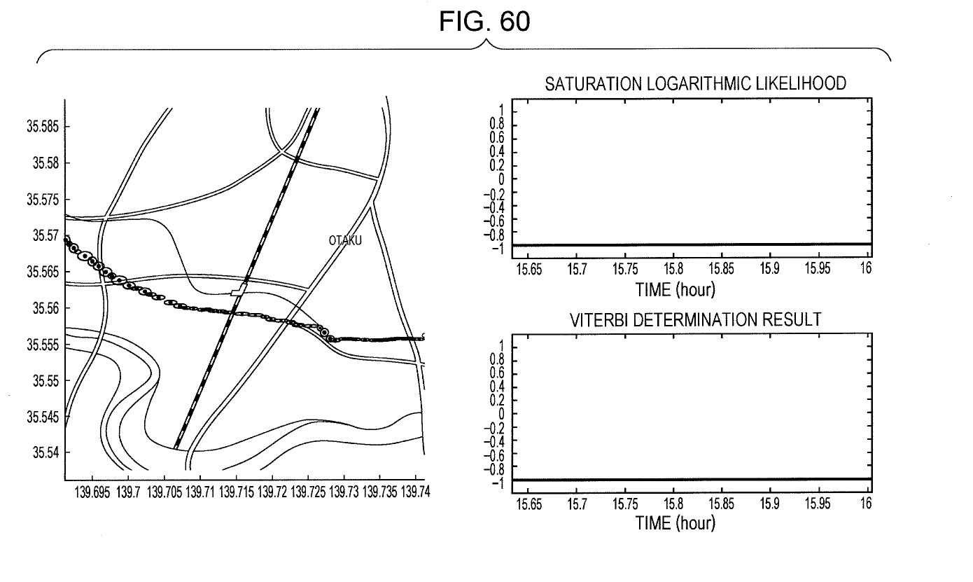

FIG. 60 illustrates a movement route which is firstly learned and its learning result. The movement history data is three dimensional data which is sampled at 15 line intervals when the user goes out to a certain destination from one's residence.

On the left map in FIG. 60, the movement history data which is learned by the prediction system 1 is shown as black circles, and ellipses positioned in the vicinities of the black circles represent state nodes of the learning result. It can be understood that the state nodes are learned so that routes between the samples are modeled, referring to the learning result.

Since the movement history data is data used for the first learning of the learning main processing section 23, it should be determined that the movement history data is the unknown movement history data in the known or unknown determination process of the known or unknown determining section 201.

Two drawings on the right-hand side in FIG. 60 illustrate the known or unknown determination result of the movement history data on the left-hand side in FIG. 60. The upper drawing represents a saturation logarithm likelihood, and the lower drawing represents the known or unknown determination result through the Viterbi determination. The known or unknown determination result shows that “−1” corresponding to the unknown route is continuously output and is correctly learned as the unknown route.

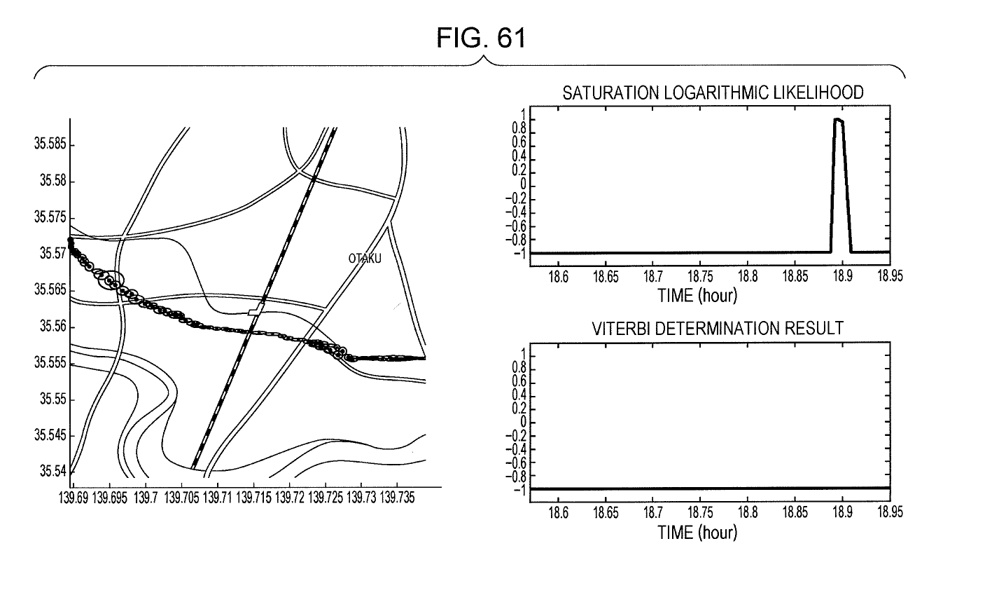

FIG. 61 illustrates a learning result when returning movement history data is learned at the time when the user returns through the same route from the destination reached by the user through the movement route in FIG. 60.

In this case, since each location through which the user passes is a location known by the user, the known or unknown determination result seems to be known. However, a user's intention is important when the behavior prediction is performed, and thus, it is necessary to perform modeling by correctly distinguishing the user's intention to go out or to return even in the case of the same location. Accordingly, in the known or unknown determination, the returning movement history data in FIG. 61 should be determined to be unknown in the known or unknown determination.

Referring to the known or unknown determination result on the right-hand side in FIG. 61, “−1” corresponding to the unknown route is continuously output and the known or unknown determining section 201 of the learning main processing section 23 correctly determines it as the unknown route.

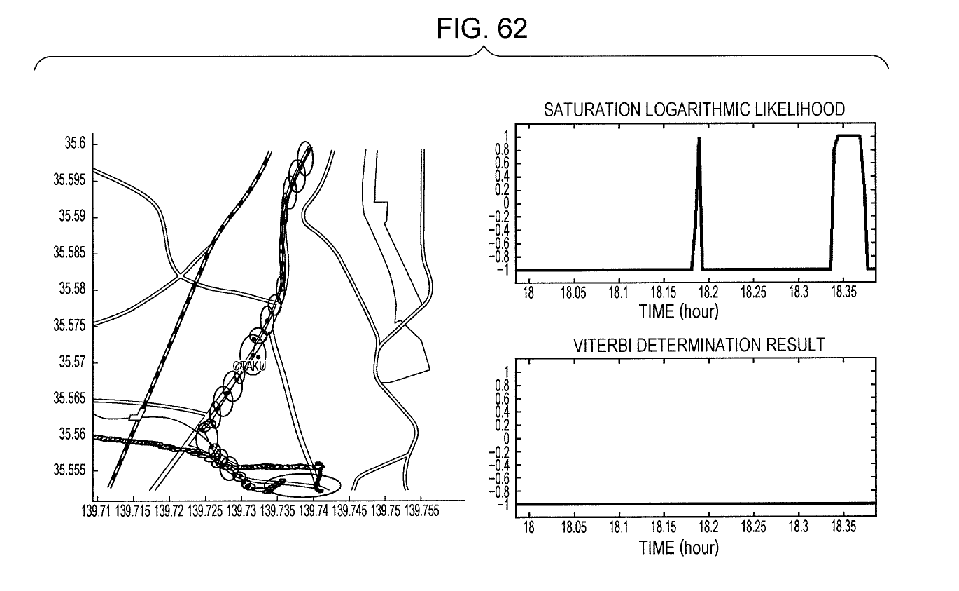

FIG. 62 illustrates a learning result of the movement history data in a case where the user moves to the same destination as in FIG. 60 through a completely different route.

A chain of ellipses in a transverse direction represents a learning result of the routes shown on the left map in FIG. 62, and a long chain of ellipses in a longitudinal direction represents a learning result through a completely different route shown in FIG. 60. Scales on the map are different from each other in FIGS. 60 and 62.

Referring to the known or unknown determination result on the right-hand side in FIG. 62, “−1” corresponding to the unknown route is continuously output and the known or unknown determining section 201 of the learning main processing section 23 correctly determines it as the unknown route, with respect to the movement history data having the completely different route.

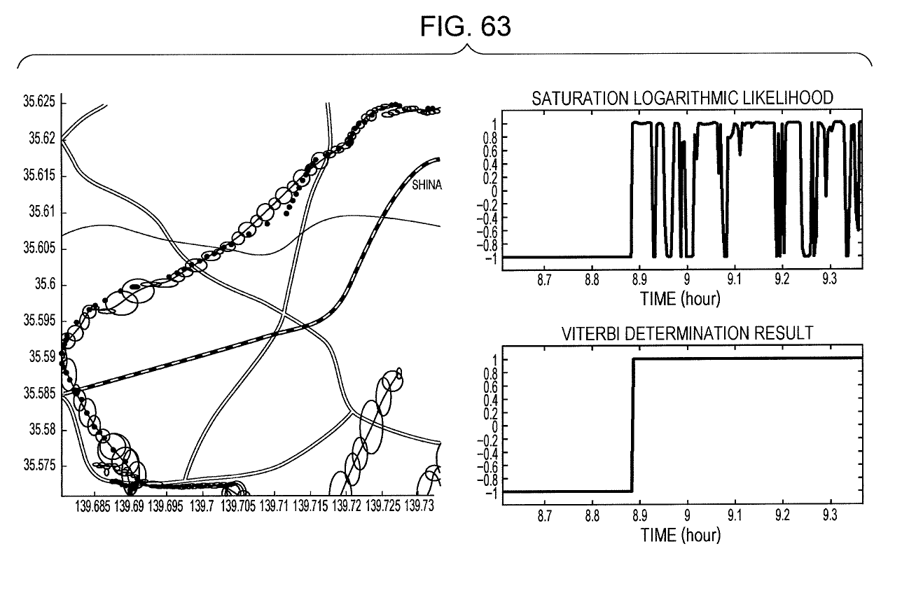

FIG. 63 illustrates a learning result when a further different movement route is learned.

Specifically, FIG. 63 illustrates a learning result when a movement route of a certain user from one's residence to one's office secondly learned through a second route after being firstly learned through a first route.

Here, the first route and the second route represent the difference between a case where the user moves without making a side trip between one's residence and the stopover on the way and a case where the user moves to a predetermined location while making a side trip. Further, the second half movement route from the stopover on the way to the office which is the destination is the same.

Referring to the known or unknown determination result on the right-hand side in FIG. 63, “−1” corresponding to the unknown route is output in the first half portion of the movement route, and “1” corresponding to the known route is output in the second half of the movement route. This means that it is determined that the route from the residence to the stopover on the way is “unknown” and the route from the stopover on the way to the office is “known”. Accordingly, it can be understood that the known or unknown determining section 201 of the learning main processing section 23 can correctly distinguish the known or unknown routes for learning.

Further, in the state nodes described on the left-hand side map in FIG. 63, it is difficult to reliably distinguish them through monochrome display, but a state node which is newly added in the second learning is not included in a state node which covers the first learning data route. On the other hand, a state node which covers the second learning data route entirely becomes a state node which is newly added in the second learning. That is, the learning is performed by updating the existing model parameters with respect to the movement history data on the known route, without topology change, and a new state node is added to only the movement history data on the unknown route. Accordingly, in the learning of the learning main processing section 23, it is possible to reflect the new movement history data to the learning model, and to moderately model the learning model, without adding the state node uselessly. In other words, it is possible to simply perform difference learning when the movement history data on the unknown route is obtained.

### [Configuration Example of Computer]

The series of processes as described above may be performed by hardware or software. In a case where the series of processes is performed by software, a program for forming the software is installed in a computer. Here, the computer includes a computer mounted in a piece of exclusive hardware or a general-purpose personal computer which is installed with a variety of programs to perform a variety of functions.

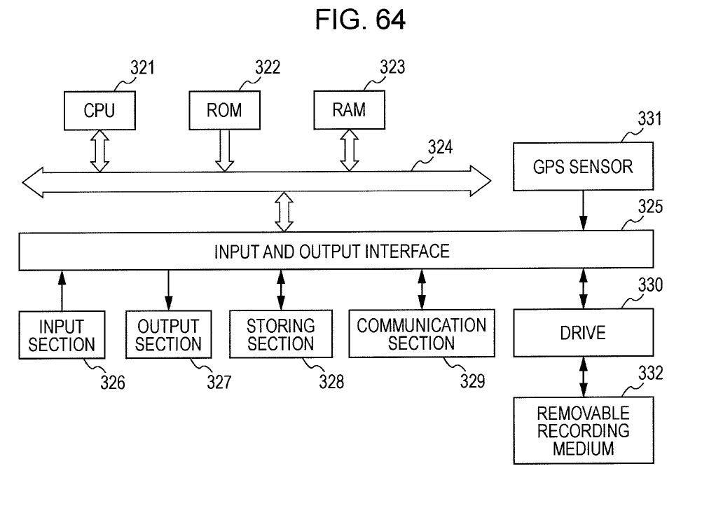

FIG. 64 is a block diagram illustrating a hardware configuration example of the computer which executes the series of processes as described above by programs.

In the computer, a CPU (central processing unit) 321, a ROM (read only memory) 322 and a RAM (random access memory) 323 are connected to each other through a bus 324.

Further, an input and output interface 325 is connected to the bus 324. An input section 326, an output section 327, a storing section 328, a communication section 329, a drive 330 and a GPS sensor 331 are connected to the input and output interface 325.

The input section 326 includes a keyboard, a mouse, a microphone or the like. The output section 327 includes a display, a speaker or the like. The storing section 328 includes a hard disk, a non-volatile memory or the like. The communication section 329 includes a network interface or the like. The drive 330 drives a removable recording medium 332 such as a magnetic disk, an optical disk, a magneto-optical disk, a semiconductor memory or the like. The GPS sensor 331 which is the above-described sensor device outputs three dimensional data including data on current locations (latitude and longitude) and time at that time.

In the computer with such a configuration, for example, the CPU 321 loads a program stored in the storing section 328 to the RAM 323 through the input and output interface 325 and the bus 324 to be executed, to thereby perform the series of processes as described above.

The program executed by the computer (CPU 321) can be recorded in the removable recording medium 332 which is a package media or the like, for example, for supply. Further, the program can be supplied through a wired or wireless transmission medium, such as a local area network, the Internet or digital satellite broadcasting.

In the computer, the program can be installed in the storing section 328 through the input and output interface 325, by installing the removable recording medium 332 on the drive 330. Further, the program may be received in the communication section 329, through the wired or wireless transmission medium, and then may be installed in the storing section 328. In addition, the program may be installed in the ROM 322 or the storing section 328, in advance.

The program executed by the computer may be a program in which the procedure is performed in a time series manner in the order as described in this description, or may be a program in which the procedure is performed in parallel or at a necessary timing, for example, when a call is performed.

In this description, the steps disclosed in the flowcharts may be performed in a time series manner in the described order, or may be performed in parallel or at a necessary timing, for example, when a call is performed.

In this description, the system refers to the entire apparatus including a plurality of devices.

The present disclosure contains subject matter related to that disclosed in Japanese Priority Patent Application JP 2010-141946 filed in the Japan Patent Office on Jun. 22, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A data processing apparatus comprising:
a learning section which obtains parameters of a probability model when movement history data of a user which is obtained as learning data is expressed as the probability model indicating an activity of the user;
a destination and stopover estimating section which estimates a destination node corresponding to a movement destination and a stopover node corresponding to a movement stopover, among state nodes of the probability model using the parameters obtained by the learning section;
a current location estimating section which inputs the movement history data of the user within a predetermined time from a current time, which is different from the learning data, to the probability model using the parameters obtained by learning, and estimates a current location node corresponding to a current location of the user;
a searching section which searches for a route to the destination from the current location of the user, using information about the estimated destination node, stopover node and the current location node and the probability model obtained by learning; and
a calculating section which calculates an arrival probability and a time to reach the searched destination,
wherein the learning section includes
a known or unknown determining section which determines, in a case where movement history data which is new learning data is supplied after the parameters of the probability model are once obtained, whether the new learning data is movement history data on a known route or movement history data on an unknown route;
a parameter updating section which updates, in a case where it is determined that the new learning data is the movement history data on the known route in the known or unknown determining section, the parameters of the existing model which is the already obtained probability model;
a new model generating section which obtains, in a case where it is determined that the new learning data is the movement history data on the unknown route in the known or unknown determining section, parameters of a probability model which is a new model corresponding to the movement history data on the unknown route; and
a new model combining section which generates an updated model in which the existing model and the new model are combined with each other, by combining the parameters of the existing model with the parameters of the new model, and
wherein in a case where the probability model is updated by the new learning data, a process using the probability model after being updated is performed in the destination and stopover estimating section, the current location estimating section, the searching section and the calculating section.

2. The data processing apparatus according to claim 1, wherein the new model generating section employs a model in which one state node reflects at least two continuous samples in the movement history data of the user, as the probability model.

3. The data processing apparatus according to claim 2, wherein the model in which one state node reflects the at least two continuous samples in the movement history data of the user is a model in which the at least two continuous samples in the movement history data of the user are simultaneously output at the time of transition to one state node.

4. The data processing apparatus according to claim 3, wherein the model in which one state node reflects the at least two continuous samples in the movement history data of the user is also a model to which a left-to-right restriction is set.

5. The data processing apparatus according to claim 1, wherein the new model generating section obtains the parameters of the probability model by using a Baum-Welch's maximum likelihood estimation method.

6. The data processing apparatus according to claim 5, wherein the new model generating section obtains the parameters of the new model corresponding to the movement history data on the unknown route by using the Baum-Welch's maximum likelihood estimation method, generates node series data obtained by converting the movement history data on the unknown route into a state node of the new model, calculates a state frequency and a transition frequency of each state node, and obtains parameters of the node series data in the movement history data on the unknown route corresponding to the parameters of the new model.

7. The data processing apparatus according to claim 6,
wherein the known or unknown determining section generates, in a case where it is determined that the new learning data is the movement history data on the known route, node series data obtained by converting the movement history data on the known route into a state node of the existing model, and
wherein the parameter updating section updates the state frequency and the transition frequency of each state node from the node series data obtained by converting the movement history data on the known route into the state node of the existing model, and updates the parameters of the node series data which are the parameters of the existing model.

8. The data processing apparatus according to claim 6,
wherein the known or unknown determining section recognizes the state node corresponding to the movement history data which is the new learning data by using an unknown state addition model obtained by adding one state node which takes the movement history data on the unknown route to the existing model, calculates an observation likelihood of the node series data in the unknown state addition model corresponding to the movement history data which is the new learning data, and performs a known or unknown determination from the size of the calculated observation likelihood.

9. The data processing apparatus according to claim 8,
wherein a transition probability between one state node which takes the movement history data on the unknown route which is added to the existing model and each state node of the known model is lower than any one of transition probabilities between the state nodes of the existing model, and a variance value thereof is a value which covers an obtainable range in the movement history data.

10. The data processing apparatus according to claim 8,
wherein the known or unknown determining section performs a Viterbi determination using an HMM which includes two known or unknown states and has a high self transition probability, for the observation likelihood of the node series data in the unknown state addition model, to perform the known or unknown determination.

11. The data processing apparatus according to claim 1,
wherein in a case where the movement history data on the unknown route is connected to the movement history data on the known route, the known or unknown determining section outputs a state node corresponding to the movement history data on the known route of the connection target,
wherein in a case where the existing model includes M state nodes and the new model includes N state nodes, the new model combining section generates a transition probability table of (M+N) rows and (M+N) columns in which a transition probability of the updated model is defined,
wherein each element in an upper left region from the first row and the first column to an M-th row and an M-th column in the generated transition probability table corresponds to a transition probability of the state node of the existing model,
wherein each element in a lower right region from an (M+1)-th row and an (M+1)-th column to the (M+N)-th row and the (M+N)-th column in the generated transition probability table corresponds to the transition probability of the state node of the new model,
wherein each element in an upper right region from the first row and the (M+1)-th column to the M-th row and the (M+N)-th column in the generated transition probability table corresponds to the state node of the connection target when the new model is connected to follow the node series data in the existing model, and
wherein each element in a lower left region from the (M+1)-th row and the first column to the (M+N)-th row and the M-th column in the generated transition probability table corresponds to the state node of the connection target when the node series data in the existing model is connected to follow the new model.

12. The data processing apparatus according to claim 1, further comprising: a movement attribute recognizing section which recognizes at least a stationary state or a movement state with respect to each piece of three dimensional data which forms the movement history data,
wherein the destination and stopover estimating section estimates the state node corresponding to the movement history data in which the stationary state continues for a predetermined threshold time or longer as the destination node, and estimates the state node corresponding to the movement history data in which the continuous time of the stationary state is shorter than the predetermined threshold time as the stopover node.

13. A data processing method comprising:
obtaining parameters of a probability model when movement history data of a user which is obtained as learning data is expressed as the probability model indicating an activity of the user, by a learning section of a data processing apparatus which processes the movement history data of the user;
estimating a destination node corresponding to a movement destination and a stopover node corresponding to a movement stopover, among state nodes of the probability model using the parameters obtained, by a destination and stopover estimating section of the data processing apparatus;
inputting the movement history data of the user within a predetermined time from a current time, which is different from the learning data, to the probability model using the parameters obtained by learning, and estimating a current location node corresponding to a current location of the user, by a current location estimating section of the data processing apparatus;
searching for a route to the destination from the current location of the user, using information about the estimated destination node, stopover node and the current location node and the probability model obtained by learning, by a searching section of the data processing apparatus; and
calculating an arrival probability and a time to reach the searched destination, by a calculating section of the data processing apparatus,
wherein the obtaining of parameters includes
determining, in a case where movement history data which is new learning data is supplied after the parameters of the probability model are once obtained, whether the new learning data is movement history data on a known route or movement history data on an unknown route, by a known or unknown determining section of the learning section;
updating, in a case where it is determined that the new learning data is the movement history data on the known route in the known or unknown determining section, the parameters of the existing model which is the already obtained probability model, by a parameter updating section thereof;
obtaining, in a case where it is determined that the new learning data is the movement history data on the unknown route in the known or unknown determining section, parameters of a probability model which is a new model corresponding to the movement history data on the unknown route, by a new model generating section thereof; and
generating an updated model in which the existing model and the new model are combined with each other, by combining the parameters of the existing model with the parameters of the new model, by a new model combining section thereof, and
wherein in a case where the probability model is updated by the new learning data, a process using the probability model after being updated is performed in the destination and stopover estimating section, the current location estimating section, the searching section and the calculating section.

14. A program which allows a computer to function as the following sections, the sections comprising:
a learning section which obtains parameters of a probability model when movement history data of a user which is obtained as learning data is expressed as the probability model indicating an activity of the user;
a destination and stopover estimating section which estimates a destination node corresponding to a movement destination and a stopover node corresponding to a movement stopover, among state nodes of the probability model using the parameters obtained by the learning section;
a current location estimating section which inputs the movement history data of the user within a predetermined time from a current time, which is different from the learning data, to the probability model using the parameters obtained by learning, and estimates a current location node corresponding to a current location of the user;
a searching section which searches for a route to the destination from the current location of the user, using information about the estimated destination node, stopover node and the current location node and the probability model obtained by learning; and
a calculating section which calculates an arrival probability and a time to reach the searched destination,
wherein the learning section includes functions of
a known or unknown determining section which determines, in a case where movement history data which is new learning data is supplied after the parameters of the probability model are once obtained, whether the new learning data is movement history data on a known route or movement history data on an unknown route;
a parameter updating section which updates, in a case where it is determined that the new learning data is the movement history data on the known route in the known or unknown determining section, the parameters of the existing model which is the already obtained probability model;
a new model generating section which obtains, in a case where it is determined that the new learning data is the movement history data on the unknown route in the known or unknown determining section, parameters of a probability model which is a new model corresponding to the movement history data on the unknown route; and
a new model combining section which generates an updated model in which the existing model and the new model are combined with each other, by combining the parameters of the existing model with the parameters of the new model, and
wherein in a case where the probability model is updated by the new learning data, a process using the probability model after being updated is performed in the destination and stopover estimating section, the current location estimating section, the searching section and the calculating section.
